(19) United States
(12) Patent Application Publication
(10) Pub. No.: US 2013/0286329 A1
(43) Pub. Date: Oct. 31, 2013

(54) OPTICAL FILM, PROCESS FOR PRODUCING THE SAME, AND POLARIZING PLATE AND STEREOSCOPIC DISPLAY DEVICE AND SYSTEM HAVING THE SAME

(71) Applicant: FUJIFILM Corporation, Tokyo (JP)

(72) Inventors: Ryoji GOTO, Kanagawa (JP); Shinichi MORISHIMA, Kanagawa (JP)

(21) Appl. No.: 13/926,037

(22) Filed: Jun. 25, 2013

Related U.S. Application Data
(63) Continuation of application No. PCT/JP2011/080542, filed on Dec. 21, 2011.

(30) Foreign Application Priority Data
Dec. 27, 2010 (JP) 2010-289360
Sep. 9, 2011 (JP) 2011-196768

(51) Int. Cl. G02F 1/1335; G02B 5/30

(52) U.S. Cl. CPC G02F 1/133528; G02B 5/3016
USPC 349/96; 349/194; 427/510

(57) ABSTRACT

An optical film comprising a transparent support, and thereon, an alignment layer comprising at least one photo-acid-generating agent, and an optically anisotropic layer formed of a composition comprising a liquid crystal having a polymerizable group as a main ingredient is disclosed. The optically anisotropic layer is an optically anisotropic patterned layer comprising a first retardation domain and a second retardation domain disposed alternately in a plane.

The present application is a continuation of PCT/JP2011/080542 filed on Dec. 21, 2011 and claims priority under 35 U.S.C. §119 of Japanese Patent Application No. 289360/2010, filed on Dec. 27, 2010, and Japanese Patent Application No. 196768/2011, filed on Sep. 9, 2011.

### BACKGROUND OF THE INVENTION

1. Technical Field

The present invention relates to an optical film having an optically anisotropic layer with a high-definition alignment pattern, which can be produced readily and is excellent in usefulness. The present invention relates also to a process for producing the film, a polarizing plate having the film, and a display device and system, capable of displaying stereoscopic images, having the film.

2. Background Art

Some examples of a stereoscopic display device capable of displaying stereoscopic imagery need an optical element capable of transforming the polarization state of the incident light into a right-eye polarization state and a left-eye polarization state, for example, circular polarization states which are opposite to each other. For producing the optical element, the patterning technique for arranging regularly a plurality of domains in which the absorption axes of the polarizing film or the slow axes of the retardation film are different from each other is needed.

For example, the method for producing an optical rotatory element having stripes of rotatory and non-rotatory regions by using a photoresist material is disclosed in JP-A-10-90675. However, the method needs many steps, and therefore, it may be difficult to manufacture the element industrially and continuously according to the method.

For example, the method for producing a retardation sheet, having first and second areas in which the fast or slow axis is different from each other, by using the predetermined photoisomerizing material is disclosed in JP-A-10-153707. However, the material to be used in the method is limited, and therefore, it may be difficult to achieve the appropriate properties depending on any application.

An elliptical polarizer and an optically anisotropic body which can be produced by using an optical alignment layer are disclosed in JP-A-2009-193014 and JP-A-2007-71952 respectively. The processes employing an optical alignment layer contain the complicated step of irradiating the optical alignment layer with light in plural directions different from each other. The processes employing a rubbed alignment layer for producing an optically anisotropic patterned layer are also known. However, any of the processes contain the complicated step of rubbing a surface in plural directions different from each other.

One the other hand, an alignment layer containing a photo-acid-generating agent is disclosed in JP-A-2006-220891, and it is also disclosed that the resistance for saponification can be improved adding the photo-acid-generating agent. However, using the alignment layer in producing an optically anisotropic patterned layer is not disclosed.

### SUMMARY OF THE INVENTION

If any step of rubbing a surface in plural directions different from each other is not necessary in forming an optically anisotropic patterned layer, it may be possible to simplify the process remarkably, which may be advantageous for a continuous manufacture. However, as described above, previously, an alignment layer which is subjected to an alignment treatment in plural directions different from each other (for example, a photo-alignment layer which is subjected to an irradiation of light in plural directions different from each other or a rubbed alignment layer which is subjected to a rubbing treatment in plural directions different from each other by mask-rubbing) has generally been considered necessary for forming any optically anisotropic patterned layer. And there may not have been any idea that any optically anisotropic patterned layer would be prepared by using only an alignment layer subjected to an alignment direction in one direction.

First object of the invention is to provide an optical film, having an optically anisotropic layer with a high-definition alignment pattern, which can be prepared readily and is excellent in usefulness.

Second object of the invention is to provide a simple process for producing such an optical film.

Third object of the invention is to provide an image display device and a stereoscopic display device system having a high level of visibility which can be produced in low cost.

Fourth object of the invention is to provide a novel patterned alignment layer which is useful for forming an optically anisotropic patterned layer.

The means for achieving the above-described objects are as follows.

<1> An optical film comprising:

a transparent support, and thereon,

an alignment layer comprising at least one photo-acid-generating agent, and

an optically anisotropic layer formed of a composition comprising a liquid crystal having a polymerizable group as a main ingredient;

wherein the optically anisotropic layer is an optically anisotropic patterned layer comprising a first retardation domain and a second retardation domain disposed alternately in a plane.

<2> The optical film of <1>, wherein the alignment layer is an alignment layer subjected to an alignment treatment in one direction.
<3> The optical film of <1> or <2>, wherein the at least one photo-acid-generating agent is decomposed at least partially, and the degrees of decomposition thereof are different between the domains of the alignment layer corresponding to the first and second retardation domains respectively.
<4> The optical film of <3>, wherein an acidic compound or an ion thereof generated from the at least one photo-acid-generating agent exists in at least a part of the optically anisotropic layer, and the ratios of the acidic compound or the ion contained in the first retardation domain and the second retardation domain respectively are different to each other.
<5> The optical film of any one of <1>-<4>, wherein slow axes in plane of the first retardation domain and the second retardation domain are orthogonal to each other.
<6> The optical film of any one of <1>-<5>, which has Re(550) falling within the range from 110 nm to 165 nm, wherein Re (550) (unit: nm) is retardation in plane at a wavelength of 550 nm.
<7> The optical film of any one of <1>-<6>, wherein Re (550) of the transparent support is from 0 nm to 10 nm.
<8> The optical film of any one of <1>-<7>, which has Rth(550) satisfying |Rth(550)|≦20, wherein Rth (550) (unit: nm) is retardation along the thickness at a wavelength of 550 nm.
<9> The optical film of any one of <1>-<6>, wherein the transparent support is a glass plate.
<10> The optical film of any one of <1>-<9>, wherein the alignment layer comprises modified or non-modified polyvinyl alcohol as a main ingredient.
<11> The optical film of any one of <1>-<10>, wherein the liquid crystal having a polymerizable group is a discotic liquid crystal.
<12> The optical film of any one of <1>-<11>, wherein the optically anisotropic layer further comprises at least one onium salt.
<13> The optical film of <12>, wherein the at least one onium salt in the optically anisotropic layer is at least partially anion-exchanged with an acid compound generated from the photo-acid-generating agent.
<14> The optical film of <13>, wherein the anion-exchange ratios of the onium salt in the first retardation domain and the second retardation domain are different from each other.
<15> The optical film of any one of <1>-<14>, wherein the optically anisotropic layer further comprises at least one compound represented by formula (Ia):

T-X¹-Q (Ia)

wherein X¹ represents a single bond or divalent linking group, hydrogen atom, or substituted or non-substituted alkyl, alkenyl, alkynyl, aryl or heteroaryl; T represents a substituent having a polymerizable group; Q represents a boronic acid or boronic acid ester; and the compound may have no T, and in the compound having T, X¹ represents a divalent linking group.

<16> The optical film of any one of <1>-<15>, wherein the optically anisotropic layer further comprises at least one fluoroaliphatic group-containing copolymer.
<17> The optical film of any one of <1>-<16>, wherein the liquid crystal having a polymerizable group is a discotic liquid crystal, and the discotic liquid crystal in the optically anisotropic layer is fixed in a vertical alignment state.
<18> A polarizing plate comprising an optical film of any one of <1>-<17>, and a polarizing film, wherein the angle between each of slow axes in plane of the first retardation domain or the second retardation domain and an absorption axis of the polarizing film is 45°.
<19> The polarizing plate of <18>, wherein the optical film and the polarizing film are bonded via a pressure-sensitive adhesive layer.
<20> The polarizing plate of <18> or <19>, which further comprises a monolayered or multilayered light-antireflective film disposed at an outermost surface.
<21> An image display device comprising:

a first polarizing film and a second polarizing film,

a liquid crystal cell disposed between the first and second polarizing films, comprising a pair of substrates and a liquid crystal layer disposed between the pair of substrates, and

an optical film of any one of <1>-<17> disposed on the outer side of the first polarizing film;

wherein the angle between each of slow axes in plane of the first retardation domain or the second retardation domain of the optical film and an absorption axis of the first polarizing film is ±45°.

<22> The image display device of <21>, which further comprises a third polarizing plate disposed on the outer side of the optical film so as to be capable of allowing a viewer to see stereoscopic imagery through the third polarizing plate.
<23> A process for producing an optical film of any one of <1>-<17>, comprising, in the following order:

1) forming an alignment layer of a composition, comprising at least one photo-acid-generating agent, on a transparent support;

2) irradiating the alignment layer with light through a photo-mask, thereby to decompose the at least one photo-acid-generating agent in the irradiated area, and to generate an acidic compound in the irradiated area;

3) applying a composition, comprising a liquid crystal having a polymerizable group as a main ingredient, to the alignment layer, thereby to form a coated layer;

4) aligning the liquid crystal at a temperature of T₁ degrees Celsius, so that a slow axis of the irradiated domain is aligned along a first direction and a slow axis of the non-irradiated domain is aligned along a second direction which is different from the first direction; and

5) polymerizing the liquid crystal at a temperature of T₂ (T₁>T₂) degrees Celsius, thereby to fix the liquid crystal in an alignment state, and to form an optically anisotropic patterned layer with a first retardation domain and a second retardation domain having slow axes which are aligned along the directions different from each other.

<24> The process of <23>, further comprising rubbing the alignment layer along one direction between the 1) and the 2) steps, or the 2) and 3) steps.
<25> The process of <23> or <24>, wherein carrying out the 2) step brings about the difference in aligning force between the irradiated area and the non-irradiated area of the alignment layer.
<26> The process of <25>, wherein

the composition to be used in the 3) step comprises an agent capable of controlling alignment at an alignment layer-interface; and

an acidic compound or an ion thereof, generated in the irradiated area of the alignment layer during the 2) step, decreases the degree of localization of the agent to the alignment-layer interface, thereby to bring about the difference in aligning force between the irradiated area and the non-irradiated area of the alignment layer.

<27> The process of <26>, wherein decrease in the degree of localization of the agent to the alignment-layer interface is caused by anion exchange between the agent and the acidic compound or the ion thereof generated in the irradiated area of the alignment layer.
<28> A patterned alignment layer with a first alignment domain and a second alignment domain disposed alternately in a plane, comprising a photo-acid-generating agent;

wherein the degrees of decomposition of the photo-acid-generating agent are different between the first alignment domain and the second alignment domain. the ratios of the acidic compound or the ion thereof are different between the first retardation domain and the second retardation domain.

<29> The patterned alignment layer of <28>, wherein a surface thereof is subjected to an alignment treatment in one direction.

According to the present invention, it is possible to provide an optical film, having an optically anisotropic layer with a high-definition alignment pattern, which can be prepared readily and is excellent in usefulness.

According to the present invention, it is possible also to provide a simple process for producing such an optical film.

According to the present invention, it is possible also to provide an image display device and a stereoscopic display device system having a high level of visibility which can be produced in low cost.

According to the present invention, it is possible also to provide a novel patterned alignment layer which is useful for forming an optically anisotropic patterned layer.

### BRIEF DESCRIPTION OF THE DRAWINGS

FIG. 1 is a cross-section view showing a frame format of an example of the optical film of the present invention.

FIG. 2 is a top view showing a frame format of an example of the optically anisotropic patterned layer according to the present invention.

FIG. 3 is a top view showing a frame format of an example of the alignment layer according to the present invention.

FIG. 4 is a cross-section view showing a frame format of an example of the polarizing plate of the present invention.

FIG. 5 shows the evaluation results of the optical characteristics of the optical film prepared in Example.

FIG. 6 shows the evaluation results of the optical characteristics of the optical film prepared in Example.

FIG. 7 shows the evaluation results of the optical characteristics of the optical film prepared in Example.

FIG. 8 shows the evaluation results of the optical characteristics of the optical film prepared in Example.

FIG. 9 shows the evaluation results of the optical characteristics of the optical film prepared in Example.

FIG. 10 shows the evaluation results of the optical characteristics of the optical film prepared in Example.

### MODE FOR CARRYING OUT THE INVENTION

The invention is described in detail hereinunder. Note that, in this patent specification, any numerical expressions in a style of “ . . . to . . . ” will be used to indicate a range including the lower and upper limits represented by the numerals given before and after “to”, respectively.

In the description, the term “visible light” is used for any light having wavelengths from 380 nm to 780 nm. In the description, the wavelength of measurement is 550 nm as far as there is no specific notation.

In the description, the angles (for example, “90°”) and the relations thereof (for example, expression of “orthogonal”, “parallel” or “crossed by 45°”) should be interpreted so as to include errors generally acceptable in the technical field to which the present invention belongs. For example, the angle desirably falls within a range of an exact angle±an angle less than 10°, more desirably within a range of an exact angle ±5°, or even more desirably within a range of an exact angle ±3°.

In the specification, the term “optical film” is used widely for any film-like members without depending on their flexibility, and for example, is used also for the members having a glass plate as a transparent support.

### 1. Optical Film

The present invention relates to an optical film comprising:

a transparent support, and thereon,

an alignment layer comprising at least one photo-acid-generating agent, and

an optically anisotropic layer formed of a composition comprising a liquid crystal having a polymerizable group as a main ingredient;

wherein the optically anisotropic layer is an optically anisotropic patterned layer comprising a first retardation domain and a second retardation domain disposed alternately in a plane.

In the embodiment wherein the optical film of the present invention is disposed on the outer side of a visual-side polarizing film in a display device capable of displaying stereoscopic imagery, the polarization images formed by lights going through the first and second retardation domains respectively are recognizable as a right-eye image and a left-eye image via a polarization selective eyewear or the like. Accordingly, the first and second retardation regions preferably have a same shape and are preferably arranged homogenously and symmetrically so as not to form the right-eye image and a left-eye image unhomogeneously.

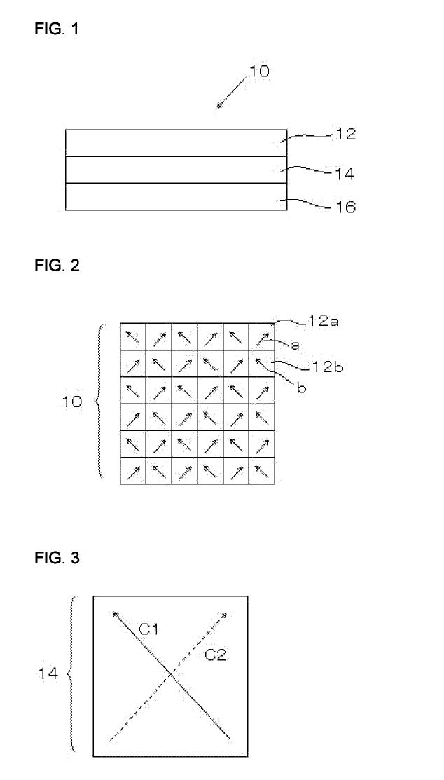

The cross-section view and the top view showing a frame format of an example of the optical film of the present invention are shown in FIG. 1 and FIG. 2 respectively. The optical film 10 shown in FIG. 1 and FIG. 2 has a transparent support 16, an alignment layer 14, and an optically anisotropic layer 12, and the optically anisotropic layer 12 is an optically anisotropic patterned layer in which first and second retardation domains 12a and 13b are disposed homogenously and symmetrically in a displaying plane. A slow axis “a” of the first retardation domain 12a is preferably orthogonal to a slow axis “b” of the second retardation domain 12b. According to the embodiment using circular polarization, Re of the first and second domains of the optically anisotropic layer 12 is preferably λ/4, more specifically, from 110 nm to 165 nm, or preferably from 120 nm to 145 nm. In the embodiment wherein the transparent support 16 is a retardation film, Re of the optical film as a whole, including Re of the transparent support 16, preferably falls within the above-described range. In an example thereof, the transparent support 16 is a low-retardation film, or more specifically, a film having Re (550) of from 0 to 10 nm.

Smaller Rth of the optical film is more preferable in terms of preventing the crosstalk. In particular, the absolute value of Rth of the optical film as a whole is preferably equal to or smaller than 20 nm.

The alignment layer 14 of the optical film 10 contains a photo-acid-generating agent. An embodiment of the alignment layer 14 is a patterned alignment layer with a first alignment domain and a second alignment domain arranged alternately in a plane, containing at least a non-modified or modified polyvinyl alcohol as a main ingredient along with the photo-acid-generating agent; the surface thereof is subjected to a rubbing treatment in one direction; and the degrees of decomposition of the photo-acid-generating agent in the first and second alignment domains are different from each other. The degree of decomposition of the photo-acid-generating agent can be known by determination of an amount of the acidic compound generated due to the decomposition of the photo-acid-generating agent in each of the alignment domains. One embodiment of the alignment layer to be used in preparing the optically anisotropic patterned layer, having the first and second retardation domains 12a and 12b, is a patterned alignment layer having a first and second alignment domains corresponding to the first and second retardation domains 12a and 12b respectively; and the degrees of decomposition of the photo-acid-generating agent in the first and second alignment domains are different from each other, or namely, the ratios of the acidic compound generated due to the decomposition of the photo-acid-generating agent in the first and second alignment domains are different from each other. According to the alignment layer of the embodiment, the difference in aligning force between the first and second alignment domains is attributed to the difference in concentration of the acidic compound or ion thereof generated due to the decomposition of the photo-acid-generating agent therebetween. In one example of the alignment layer of the embodiment, one of the first and second alignment domains contains the photo-acid-generating agent in a state not decomposed yet, and another contains the acidic compound or ion thereof generated due to the decomposition of the photo-acid-generating agent since a part of the photo-acid-generating agent is already decomposed.

The photo-acid-generating agent which can be used in the invention will be described in detail later.

The alignment layer 14 preferably has the first and second alignment documents of which alignment forces are different from each other. However, according to the invention, for developing the ability of controlling alignment, carrying out any alignment treatment in plural directions may not be necessary. Namely, any complicated step such as a step of rubbing in plural directions by a mask-rubbing or the like may not be carried out. The alignment layer is preferably subjected to a rubbing treatment in one direction. One embodiment of the alignment layer to be used in preparing the optically anisotropic patterned layer, having the first and second retardation domains 12a and 12b, shown in FIG. 2 is an alignment layer subjected to a rubbing treatment along one direction C1 or C2, as shown in FIG. 3, which is parallel to the slow axis “a” of the first retardation domain 12a or the slow axis “b” of the second retardation domain 12b

The alignment layer 14 may be a photo-alignment layer if possible. For example, a photo-alignment layer having an aligning force along one direction caused by irradiation of light may be used. Generally, a rubbed alignment layer can maintain the alignment force even if it has a certain thickness; and therefore, even if the surface of the transparent support 16 is uneven, it may be possible to planarize the surface by using a rubbed alignment layer having a thickness which is enough to compensate the uneven surface. On the other hand, generally, the thickness of a photo-alignment layer should be thin for exhibiting the alignment force; and therefore, it may be impossible to planarize the uneven surface by using a photo-alignment layer since, for exhibiting the alignment force, it should be a thickness which is not enough to compensate the uneven surface. Therefore, in terms of planarizing an uneven surface of a transparent support and preparing an optically anisotropic patterned layer stably, a rubbed alignment layer may be preferred to a photo-alignment layer.

The optically anisotropic layer 16 is an optically anisotropic layer formed of a composition containing a liquid crystal having a polymerizable group as a main ingredient. Namely, according to the invention, it is not necessary to add any different ingredient to the composition or vary the ratio of the ingredient in the composition for forming the first and second retardation domains. One example of the optically anisotropic layer 16 is an optically anisotropic layer formed of a composition containing a discotic liquid crystal as a main ingredient. In the optically anisotropic layer, the discotic liquid crystal is preferably fixed in an alignment state (vertical alignment state) in which the discotic faces of the discotic liquid crystal molecules are aligned vertically with respect to the layer plane. And the composition may contain at least one agent capable of controlling the alignment of the liquid crystal. Examples of the agent capable of controlling the alignment which can be used in the present invention include both of agents capable of localizing to the alignment layer interface and controlling the alignment of liquid crystal at the alignment layer interface and agents capable of localizing to the air-interface and controlling the alignment of liquid crystal at the air-interface. The optically anisotropic layer 16 may contain both of them. Preferable examples of the agent capable of controlling the alignment which can be used in the present invention include pyridinium compounds and imidazolium compounds.

The liquid crystal and the agent capable of controlling the alignment to be used for preparing the optically anisotropic layer 16 will be described in detail later.

An acid compound or a counter anion thereof generated due to the decomposition of the photo-acid generating agent in the alignment layer 14 may exist in the optically anisotropic layer 16. In one embodiment of the invention, an acidic compound or an ion thereof generated from the photo-acid-generating agent exists in the optically anisotropic layer, and the ratios of the acidic compound or the ion thereof are different between the first retardation domain and the second retardation domain. According to the embodiment, the difference in the ratio of the acidic compound or the ion thereof between the first retardation domain and the second retardation domain may allow the liquid crystal in the domains to align in the manner which is different between the domains. For example, the optically anisotropic layer 16 may contain an onium salt as an agent capable of controlling the alignment, and the onium salt in the optically anisotropic layer may be at least partially anion-exchanged with the acid compound generated from the photo-acid-generating agent. According to the embodiment, the difference in the anion-exchange ratio of the onium salt between the first retardation domain and the second retardation domain may allow the liquid crystal in the domains to align in the manner which is different between the domains

Next, the process for producing the optical film of the present invention and the members thereof will be described in detail.

### (1) Process for Producing Optical Film

One example of the process for producing the optical film of the invention comprises:

1) forming an alignment layer of a composition, comprising at least one photo-acid-generating agent, on a transparent support;

2) irradiating the alignment layer with light through a photo-mask, thereby to decompose the at least one photo-acid-generating agent in the irradiated area, and to generate an acidic compound in the irradiated area,

3) applying a composition, comprising a liquid crystal having a polymerizable group as a main ingredient, to the alignment layer, thereby to form a coated layer,

4) aligning the liquid crystal at a temperature of T₁ degrees Celsius, so that a slow axis of the irradiated domain is aligned along a first direction and a slow axis of the non-irradiated domain is aligned along a second direction which is different from the first direction; and

5) polymerizing the liquid crystal at a temperature of T₂ (T₁>T₂) degrees Celsius, thereby to fix the liquid crystal in an alignment state, and to form an optically anisotropic patterned layer with a first retardation domain and a second retardation domain having slow axes which are aligned along the directions different from each other.

In the process, for forming the optically anisotropic patterned layer, an alignment layer subjected to an alignment treatment along one direction is preferably used, or an alignment layer subjected to a rubbing or photo-alignment treatment along one direction is more preferably used. The alignment treatment may be carried out between the 1) and the 2) steps, or the 2) and 3) steps. The alignment treatment is preferably carried out between the 1) and the 2) steps.

The rubbed alignment layer becomes to exhibit the ability of controlling alignment by being subjected to a rubbing treatment. Generally, if a liquid crystal is aligned on a surface subjected to a rubbing treatment along one direction, the liquid crystal is aligned so that the slow axis thereof is parallel to or orthogonal to the rubbing direction. Which alignment state is obtained may depend on various factors such as the type of the material of the alignment layer, the type of liquid crystal and the type of the agent capable of controlling the alignment. As described later, according to the present invention, the action of the acid compound generated by irradiation with ultraviolet light to the alignment layer contributes to decomposing the material of the alignment layer and/or varying the localization property of the agent capable of controlling, thereby to achieve both of the alignment state with the slow axis of the liquid crystal parallel to the rubbing direction and the alignment state with the slow axis of the liquid crystal orthogonal to the rubbing direction. The pattern, having a preferable shape and arrangement, of the optically anisotropic layer, or the preferable shape and arrangement of the first and second retardation regions thereof, may be obtained by selecting a photo-mask to be used in the 2) step. In the embodiment to be used in a stereoscopic display device capable of displaying stereoscopic imagery, preferably, the first and second retardation domains are stripes with the same short side, and are arranged alternately.

According to the process of the present invention, the slow axis of the liquid crystal in the area irradiated with the light is aligned along a first direction; and the slow axis of the liquid crystal in the area not irradiated with the light is aligned along a second direction which is different from the first direction. Since the photo-acid-generating agent is decomposed by irradiation of the light, the difference in the ration of an acid compound generated by the decomposition of the photo-acid-generating agent occurs between the irradiated area and the non-irradiated area of the alignment layer, which can bring about the difference in aligning force between the areas. One example thereof is as follows.

In the non-irradiated area, since the photo-acid-generating agent exists in the almost undecomposed state, the alignment state is decided dominantly by the interaction of the alignment-layer material, the liquid crystal and the agent capable of controlling the alignment which is added if desired. Under such a control, the liquid crystal is aligned so that the slow axis thereof is orthogonal to the rubbing direction. After being irradiated with the ultraviolet light, since an acid compound is generated from the photo-acid-generating agent in the irradiated area and the interaction is not dominative anymore, the alignment state in the irradiated area is dominantly controlled by the rubbing direction of the rubbed alignment layer. Under such a control, the liquid crystal is aligned so that the slow axis thereof is parallel to the rubbing direction. The preferable conditions achieving these states may vary depending on the type and/or the amount of each ingredient and the irradiation condition, and the preferable condition in all of the embodiments cannot be decided. According to the invention, generation and dispersion of the acid compound occurs, and therefore, the environmental condition including the temperature and the humidity, or the irradiance level may contribute to the pattern accuracy. For example, the step of rubbing the alignment layer or applying the coating liquid is preferably carried out under the condition with a high temperature and a high humidity, in particular, the humidity is preferably equal to or higher than 40%, or more preferably equal to or higher than 60%. Adding a small amount of water to the liquid crystal composition to be used for forming the optically anisotropic layer is also preferable.

In the example, the coating liquid to be used in the 3) step may comprise an agent capable of controlling alignment at an alignment layer-interface; and an acidic compound or an ion thereof, generated in the irradiated area of the alignment layer during the 2) step, may decrease the degree of localization of the agent to the alignment-layer interface, thereby to bring about the difference in aligning force between the irradiated area and the non-irradiated area of the alignment layer. By using an onium salt as the agent capable of controlling alignment at an alignment layer-interface, it is possible to align a discotic liquid crystal so that the disk-faces of the discotic liquid crystal molecules are orthogonal to the rubbing direction and vertical to the layer plane, or namely align a discotic liquid crystal in an orthogonal and vertical alignment state. In the non-irradiated area, since the agent capable of controlling alignment at an alignment layer-interface is localized to the alignment layer interface, the discotic liquid crystal is aligned in the orthogonal and vertical alignment state. However, after being irradiated with the light, since the localization property of the agent is decreased by an acid compound or ion thereof generated from the photo-acid-generating agent and the action of the agent is weakened, the alignment state in the irradiated area is dominantly controlled by the rubbing direction of the rubbed alignment layer. Under such a control, the discotic liquid crystal is aligned so that the disk-faces of the discotic liquid crystal molecules are parallel to the rubbing direction and vertical to the layer plane, or namely the alignment state of the discotic liquid crystal transfers to a parallel and vertical alignment state.

In the embodiment, the decrease of the localization to the alignment layer interface of the agent capable of controlling the alignment at the alignment layer interface may be caused by the ion-exchange of the ion constituting the agent capable of controlling the alignment at the alignment layer interface with the ion constituting the acidic acid generated from the photo-acid-generating agent in the irradiated area. According to the embodiment in which an onium salt of pyridinium or imidazolium compound is used as an agent capable of controlling the alignment at the alignment layer interface, the decrease of the localization to the alignment layer interface of the onium salt may be caused by the anion-exchange of the onium salt with the acidic compound generated from the photo-acid-generating agent in the irradiated area.

In the 2) step, irradiation of light through a photo-mask is carried out for generating an acidic compound. As described above, since the acidic compound is generated and dispersed while the photo-acid-generating agent is decomposed, in the step of irradiation of light through a photo-mask, UV light is preferable, or non-polarized UV light is more preferable. The peak of the irradiation wavelength is preferably from 200 nm to 250 nm; and an UV-C light source is preferably used. The irradiation amount thereof is preferably from about 5 mJ/cm² to about 1000 mJ/cm², or more preferably from about 5 mJ/cm² to about 50 mJ/cm². If the irradiation amount is too small, it may be impossible to form a patter. On the other hand, if the irradiation amount is too large, the resolution may be decreased due to the dispersion of the acidic compound. For improving the resolution, irradiation of light is preferably carried out at a room temperature.

The condition of the photo-irradiation may be decided depending on the formulation of the alignment layer or the like, and therefore, the condition thereof is not limited to the above.

In the 5) step, fixing the alignment state is preferably achieved by carrying out the polymerization of a polymerizable liquid crystal under irradiation of the light (for example, under irradiation of UV light). The irradiation energy is preferably from 10 mJ/cm² to 10 J/cm², or more preferably from 25 mJ/cm² to 800 mJ/cm². The illumination intensity is preferably from 10 mW/cm² to 1000 mW/cm², more preferably from 20 mW/cm² to 500 mW/cm², or even more preferably from 40 mW/cm² to 350 mW/cm². The peak of the irradiation wavelength is preferably from 250 nm to 450 nm, or more preferably from 300 nm to 410 nm. For promoting the photo-polymerization, irradiation of light may be carried out under an atmosphere of an inert gas such as nitrogen gas or under heat. As the light source, a low-pressure mercury lamp (e.g., bactericidal lamp, fluorescence chemical lamp, black light), a high-pressure discharge lamp (e.g., high-pressure mercury lamp, metal halide lamp), or a short-ark discharge lamp (e.g., ultra high-pressure mercury lamp, xenon lamp, mercury-xenon lamp) is preferably used.

Since the polymerization for fixing the alignment state is carried out enough promptly, the alignment state of the optically anisotropic layer is not influenced even if the decomposition of the photo-acid-generating agent occurs by irradiation of the light to a whole surface in the 5) step.

Fixing the alignment state in the 5) step is carried out at T₂ degrees Celsius so that T₁>T₂ is satisfied in the relation with the alignment temperature of T₁ degrees Celsius in the 4) step. If the condition is satisfied, it is possible to fix the alignment state while preventing the disorder of the alignment state. The preferable ranges of T₁ degrees Celsius and T₂ degrees Celsius may be varied depending on the materials to be used. Generally, T₁ is preferably from about 50 degrees Celsius to about 150 degrees Celsius; and T₂ is preferably from about 20 degrees Celsius to about 120 degrees Celsius. The difference between T₁ and T₂ is preferably about 10 degrees Celsius to about 100 degrees Celsius.

### Alignment Layer:

An alignment layer which can realize an optically anisotropic patterned layer is formed by the 1) and 2) steps. Furthermore, an alignment treatment along one direction is preferably carried out between the 1) and 2) steps or the 2) and 3) steps. The alignment treatment is preferably a rubbing treatment. Namely, in the invention, a rubbed alignment layer is preferably used.

The “rubbed alignment layer” which can be used in the invention means a film subjected to a treatment by rubbing so as to exhibit an ability of controlling the alignment. The rubbed alignment layer has an alignment axis controlling the alignment of liquid crystal molecules, and liquid crystal molecules are aligned on the basis of the alignment axis. According to the invention, liquid crystal molecules in the irradiated area are aligned so that the slow axes thereof are parallel to the rubbing direction of the alignment layer, liquid crystal molecules in the non-irradiated area are aligned so that the slow axes thereof are orthogonal to the rubbing direction of the alignment layer; and for obtaining the alignment states, the material of the alignment layer, the photo-acid-generating agent, liquid crystal and the agent capable of controlling agent may be selected.

Generally, a rubbed alignment layer contains a polymer as a main ingredient. The description regarding the polymer materials for alignment layers can be found in various documents, and many materials may be commercially available. The polymer material which can be used in the present invention is preferably selected from polyvinyl alcohols, polyimides, or any derivatives thereof. Especially, modified or non-modified polyvinyl alcohols are preferable. Polyvinyl alcohols having any saponification degree may be available, and according to the invention, polyvinyl alcohols having a saponification degree of from about 85 to about 99 are preferably used. Any commercially available polyvinyl alcohols may be used, and, in particular, both of “PVA103” and “PVA203” (Kuraray Co., Ltd.) are polyvinyl alcohols having the saponification degree falling within the above-described range. The modified polyvinyl alcohols, described in WO01/88574A1, p. 43, line 24-p. 49, line 8, or in Japanese Patent No. 3907735, columns 0071-0095, may be referred. The thickness of the alignment layer is preferably from 0.01 to 10 micro meters, or more preferably from 0.01 to 1 micro meter.

Usually, the rubbing treatment may be carried out by rubbing the surface of a layer, containing polymer as a main ingredient, several times in a constant direction with paper or cloth. The normal methods of the rubbing treatment are described in “Handbook of Liquid Crystals (Ekisho Binran)” published by Maruzen co., Ltd, Oct. 30, 2000), or the like.

In order to vary rubbing densities of alignment layers, it is possible to adopt methods described in “Handbook of Liquid Crystals (Ekisho Binran)” published by Maruzen co., Ltd. A rubbing density (L) can be defined by Formula (A) below.

L=NI(1+2πrn/60v) Formula (A)

“N” is a number of rubbing, “I” is a contact length of a rubbing roller, “r” is a radius of the roller, “n” is a rotation speed (rpm) of the roller, and “v” is a moving velocity of a stage (per a sec).

When increasing rubbing density, rubbing treatment may be carried out with a higher number of rubbing, longer I, longer contact length of a rubbing roller, larger radius of the roller, higher rotation speed of the roller, or smaller moving velocity of a stage; on the other hand, when decreasing rubbing density, rubbing treatment may be carried out in opposite ways.

There is a relationship between a rubbing density and a pre-tilt angle of an alignment layer that the higher rubbing density the alignment layer is treated with, the lower pre-tilt angle of the alignment layer is; and the smaller rubbing density the alignment layer is treated with, the larger pre-tilt angle of the alignment layer is.

An alignment layer to be bonded to a long polarizing film having an absorption axis parallel to the long direction thereof may be prepared by forming a polymer layer on a long polymer film, which is a support, and then rubbing the surface of the layer in a 45° direction relative to the long direction.

Any photo-alignment layer may be used if possible (for example, in the case that the process of light irradiation for decomposition of the photo-acid-generating agent and the process of light irradiation for developing the photo-alignment ability can be carried out separately).

### Photo-Acid-Generating Agent:

The alignment layer of the present invention contains at least one photo-acid-generating agent. The photo-acid-generating agent is any compound capable of decomposing by light irradiation such as UV light irradiation and capable of generating an acidic compound. When the photo-acid-generating agent decomposes and then an acidic compound is generated, the variation of the orientation-controlling ability occurs. The variation of the orientation-controlling ability may be identified as a variation of the orientation-controlling ability achieved by only an alignment layer, may be identified as a variation of the orientation-controlling ability achieved by an alignment layer and other factor(s) such as an additive in a composition for preparing an optically anisotropic layer disposed on the alignment layer, or may be identified as any combination thereof.

The discotic liquid crystal, described later, may be aligned in an orthogonal-vertical alignment state by being added with an onium salt. When the anion-exchange is carried out between the acidic salt which is generated via the decomposition and the onium salt, the localization of the onium salt to the interface of the alignment layer may be reduced, the ability of aligning the discotic liquid crystal in the orthogonal-vertical alignment state may be weakened, and then the discotic liquid crystal may be aligned in a parallel-vertical-alignment state. Or, when a polyvinyl alcohol-base alignment layer is used, the ester portions thereof may be decomposed by a generated acidic compound, which may change the localization property of the onium salt to the interface of the alignment layer.

As the photo-acid-generating agent to be used in the alignment layer, water-soluble compounds are preferable. Examples of the photo-acid-generating agent include those described in Prog. Polym. Sci., vol. 23, p. 1485, 1998. As the photo-acid-generating agent, pyridinium, iodonium or sulfonium salts are especially preferable. Preferable examples of the pyridinium, iodonium or sulfonium salt include those represented by the following formulas.

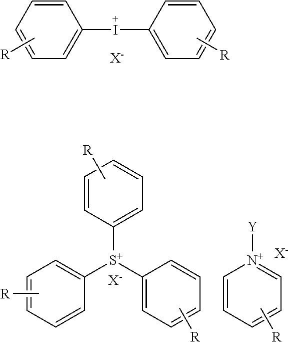

In the formulas, R represents a hydrogen atom, a linear or branched C₁₋₆ alkyl, a linear or branched C₁₋₆ alkoxy, a C₆₋₁₂ aryl or a halogen atom. Y represents a linear or branched C₁₋₆ alkyl, or a linear or branched C₁₋₆ alkoxy. X⁻ represents a counter anion of a pyridinium salt, iodonium salt or sulfonium salt, which becomes an anion of an acidic compound generated by the decomposition. Preferably, X⁻ represents PF₆⁻ or BF₄⁻. For example, the acid, HBF₄, generates from the photo-acid-generating agent having BF₄⁻ as X⁻; and the acid, HPF₆, generates from the photo-acid-generating agent having PF₆⁻ as X.

Examples of the photo-acid-generating agent include, but are not limited to, those shown below.

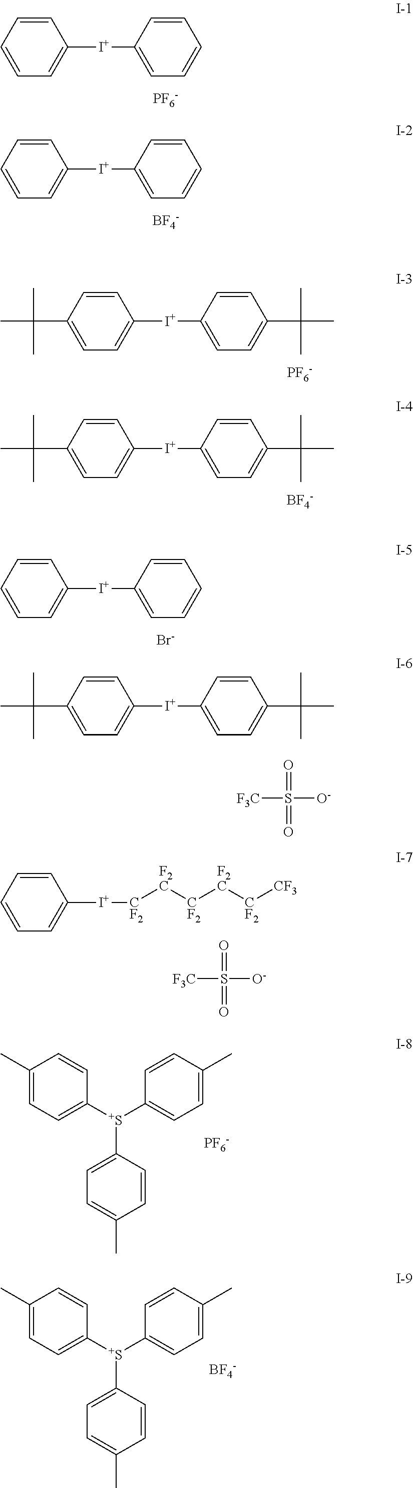

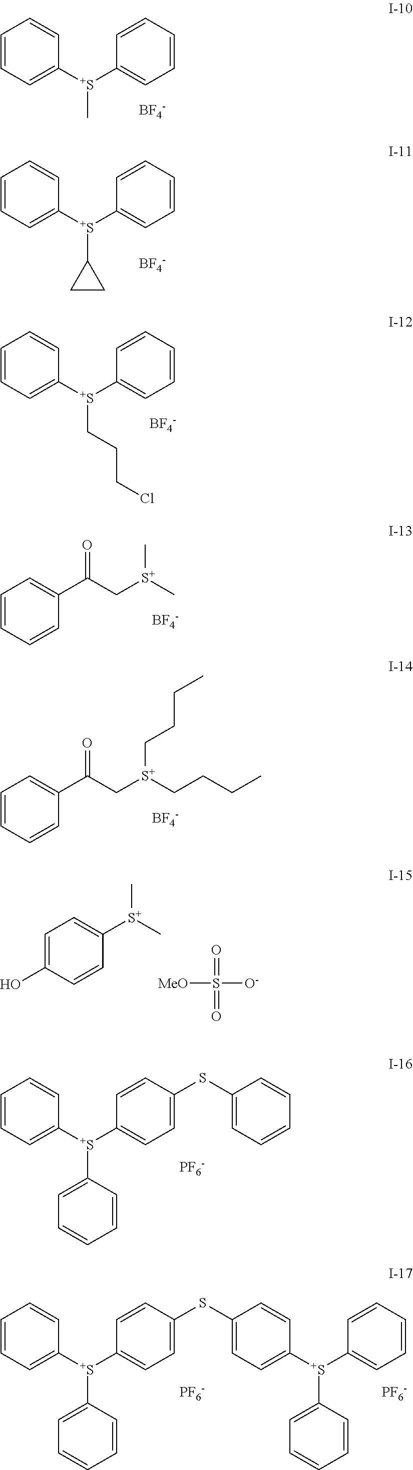

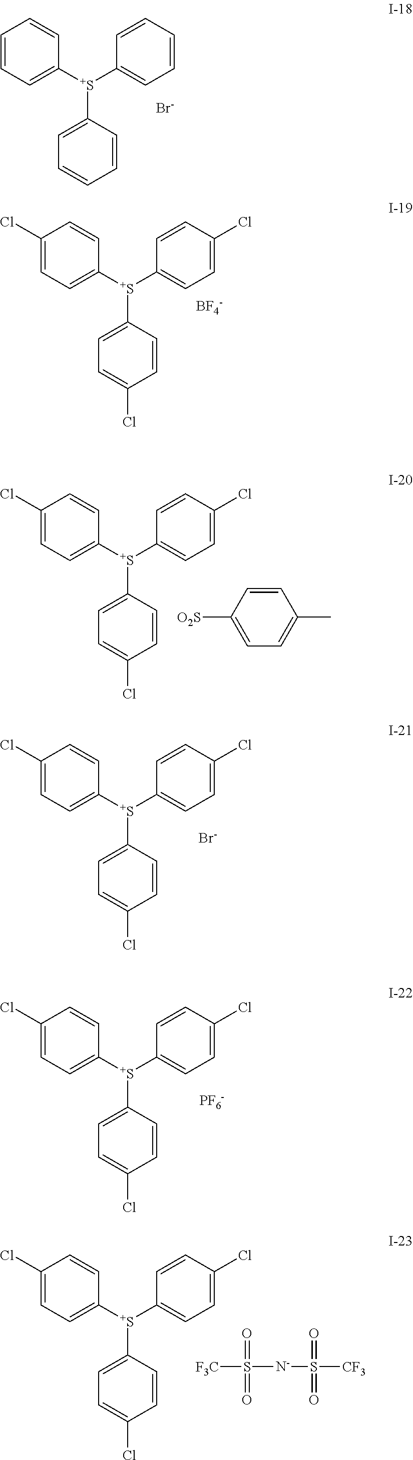

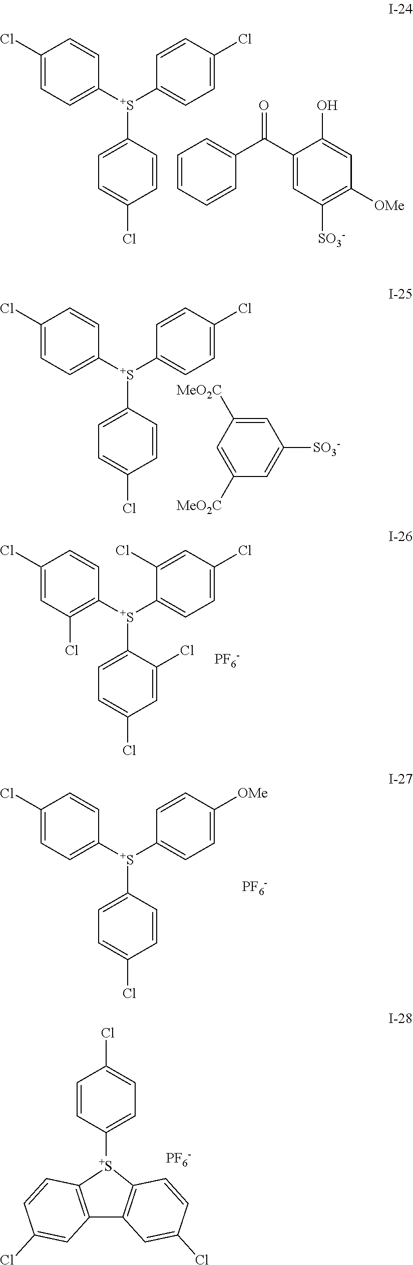

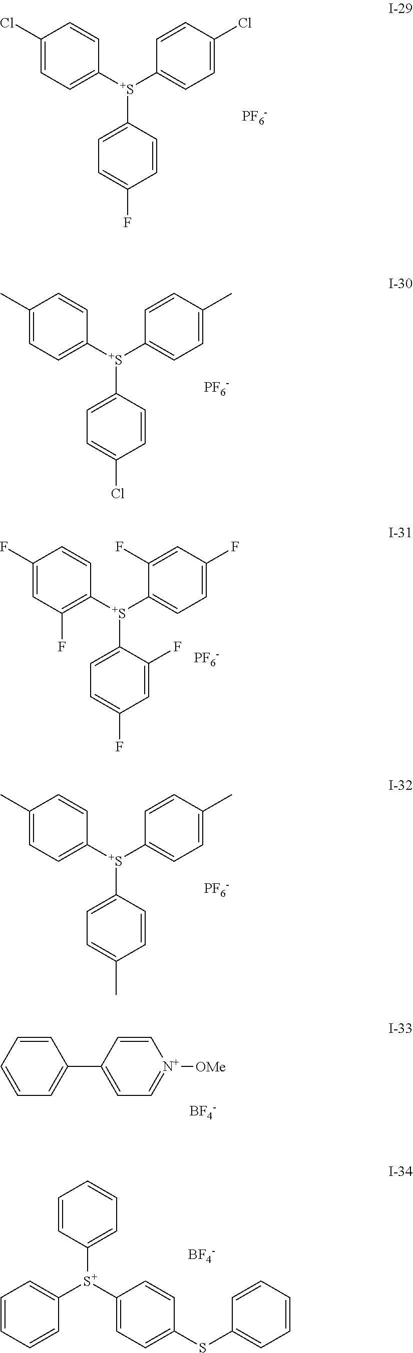

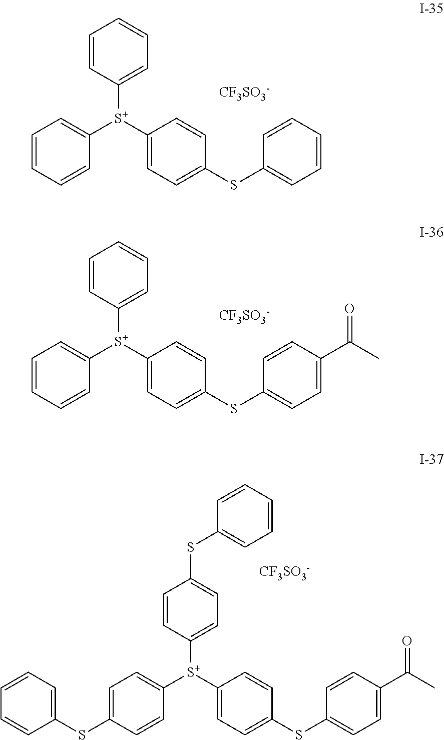

The composition to be used in the alignment layer is preferably prepared as a coating liquid. The solvent to be used for preparing the coating liquid preferably contain water, more preferably contain water in an amount of equal to or more than 20% by mass, or even more preferably contain water in an amount of from 50 to 80% by mass. It is possible to prevent or control the dissolution of the substrate into the solvent by using any coating liquid containing water

An amount of each of the ingredients contained in the composition for preparing the alignment layer may be decided so as to form the alignment layer stably. For example, an amount of the polymer material which is the main ingredient of the alignment layer is from 2.0 to 10.0% by mass, or more preferably from 2.0 to 5.0% by mass, with respect to the total mass of the composition (may contain the solvent). An amount of the photo-acid-generating agent to be added may be decided depending on the range capable of exchanging the counter anion with the above-described onium salt, and for example, is from 0.1 to 10.0% by mass, or more preferably from 0.5 to 5.0% by mass, with respect to the polymer material of the alignment layer. An amount of the solvent of the composition is for example from 80 to 98% by mass, or more preferably from 90 to 97% by mass, with respect to the total mass of the composition.

### Optically Anisotropic Patterned Layer:

In the 3) step, a composition, a coating liquid, containing a polymerizable liquid crystal as a main ingredient is applied to a surface subjected to a rubbing treatment of the alignment layer. The coating method is not limited, and any known coating method such as a curtain coating method, dip coating method, spin coating method, printing coating method, spray coating method, slot coating method, roll coating method, slide coating method, blade coating method, gravure coating method or wire bar coating method may be used.

In the 4) step, the liquid crystal is aligned so that the slow axis thereof is perpendicular or parallel to the rubbed direction. This enables the first or second slow axis to be determined, and the first and second retardation layers having the slow axis perpendicular to each other are formed. Furthermore, the alignment state achieved in this step by the liquid crystal is a factor determining the optical properties (Re and Rth) of the optically anisotropic layer. One preferable example of the optically anisotropic layer is a λ/4 plate capable of changing a linearly polarized light to a circularly polarized light. The optically anisotropic layer functioning as a λ/4 plate may be prepared according to any method. One example thereof is a method comprising a step of fixing the alignment state in which the slow axis of a rod-like liquid crystal compound having a polymerizable group is parallel to the layer plane, or a method comprising a step of fixing the alignment state in which the disc-like plane of a discotic liquid crystal is vertical to the layer plane. The latter method is more preferable.

One example of the composition to be used for preparing the optically anisotropic layer contains at least one liquid crystal compound, having a polymerizable group, and at least one alignment-controlling agent. The composition may further contain a polymerization initiator or a sensitizer.

Each of the materials which can be used will be described in details hereinafter.

### <Liquid Crystal Compound Having a Polymerizable Group>

Examples of the liquid crystal, which can be used as a main ingredient for the optically anisotropic layer of the invention, include rod-like liquid crystals and discotic liquid crystals. Discotic liquid crystals are preferable, and discotic liquid crystals having a polymerizable group are more preferable as described above.

Examples of the polymerizable rod-like liquid crystal compound include those described in Makromol. Chem., vol. 190, p. 2255 (1989), Advanced Materials, vol. 5, p. 107 (1993), U.S. Pat. No. 4,683,327, U.S. Pat. No. 5,622,648, U.S. Pat. No. 5,770,107, WO95/22586, WO95/24455, WO97/00600, WO98/23580, WO98/52905, JPA No. 1-272551, JPA No. 6-16616, JPA No. 7-110469, JPA No. 11-80081 and JPA No. 2001-328973. Plural types of polymerizable rod-like liquid crystal compounds may be used in combination, and any compound selected from those described in the documents may be used.

The low-molecular weight rod-like liquid crystal compound is preferably selected from formula (X).

Q₁-L¹-Cy¹-L²-(Cy²-L³)ₙ-Cy³-L⁴-Q² Formula (X)

In the formula, Q¹ and Q² each independently represent a polymerizable group; L¹ and L⁴ each independently represent a divalent linking group; L² and L³ each independently represent a single bond or a divalent linking group; Cy¹, Cy² and Cy³ each independently represent a divalent cyclic group; and n is 0, 1 or 2.

In the formula, Q¹ and Q² each independently represent a polymerizable group. The polymerization of the polymerizable group is an addition polymerization (including ring-opening polymerization) or a condensation polymerization. In other words, the polymerizable group is preferably a functional group capable of addition polymerization or condensation polymerization.

The discotic liquid crystal which can be used in the present invention as a main ingredient of the optically anisotropic layer is preferably selected from the compounds having a polymerizable group as describe above.

The discotic liquid crystal is preferably selected from the compounds represented by formula (I).

D(-L-H-Q)ₙ (I)

In the formula, D represents a disc-like core; L represents a divalent linking group; H represents a divalent aromatic ring or a heterocyclic ring; Q is a group containing a polymerizable group; and n is an integer of from 3 to 12.

The disc-like core (D) is preferably a benzene ring, naphthalene ring, triphenylene ring, anthraquinone ring, truxene ring, pyridine ring, pyrimidine ring, or triazine ring, or especially preferably a benzene ring, triphenylene ring, pyridine ring, pyrimidine ring or triazine ring.

L is preferably selected from the divalent liking group consisting of *—O—CO—, *—CO—O—, *—CH═CH—, *—C≡C— and any combinations thereof, or is especially preferably a divalent linking group containing at least one of *—CH═CH— and *—C≡C—. The symbol of “*” is a site bonding to D of the formula (I).

The aromatic ring represented by H is preferably a benzene ring or a naphthalene ring, or is more preferably a benzene ring. The heterocyclic ring represented by H is preferably a pyridine ring or pyrimidine ring, or is more preferably a pyridine ring. Preferably, H is an aromatic ring.

The polymerization of the polymerizable group in the group Q is an addition polymerization (including ring-opening polymerization) or a condensation polymerization. In other words, the polymerizable group is preferably a functional group capable of addition polymerization or condensation polymerization. Among them, a (meth)acrylate or epoxy group is preferable.

Q may contain the linking group connecting H with the polymerizable group, and examples of the linking group include *—O—CO—, *—CO—O—, *—CH═CH—, *—C≡C—, a C₁₋₂₀ alkylene (one carbon atom or two or more carbon atoms not adjacent to each other may be replaced with an oxygen atom) and any combinations thereof.

The discotic liquid crystal represented by the formula (I) is preferably selected from the formula (II) or (III).

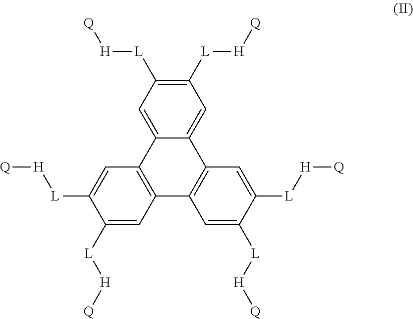

In the formula, the definitions of L, H and Q are same as those of L, H and Q in the formula (I) respectively; and the preferable examples thereof are same as those of L, H and Q in the formula (I) respectively.

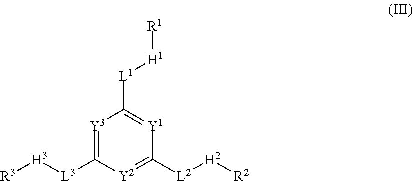

In the formula, the definitions of Y¹, Y² and Y³ are same as those of Y¹¹, Y¹² and Y¹³ in the formula (IV) described later respectively, and the preferable examples thereof are same as those of Y¹¹, Y¹² and Y¹³ in the formula (IV) respectively. Or the definitions of L¹, L², L³, H¹, H², H³, R¹, R² and R³ are same as those of L¹, L², L³, H¹, H², H³, R¹, R² and R³ in the formula (IV) described later respectively, and the preferable examples thereof are same as those of L¹, L², L³, H¹, H², H³, R¹, R² and R³ in the formula (IV) described later respectively.

As described later, the discotic liquid crystal having plural aromatic rings such as the compounds represented by formula (I), (II) or (III) may interact with the onium salt such as pyridium or imidazolium compound to be used as an alignment controlling agent by the π-π molecular interaction, thereby to achieve the vertical alignment. Especially, for example, the compound represented by the formula (II) in which L represents a divalent linking group containing at least one selected from *—CH═CH— and *—C≡C—, or the compound represented by formula (III) in which plural aromatic rings or heterocyclic rings are connected via a single bond to each other may keep the linearity of the molecule thereof since the free rotation of the bonding may be restricted strongly by the linking group. Therefore, the liquid crystallinity of the compound may be improved and the compound may achieve the more stable vertical alignment by the stronger intermolecular π-π interaction.

The discotic liquid crystal is preferably selected from the compounds represented by formula (IV)

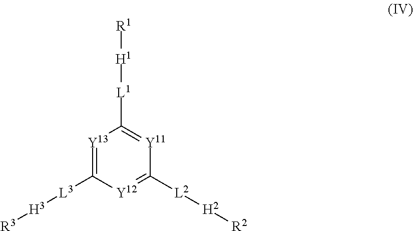

In the formula, Y¹¹, Y¹² and Y¹³ each independently represent a methine group or a nitrogen atom.

When each of Y¹¹, Y¹² and Y¹³ each is a methine group, the hydrogen atom of the methine group may be substituted with a substituent. Examples of the substituent of the methine group include an alkyl group, an alkoxy group, an aryloxy group, an acyl group, an alkoxycarbonyl group, an acyloxy group, an acylamino group, an alkoxycarbonylamino group, an alkylthio group, an arylthio group, a halogen atom, and a cyano group. Among those, preferred are an alkyl group, an alkoxy group, an alkoxycarbonyl group, an acyloxy group, a halogen atom and a cyano group; more preferred are an alkyl group having from 1 to 12 carbon atoms, an alkoxy group having from 1 to 12 carbon atoms, an alkoxycarbonyl group having from 2 to 12 carbon atoms, an acyloxy group having from 2 to 12 carbon atoms, a halogen atom and a cyano group.

Preferably, Y¹¹, Y¹² and Y¹³ are all methine groups, more preferably non-substituted methine groups, in terms of easiness in preparation of the compound.

In the formula, L¹, L² and L³ each independently represent a single bond or a bivalent linking group.

The bivalent linking group is preferably selected from —O—, —S—, —C(═O)—, —NR⁷—, —CH═CH—, —C≡C—, a bivalent cyclic group, and their combinations. R⁷ represents an alkyl group having from 1 to 7 carbon atoms, or a hydrogen atom, preferably an alkyl group having from 1 to 4 carbon atoms, or a hydrogen atom, more preferably a methyl, an ethyl or a hydrogen atom, even more preferably a hydrogen atom.

The bivalent cyclic group for L¹, L² and L³ is preferably a 5-membered, 6-membered or 7-membered group, more preferably a 5-membered or 6-membered group, or even more preferably a 6-membered group. The ring in the cyclic group may be a condensed ring. However, a monocyclic ring is preferred to a condensed ring for it. The ring in the cyclic group may be any of an aromatic ring, an aliphatic ring, or a heterocyclic ring. Examples of the aromatic ring are a benzene ring and a naphthalene ring. An example of the aliphatic ring is a cyclohexane ring. Examples of the heterocyclic ring are a pyridine ring and a pyrimidine ring. Preferably, the cyclic group contains an aromatic ring or a heterocyclic ring. According to the invention, the divalent cyclic group is preferably a divalent linking group consisting of a cyclic structure (but the cyclic structure may have any substituent(s)), and the same will be applied to the later.

Of the bivalent cyclic group represented by L¹, L² or L³, the benzene ring-having cyclic group is preferably a 1,4-phenylene group. The naphthalene ring-having cyclic group is preferably a naphthalene-1,5-diylgroup or a naphthalene-2,6-diyl group. The pyridine ring-having cyclic group is preferably a pyridine-2,5-diyl group. The pyrimidine ring-having cyclic group is preferably a pyrimidin-2,5-diyl group.

The bivalent cyclic group for L¹, L² and L³ may have a substituent. Examples of the substituent are a halogen atom, a cyano group, a nitro group, an alkyl group having from 1 to 16 carbon atoms, an alkenyl group having from 2 to 16 carbon atoms, an alkynyl group having from 2 to 16 carbon atoms, a halogen atom-substituted alkyl group having from 1 to 16 carbon atoms, an alkoxy group having from 1 to 16 carbon atoms, an acyl group having from 2 to 16 carbon atoms, an alkylthio group having from 1 to 16 carbon atoms, an acyloxy group having from 2 to 16 carbon atoms, an alkoxycarbonyl group having from 2 to 16 carbon atoms, a carbamoyl group, an alkyl group-substituted carbamoyl group having from 2 to 16 carbon atoms, and an acylamino group having from 2 to 16 carbon atoms.

In the formula, L¹, L² and L³ are preferably a single bond, *—O—CO—, *—CO—O—, —CH═CH—, *—C≡C—, *-“bivalent cyclic group”-, *—O—CO-“bivalent cyclic group”-, —CO—O-“bivalent cyclic group”-, *—CH═CH-“bivalent cyclic group”-, *—C≡C-“bivalent cyclic group”-, *-“bivalent cyclic group”-O—CO—, *-“bivalent cyclic group”-CO—O—, *-“bivalent cyclic group”-CH═CH—, or *-“bivalent cyclic group”-C≡C—. More preferably, they are a single bond, *—CH═CH—, *—C≡C—, *—CH═CH—“bivalent cyclic group”- or *—C≡C—“bivalent cyclic group”-, even more preferably a single bond. In the examples, “*” indicates the position at which the group bonds to the 6-membered ring of formula (IV) that contains Y¹¹, Y¹² and Y¹³.

In the formula, H¹, H² and H³ each independently represent the following formula (IV-A) or (IV-B):

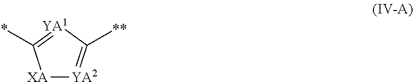

In formula (IV-A), YA¹ and YA² each independently represent a methine group or a nitrogen atom;

XA represents an oxygen atom, a sulfur atom, a methylene group or an imino group;

* indicates the position at which the formula bonds to any of L¹ to L³; and

** indicates the position at which the formula bonds to any of R¹ to R³.

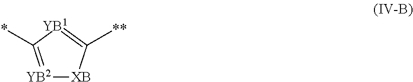

In formula (IV-B), YB¹ and YB² each independently represent a methine group or a nitrogen atom;

XB represents an oxygen atom, a sulfur atom, a methylene group or an imino group;

* indicates the position at which the formula bonds to any of L¹ to L³; and

** indicates the position at which the formula bonds to any of R¹ to R³.

In the formula, R¹, R² and R³ each independently represent the following formula (IV-R):

*-(-L₂₁-Q²)ⁿ¹-L²²-L²³-Q¹ (IV-R)

In formula (IV-R), * indicates the position at which the formula bonds to H¹, H² or H³ in formula (IV).

L²¹ represents a single bond or a bivalent linking group. When L²¹ is a bivalent linking group, it is preferably selected from a group consisting of —O—, —S—, —C(═O)—, —NR⁷—, —CH═CH—, —C≡C—, and their combination. R⁷ represents an alkyl group having from 1 to 7 carbon atoms, or a hydrogen atom, preferably an alkyl group having from 1 to 4 carbon atoms, or a hydrogen atom, more preferably a methyl group, an ethyl group or a hydrogen atom, even more preferably a hydrogen atom.

In the formula, L²¹ is preferably a single bond, **—O—CO—, **—CO—O—, —CH═CH— or **—C≡C— (in which ** indicates the left side of L²¹ in formula (IV-R)). More preferably it is a single bond.

In the formula, Q² represents a bivalent cyclic linking group having at least one cyclic structure. The cyclic structure is preferably a 5-membered ring, a 6-membered ring, or a 7-membered ring, more preferably a 5-membered ring or a 6-membered ring, even more preferably a 6-membered ring. The cyclic structure may be a condensed ring. However, a monocyclic ring is preferred to a condensed ring for it. The ring in the cyclic ring may be any of an aromatic ring, an aliphatic ring, or a hetero ring. Examples of the aromatic ring are a benzene ring, a naphthalene ring, an anthracene ring, and a phenanthrene ring. An example of the aliphatic ring is a cyclohexane ring. Examples of the heterocyclic ring are a pyridine ring and a pyrimidine ring.

The benzene ring-having group for Q² is preferably a 1,4-phenylene group or a 1,3-phenylene group. The naphthalene ring-having group is preferably a naphthalene-1,4-diylgroup, a naphthalene-1,5-diylgroup, a naphthalene-1,6-diyl group, a naphthalene-2,5-diyl group, a naphthalene-2,6-diyl group, or a naphthalene-2,7-diyl group. The cyclohexane ring-having group is preferably a 1,4-cyclohexylene group. The pyridine ring-having group is preferably a pyridine-2,5-diyl group. The pyrimidine ring-having group is preferably a pyrimidin-2,5-diyl group. More preferably, Q² is a 1,4-phenylene group, a nephthalen-2,6-diyl group, or a 1,4-cyclohexylene group.

In the formula, Q² may have a substituent. Examples of the substituent are a halogen atom (e.g., fluorine atom, chlorine atom, bromine atom, iodine atom), a cyano group, a nitro group, an alkyl group having from 1 to 16 carbon atoms, an alkenyl group having from 1 to 16 carbon atoms, an alkynyl group having from 2 to 16 carbon atoms, a halogen atom-substituted alkyl group having from 1 to 16 carbon atoms, an alkoxy group having from 1 to 16 carbon atoms, an acyl group having from 2 to 16 carbon atoms, an alkylthio group having from 1 to 16 carbon atoms, an acyloxy group having from 2 to 16 carbon atoms, an alkoxycarbonyl group having from 2 to 16 carbon atoms, a carbamoyl group, an alkyl group-substituted carbamoyl group having from 2 to 16 carbon atoms, and an acylamino group having from 2 to 16 carbon atoms. The substituent is preferably a halogen atom, a cyano group, an alkyl group having from 1 to 6 carbon atoms, a halogen atom-substituted alkyl group having from 1 to 6 carbon atoms, more preferably a halogen atom, an alkyl group having from 1 to 4 carbon atoms, a halogen atom-substituted alkyl group having from 1 to 4 carbon atoms, even more preferably a halogen atom, an alkyl group having from 1 to 3 carbon atoms, or a trifluoromethyl group.

In the formula, n1 indicates an integer of from 0 to 4. n1 is preferably an integer of from 1 to 3, or more preferably 1 or 2.

In the formula, L²² represents **—O—, **—O—CO—, **—CO—O—, **—O—CO—O—, **—S—, —NH—, **—SO₂—, **—CH₂—, **—CH═CH— or **—C≡C—, and “*” indicates the site bonding to the Q² side. Preferably, L²² represents **—O—, **—O—CO—, **—CO—O—, **—O—CO—O—, —CH₂—, **—CH═CH— or **—C≡C—, or more preferably, L²² represents **—O—, **—O—CO—, —CO—O—, **—O—CO—O—, or **—CH₂—. When the above group has a hydrogen atom, then the hydrogen atom may be substituted with a substituent. Examples of the substituent are a halogen atom, a cyano group, a nitro group, an alkyl group having from 1 to 6 carbon atoms, a halogen atom-substituted alkyl group having from 1 to 6 carbon atoms, an alkoxy group having from 1 to 6 carbon atoms, an acyl group having from 2 to 6 carbon atoms, an alkylthio group having from 1 to 6 carbon atoms, an acyloxy group having from 2 to 6 carbon atoms, an alkoxycarbonyl group having from 2 to 6 carbon atoms, a carbamoyl group, an alkyl group-substituted carbamoyl group having from 2 to 6 carbon atoms, and an acylamino group having from 2 to 6 carbon atoms. Especially preferred are a halogen atom, and an alkyl group having from 1 to 6 carbon atoms.

In the formula, L²³ represents a bivalent linking group selected from —O—, —S—, —C(═O)—, —SO₂—, —NH—, —CH₂—, —CH═CH— and —C≡C—, and a group formed by linking two or more of these. The hydrogen atom in —NH—, —CH₂— and —CH═CH— may be substituted with any other substituent. Examples of the substituent are a halogen atom, a cyano group, a nitro group, an alkyl group having from 1 to 6 carbon atoms, a halogen atom-substituted alkyl group having from 1 to 6 carbon atoms, an alkoxy group having from 1 to 6 carbon atoms, an acyl group having from 2 to 6 carbon atoms, an alkylthio group having from 1 to 6 carbon atoms, an acyloxy group having from 2 to 6 carbon atoms, an alkoxycarbonyl group having from 2 to 6 carbon atoms, a carbamoyl group, an alkyl group-substituted carbamoyl group having from 2 to 6 carbon atoms, and an acylamino group having from 2 to 6 carbon atoms. Especially preferred are a halogen atom, and an alkyl group having from 1 to 6 carbon atoms. The group substituted with the substituent improves the solubility of the compound of the formula (IV) in solvent, and therefore the composition can be readily prepared as a coating liquid.

In the formula, L²³ is preferably a linking group selected from a group consisting of —O—, —C(═O)—, —CH₂—, —CH═CH— and —C≡C—, and a group formed by linking two or more of these. L²³ preferably has from 1 to 20 carbon atoms, more preferably from 2 to 14 carbon atoms. Preferably, L²³ has from 1 to 16 (—CH₂—)'s, more preferably from 2 to 12 (—CH₂—)'s.

In the formula, Q¹ represents a polymerizable group or a hydrogen atom. In case where the compound of formula (IV) is used in producing optical films of which the retardation is required not to change by heat, such as optical compensatory films, Q¹ is preferably a polymerizable group. The polymerization for the group is preferably addition polymerization (including ring-cleavage polymerization) or polycondensation. In other words, the polymerizable group preferably has a functional group that enables addition polymerization or polycondensation. Examples of the polymerizable group are shown below.

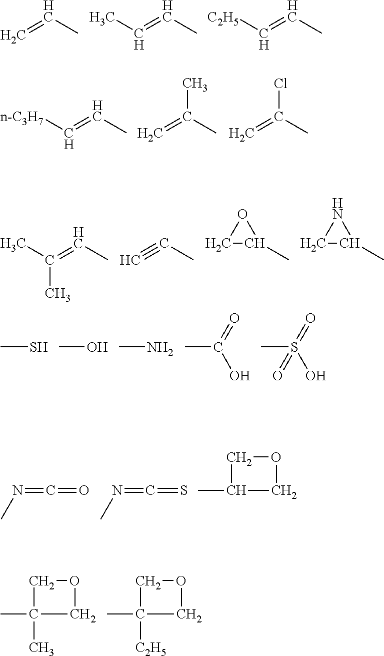

More preferably, the polymerizable group is addition-polymerizing functional group. The polymerizable group of the type is preferably a polymerizable ethylenic unsaturated group or a ring-cleavage polymerizable group.

Examples of the polymerizing ethylenic unsaturated group are the following (M-1) to (M-6):

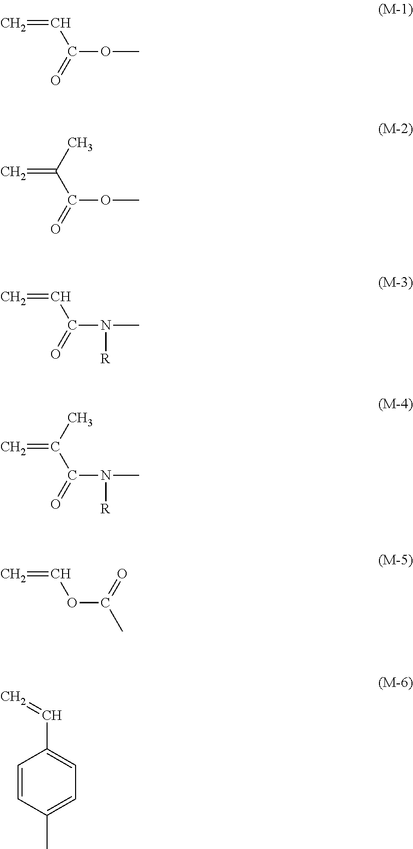

In formulae (M-3) and (M-4), R represents a hydrogen atom or an alkyl group. R is preferably a hydrogen atom or a methyl group.

Of formulae (M-1) to (M-6), preferred are formulae (M-1) and (M-2), and more preferred is formula (M-1).

The ring-cleavage polymerizable group is preferably a cyclic ether group, or more preferably an epoxy group or an oxetanyl group.

Among the compounds represented by formula (IV), the compounds represented by formula (IV′) are more preferable.

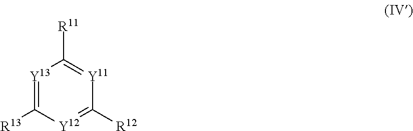

In the formula, Y¹¹, Y¹² and Y¹³ each independently represent a methine group or a nitrogen atom. Preferably, Y¹¹, Y¹² and Y¹³ are all methine groups, more preferably non-substituted methine groups.

In the formula, R¹¹, R¹² and R¹³ each independently represent the following formula represent the following formula (IV′-A), (IV′-B) or (IV′-C). When the small wavelength dispersion of birefringence is needed, preferably, R¹¹, R¹² and R¹³ each represent the following formula (IV′-A) or (IV′-C), more preferably the following formula (IV′-A). Preferably, R¹¹, R¹² and R¹³ are same (R¹¹═R¹²═R¹³).

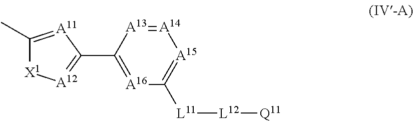

In formula (VI′-A), A¹¹, A¹², A¹³, A¹⁴, A¹⁵ and A¹⁶ each independently represent a methine group or a nitrogen atom.

Preferably, at least one of A¹¹ and A¹² is a nitrogen atom; more preferably the two are both nitrogen atoms.

Preferably, at least three of A¹³, A¹⁴, A¹⁵ and A¹⁶ are methine groups; more preferably, all of them are methine groups. Non-substituted methine is more preferable.

Examples of the substituent that the methine group represented by A¹¹, A¹², A¹³, A¹⁴, A¹⁵ or A¹⁶ may have are a halogen atom (fluorine atom, chlorine atom, bromine atom, iodine atom), cyano, nitro, an alkyl group having from 1 to 16 carbon atoms, an alkenyl group having from 2 to 16 carbon atoms, an alkynyl group having from 2 to 16 carbon atoms, a halogen-substituted alkyl group having from 1 to 16 carbon atoms, an alkoxy group having from 1 to 16 carbon atoms, an acyl group having from 2 to 16 carbon atoms, an alkylthio group having from 1 to 16 carbon atoms, an acyloxy group having from 2 to 16 carbon atoms, an alkoxycarbonyl group having from 2 to 16 carbon atoms, a carbamoyl group, an alkyl group-substituted carbamoyl group having from 2 to 16 carbon atoms, and an acylamino group having from 2 to 16 carbon atoms. Of those, preferred are a halogen atom, a cyano group, an alkyl group having from 1 to 6 carbon atoms, a halogen-substituted alkyl group having from 1 to 6 carbon atoms; more preferred are a halogen atom, an alkyl group having from 1 to 4 carbon atoms, a halogen-substituted alkyl group having from 1 to 4 carbon atoms; even more preferred are a halogen atom, an alkyl group having from 1 to 3 carbon atoms, a trifluoromethyl group.

In the formula, X¹ represents an oxygen atom, a sulfur atom, a methylene group or an imino group, but is preferably an oxygen atom.

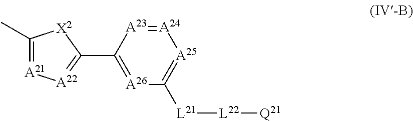

In formula (IV′-B), A²¹, A²², A²³, A²⁴, A²⁵ and A²⁶ each independently represent a methine group or a nitrogen atom.

Preferably, at least either of A²¹ or A²² is a nitrogen atom; more preferably the two are both nitrogen atoms.

Preferably, at least three of A²³, A²⁴, A²⁵ and A²⁶ are methine groups; more preferably, all of them are methine groups.

Examples of the substituent that the methine group represented by A²³, A²⁴, A²⁵ or A²⁶ may have are a halogen atom (fluorine atom, chlorine atom, bromine atom, iodine atom), cyano, nitro, an alkyl group having from 1 to 16 carbon atoms, an alkenyl group having from 2 to 16 carbon atoms, an alkynyl group having from 2 to 16 carbon atoms, a halogen-substituted alkyl group having from 1 to 16 carbon atoms, an alkoxy group having from 1 to 16 carbon atoms, an acyl group having from 2 to 16 carbon atoms, an alkylthio group having from 1 to 16 carbon atoms, an acyloxy group having from 2 to 16 carbon atoms, an alkoxycarbonyl group having from 2 to 16 carbon atoms, a carbamoyl group, an alkyl group-substituted carbamoyl group having from 2 to 16 carbon atoms, and an acylamino group having from 2 to 16 carbon atoms. Of those, preferred are a halogen atom, a cyano group, an alkyl group having from 1 to 6 carbon atoms, a halogen-substituted alkyl group having from 1 to 6 carbon atoms; more preferred are a halogen atom, an alkyl group having from 1 to 4 carbon atoms, a halogen-substituted alkyl group having from 1 to 4 carbon atoms; even more preferred are a halogen atom, an alkyl group having from 1 to 3 carbon atoms, a trifluoromethyl group.

In the formula, X² represents an oxygen atom, a sulfur atom, a methylene group or an imino group, but is preferably an oxygen atom.

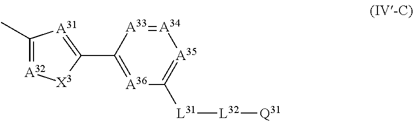

In formula (IV′-C), A³¹, A³², A³³, A³⁴, A³⁵ and A³⁶ each independently represent a methine group or a nitrogen atom.

Preferably, at least either of A³¹ or A³² is a nitrogen atom; more preferably the two are both nitrogen atoms.

Preferably, at least three of A³³, A³⁴, A³⁵ and A³⁶ are methine groups; more preferably, all of them are methine groups.

When A³³, A³⁴, A³⁵ and A³⁶ are methine groups, the hydrogen atom of the methine group may be substituted with a substituent. Examples of the substituent that the methine group may have are a halogen atom (fluorine atom, chlorine atom, bromine atom, iodine atom), cyano, nitro, an alkyl group having from 1 to 16 carbon atoms, an alkenyl group having from 2 to 16 carbon atoms, an alkynyl group having from 2 to 16 carbon atoms, a halogen-substituted alkyl group having from 1 to 16 carbon atoms, an alkoxy group having from 1 to 16 carbon atoms, an acyl group having from 2 to 16 carbon atoms, an alkylthio group having from 1 to 16 carbon atoms, an acyloxy group having from 2 to 16 carbon atoms, an alkoxycarbonyl group having from 2 to 16 carbon atoms, a carbamoyl group, an alkyl group-substituted carbamoyl group having from 2 to 16 carbon atoms, and an acylamino group having from 2 to 16 carbon atoms. Of those, preferred are a halogen atom, a cyano group, an alkyl group having from 1 to 6 carbon atoms, a halogen-substituted alkyl group having from 1 to 6 carbon atoms; more preferred are a halogen atom, an alkyl group having from 1 to 4 carbon atoms, a halogen-substituted alkyl group having from 1 to 4 carbon atoms; even more preferred are a halogen atom, an alkyl group having from 1 to 3 carbon atoms, a trifluoromethyl group.

In the formula, X³ represents an oxygen atom, a sulfur atom, a methylene group or an imino group, but is preferably an oxygen atom.

L¹¹ in formula (IV′-A), L²¹ in formula (IV′-B) and L³¹ in formula (IV′-C) each independently represent —O—, —O—CO—, —CO—O—, —O—CO—O—, —S—, —NH—, —SO₂—, —CH₂—, —CH═CH— or —C≡C—; preferably —O—, —O—CO—, —CO—O—, —O—CO—O—, —CH₂—, —CH═CH— or —C≡C—; more preferably —O—, —O—CO—, —CO—O—, —O—CO—O— or —C≡C—. L¹¹ in formula (VI′-A) is especially preferable O—, —CO—O— or —C≡C— in terms of the small wavelength dispersion of birefringence; among these, —CO—O— is more preferable because the discotic nematic phase may be formed at a higher temperature. When above group has a hydrogen atom, then the hydrogen atom may be substituted with a substituent. Preferred examples of the substituent are a halogen atom, cyano, nitro, an alkyl group having from 1 to 6 carbon atoms, a halogen atom-substituted alkyl group having from 1 to 6 carbon atoms, an alkoxy group having from 1 to 6 carbon atoms, an acyl group having from 2 to 6 carbon atoms, an alkylthio group having from 1 to 6 carbon atoms, an acyloxy group having from 2 to 6 carbon atoms, an alkoxycarbonyl group having from 2 to 6 carbon atoms, a carbamoyl group, an alkyl group-substituted carbamoyl group having from 2 to 6 carbon atoms, and an acylamino group having from 2 to 6 carbon atoms. Especially preferred are a halogen atom, and an alkyl group having from 1 to 6 carbon atoms.

L¹² in formula (IV′-A), L²² in formula (IV′-B) and L³² in formula (IV′-C) each independently represent a bivalent linking group selected from —O—, —S—, —C(═O)—, —SO₂—, —NH—, —CH₂—, —CH═CH— and —C≡C—, and a group formed by linking two or more of these. The hydrogen atom in —NH—, —CH₂— and —CH═CH— may be substituted with a substituent. Preferred examples of the substituent are a halogen atom, cyano, nitro, hydroxy, carboxyl, an alkyl group having from 1 to 6 carbon atoms, a halogen atom-substituted alkyl group having from 1 to 6 carbon atoms, an alkoxy group having from 1 to 6 carbon atoms, an acyl group having from 2 to 6 carbon atoms, an alkylthio group having from 1 to 6 carbon atoms, an acyloxy group having from 2 to 6 carbon atoms, an alkoxycarbonyl group having from 2 to 6 carbon atoms, a carbamoyl group, an alkyl group-substituted carbamoyl group having from 2 to 6 carbon atoms, and an acylamino group having from 2 to 6 carbon atoms. More preferred are a halogen atom, hydroxy and an alkyl group having from 1 to 6 carbon atoms; and especially preferred are a halogen atom, methyl and ethyl.

Preferably, L¹², L²² and L³² each independently represent a bivalent linking group selected from —O—, —C(═O)—, —CH₂—, —CH═CH— and a group formed by linking two or more of these.

Preferably, L¹², L²² and L³² each independently have from 1 to 20 carbon atoms, more preferably from 2 to 14 carbon atoms. Preferably, L¹², L²² andL³² each independently have from 1 to 16 (—CH₂—)'s, more preferably from 2 to 12 (—CH₂—)'s.

The number of carbon atoms constituting the L¹², L²² or L³² may influence both of the liquid crystal phase transition temperature and the solubility of the compound. Generally, the compound having the larger number of the carbon atoms has a lower phase transition temperature at which the phase transition from the discotic nematic phase (Nd phase) transits to the isotropic liquid occurs. Furthermore, generally, the solubility for solvent of the compound, having the larger number of the carbon atoms, is more improved.

Q¹¹ in formula (IV′-A), Q²¹ in formula (IV′-B) and Q³¹ in formula (IV′-C) each independently represent a polymerizable group or a hydrogen atom. Preferably, Q¹¹, Q²¹ and Q³¹ each represent a polymerizable group. The polymerization for the group is preferably addition polymerization (including ring-cleavage polymerization) or polycondensation. In other words, the polymerizing group preferably has a functional group that enables addition polymerization or polycondensation. Examples of the polymerizable group are same as those exemplified above.

Examples of the compound represented by formula (IV) include the compounds exemplified as “Compound 13”-“Compound 43”, described in JP-A-2006-76992, column 0052; and the compounds exemplified as “Compound 13”-“Compound 36”, described in JP-A-2007-2220, columns 0040-0063.

The compounds may be prepared according to any process. For example, the compounds may be prepared according to the method described in JP-A-2007-2220, columns 0064-0070.

The liquid-crystal phase that the liquid-crystal compound to be used in the invention expresses includes a columnar phase and a discotic nematic phase (ND phase). Of those liquid-crystal phases, preferred is a discotic nematic phase (ND phase) having a good mono-domain property.

Among the discotic liquid crystal compounds, the compounds forming the liquid crystal phase at a temperature of from 20 degrees Celsius to 300 degrees are preferable. The compounds forming the liquid crystal phase at a temperature of from 40 degrees Celsius to 280 degrees are more preferable, and the compounds forming the liquid crystal phase at a temperature of from 60 degrees Celsius to 250 degrees are even more preferable. The compound forming the liquid crystal phase at a temperature of 20 degrees Celsius to 300 degrees Celsius includes any compound of which the temperature range forming the liquid crystal phase resides including 20 degrees Celsius (for example the temperature range is from 10 degrees Celsius to 22 degrees Celsius), and includes also any compound of which the temperature range forming the liquid crystal phase resides including 300 degrees Celsius (for example, the temperature range is from 298 degrees Celsius to 310 degrees Celsius). The same will be applied to the temperature ranges of from 40 degrees Celsius to 280 degrees Celsius and of from 60 degrees Celsius to 250 degrees Celsius.

The discotic liquid crystal represented by formula (IV) having plural aromatic rings may interact with the pyridinium or imidazolium compound described later via the intermolecular π-π interaction, which may increase the tilt angle of the discotic liquid crystal in the area neighboring to the alignment layer. Especially, the discotic liquid crystal represented by formula (IV′) in which plural aromatic rings or heterocyclic rings are connected via a single bond to each other may keep the linearity of the molecule thereof since the free rotation of the bonding may be restricted strongly by the linking group. Therefore, the discotic liquid crystal represented by formula (IV′) having plural aromatic rings may interact with the pyridinium or imidazolium compound via the stronger intermolecular π-π interaction, which may increase the tilt angle of the discotic liquid crystal more remarkably in the area neighboring to the alignment layer to achieve the vertical alignment.

According to the embodiment employing any rod-like liquid crystal compound, it is preferable that the rod-like liquid crystal is aligned horizontally. It is to be understood that the term “horizontal alignment” in the specification means that the direction of long axis of a liquid crystalline molecule is parallel to the layer plane, wherein strict parallelness is not always necessary; and means, in this specification, that a tilt angle of the mean direction of long axes of liquid crystalline molecules with respect to the horizontal plane is smaller than 10°. The tilt angle is preferably from 0 to 5°, more preferably from 0 to 3°, even more preferably from 0 to 2°, or most preferably from 0 to 1°.

The composition preferably contains an additive capable of promoting the horizontal alignment of the liquid crystal, and examples of the additive include those described in JP-A-2009-223001, columns 0055-0063.

According to the embodiment employing any discotic liquid crystal compound, it is preferable that the discotic liquid crystal is aligned vertically. It is to be understood that the term “vertical alignment” in the specification means that the discotic plane of the discotic liquid crystal is vertical to the layer plane, wherein strict verticalness is not always necessary; and means, in this specification, that a tilt angle of liquid crystalline molecules with respect to the horizontal plane is equal to or larger than 70°. The tilt angle is preferably from 85 to 90°, more preferably from 87 to 90°, even more preferably from 88 to 90°, or most preferably from 89 to 90°.

The composition preferably contains an additive capable of promoting the vertical alignment, and examples of the additive are described above.

It is difficult to accurately and directly measure θ1, which is a tilt angle at a surface of an optically-anisotropic film (an angle between the physical symmetric axis of a discotic or rod-like liquid-crystal molecule in the optically-anisotropic film and an interface of the layer), and θ2, which is a tilt angle at another surface of the optically-anisotropic film. Therefore, in this description, θ1 and θ2 are calculated as follows: This method could not accurately express the actual alignment state, but may be helpful as a means for indicating the relative relationship of some optical characteristics of an optical film.

In this method, the following two points are assumed for facilitating the calculation, and the tilt angles at two interfaces of an optically-anisotropic film are determined.

1. It is assumed that an optically-anisotropic film is a multi-layered structure that comprises a layer containing discotic or rod-like compound(s). It is further assumed that the minimum unit layer constituting the structure (on the assumption that the tilt angle of the liquid crystal compound molecule is uniform inside the layer) is an optically-monoaxial layer.

2. It is assumed that the tilt angle in each layer varies monotonously as a linear function in the direction of the thickness of an optically-anisotropic layer.

A concrete method for calculation is as follows:

(1) In a plane in which the tilt angle in each layer monotonously varies as a linear function in the direction of the thickness of an optically-anisotropic film, the incident angle of light to be applied to the optically-anisotropic film is varied, and the retardation is measured at three or more angles. For simplifying the measurement and the calculation, it is desirable that the retardation is measured at three angles of −40°, 0° and +40° relative to the normal direction to the optically-anisotropic film of being at an angle of 0°. For the measurement, for example, used are KOBRA-21ADH and KOBRA-WR (by Oji Scientific Instruments), and transmission ellipsometers AEP-100 (by Shimadzu), M150 and M520 (by Nippon Bunko) and ABR10A (by Uniopto).

(2) In the above model, the refractive index of each layer for normal light is represented by n0; the refractive index thereof for abnormal light is by ne (ne is the same in all layers as well as n0); and the overall thickness of the multi-layer structure is represented by d. On the assumption that the tilting direction in each layer and the monoaxial optical axis direction of the layer are the same, the tilt angle θ1 in one face of the optically-anisotropic layer and the tilt angle θ2 in the other face thereof are fitted as variables in order that the calculated data of the angle dependence of the retardation of the optically-anisotropic layer could be the same as the found data thereof, and θ1 and θ2 are thus calculated.

In this, n0 and ne may be those known in literature and catalogues. When they are unknown, they may be measured with an Abbe's refractiometer. The thickness of the optically-anisotropic film may be measured with an optical interference thickness gauge or on a photograph showing the cross section of the layer taken by a scanning electronic microscope.

### <Onium Salt Compound (Agent for Controlling Alignment at Alignment Layer)>

According to the present invention, any onium salt compound is preferably added for achieving the vertical alignment of the liquid crystal compound having the polymerizable group, or especially, the discotic liquid crystal having the polymerizable group. The onium salt may localize at the alignment layer interface, and may function to increase the tilt angles of the liquid crystal molecules in the area neighboring to the alignment layer

As the onium salt compound, the compound represented by formula (1) is preferable.

Z-(Y-L-)ₙCy⁺.X⁻ Formula (1)

In the formula, Cy represents a 5-membered or 6-membered cyclic onium group; the definitions of L, Y, Z and X are same as those of L²³, L²⁴, Y²², Y²³, Z²¹ and X in formula (II) described layer, and these preferable examples are same as those of them in formula (II); and n represents an integer of equal to or more than 2.

The 5-membered or 6-membered onium group (Cy) is preferably pyrazolium ring, imidazolium ring, triazolium ring, tetrazolium ring, pyridium ring, pyrimidinium ring or triazinium ring, or more preferably imidazolium ring or pyridinium ring.

The 5-membered or 6-membered onium group (Cy) has preferably the group which is with an affinity for the material in the alignment layer. The onium salt compound may localize at the alignment layer interface in the area (non-irradiated area) where the photo-acid-generating agent is not decomposed since the onium salt compound is with an affinity for the alignment layer. On the other hand, the localization of the onium salt compound at the alignment layer interface may be lowered in the area (irradiated area) where the photo-acid-generating agent is decomposed and the acid generates since the affinity is lowered via the ion-exchange caused by the anion of the onium salt. The hydrogen bonding may become the state forming the bonding or the state losing the bonding in the temperature range (from a room temperature to 1500 degrees Celsius) at which the liquid crystal is actually aligned, and the affinity via the hydrogen bonding is preferably used. However, the invention is not limited to the example.

For example, according to the embodiment employing the polyvinyl alcohol as a material of the alignment layer, the onium salt preferably has the group which is capable of forming the hydrogen bonding to form the hydrogen bonding with a hydroxy group of the polyvinyl alcohol. The theoretical interpretation of the hydrogen bonding is reported, for example, in Journal of American Chemical Society, vol. 99, pp. 1316-1332, 1977, H. Uneyama and K. Morokuma. The concrete modes of the hydrogen bonding are exemplified in FIG. 17 on page 98 described in “Intermolecular and Surface Forces (Bunshikanryoku to Hyoumenn Chohryoku)” written by Jacob Nissim lsraelachvili, translated in Japanese by Tamotsu Kondoh and Hiroyuki Ohshima, and published by McGraw-Hill Company in 1991. Examples of the hydrogen bonding include those described in Angewante Chemistry International Edition English, col. 34, 00.2311, 1955, G. R. Desiraju.

The 5-membered or 6-membered cyclic onium group having a hydrogen bonding group may increase the localization at the alignment layer interface and promote the orthogonal alignment with respect to the main chain of the polyvinyl alcohol by the hydrogen bonding with the polyvinyl alcohol along with the affinity effect of the onium group. Preferable examples of the hydrogen bonding group include an amino group, carbamide group, sulfonamide group, acid amide group, ureido group, carbamoyl group, carboxyl group, sulfo group, nitrogen-containing heterocyclic group (such as imidazolyl group, benzimidazolyl group pyrazolyl group, pyridyl group, 1,3,5-triazyl group, pyrimidyl group, pyridazyl group, quinonyl group, benzoimidazolyl group, benzothiazolyl, succinimide group, phthalimide group, maleimide group, uracil group, thiouracil group, barbituric acid group, hydantoin group, maleic hydrazide group, isatin group, and uramil group). More preferable examples of the hydrogen bonding include an amino group and pyridyl group.

For example, the 5-membered or 6-membered onium ring such as an imidazolium ring in which any atom(s) capable of forming the hydrogen bonding is embedded is also preferable

In the formula, n is preferably an integer of from 2 to 5, more preferably 3 or 4, or most preferably 3. Plural L and Y may be same or different from each other respectively. The onium salt represented by formula (1) in which n is not smaller than 3 has 3 or more numbers of the 5-membered or 6-membered rings, may interact with the discotic liquid crystal by the intermolecular π-π interaction, and, on the polyvinyl-alcohol alignment layer, can achieve the orthogonal-vertical alignment with respect to the polyvinyl-alcohol main chain.

The onium salt represented by formula (1) is preferably selected from the pyridinium compounds represented by formula (2a) or the imidazolium compounds represented by formula (2b).

The compound represented by formula (2a) or (2b) may mainly be added to the discotic liquid crystal represented by any one of the formulas (I)-(IV) for controlling the alignment of the liquid crystal compound at the alignment layer interface, and may have a function of increasing the tilt angles of the discotic liquid crystal molecules in the area neighboring to the alignment layer interface.

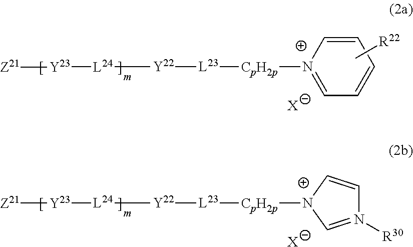

In the formula, L²³ and L²⁴ represent a divalent linking group respectively.

L²³ is preferably a single bond, —O—, —O—CO—, —CO—O—, —C≡C—, —CH═CH—, —CH═N—, —N═CH—, —N═N—, —O-AL-O—, —O-AL-O-CO—, —O-AL-CO—O—, —CO—O-AL-O—, —CO—O-AL-O-CO—, —CO—O-AL-CO—O—, —O—CO-AL-O—, —O—CO-AL-O-CO— or —O—CO-AL-CO—O—, and AL is a C₁₋₁₀ alkylene group. L²³ is more preferably a single bond, —O—, —O-AL-O—, —O-AL-O—CO—, —O-AL-CO—O—, —CO—O-AL-O—, —CO—O-AL-O—CO—, —CO—O-AL-CO—O—, —O—CO-AL-O—, —O—CO-AL-O—CO— or —O—CO-AL-CO—O—, even more preferably a single bond or —O—, or most preferably —O—.

L²⁴ is preferably a single bond, —O—, —O—CO—, —CO—O—, —C≡C—, —CH═CH—, —CH═N—, —N═CH— or —N═N—, or more preferably —O—CO— or —CO—O—. If n is equal to or larger than 2, a plurality of L²⁴ preferably represents —O—CO— or —CO—O— alternately.

If R²² is a dialkyl-substituted amino group, the two alkyls may connect to each other to form a nitrogen-containing heterocyclic ring. The nitrogen-containing heterocyclic ring is preferably a 5-membered or 6-membered ring. R²³ preferably represents a hydrogen atom, non-substituted amino group or C₂₋₁₂ dialkyl substituted amino group, or even more preferably, a hydrogen atom, non-substituted amino group or C₂₋₈ dialkyl substituted amino group. If R²³ is a non-substituted or substituted amino group, the 4-position of the pyridinium is preferably substituted.

X represents an anion.

X preferably represents a monovalent anion. Examples of the anion include halide ion (such as fluorine ion, chlorine ion, bromine ion and iodide ion) and sulfonic acid ions (such as methane sulfonate ion, p-toluene sulfonate ion and benzene sulfonate ion).

Y²² and Y²³ represent a divalent linking group having a 5-membered or 6-membered ring as a part structure respectively.

The 5-membered or 6-membered ring may have at least one substituent. Preferably, at least one of Y²² and Y²³ is a divalent linking group having a 5-membered or 6-membered ring with at least one substituent as a part structure. Preferably, Y²² and Y²³ each independently represent a divalent linking group having a 6-membered ring, which may have at least one substituent, as a part structure. The 6-membered ring includes an alicyclic ring, aromatic ring (benzene ring) and heterocyclic ring. Examples of the 6-membered alicyclic ring include a cyclohexane ring, cyclohexane ring and cyclohexadiene ring. Examples of the 6-membered heterocyclic ring include pyrane ring, dioxane ring, dithiane ring, thiin ring, pyridine ring, piperidine ring, oxazine ring, morpholino ring, thiazine ring, pyridazine ring, pyrimidine ring, pyrazine ring, piperazine ring and triazine ring. Other 6-membered or 5-membered ring(s) may be condensed with the 6-membered ring

Examples of the substituent include halogen atoms, cyano, C₁₋₁₂ alkyls and C₁₋₁₂ alkoxys. The alkyl or alkoxy may have at least one C₂₋₁₂ acyl or C₂₋₁₂ acyloxy. The substituent is preferably selected from C₁₋₁₂ (more preferably C₁₋₆, even more preferably C₁₋₃) alkyls. The 5-membered or 6-membered ring may have two or more substituents. For example, if Y²² and Y²³ are phenyls, they may have from 1 to 4 C₁₋₁₂ (more preferably C₁₋₆, or even more preferably C₁₋₃) alkyls.

In the formula, m is 1 or 2, or is preferably 2. If m is 2, plural Y²³ and L²⁴ may be same or different from each other respectively.

In the formula, Z²¹ is a monovalent group selected from the group consisting of a halogen-substituted phenyl, nitro-substituted phenyl, cyano-substituted phenyl, C₁₋₁₀ alkyl-substituted phenyl, C₂₋₁₀ alkoxy-substituted phenyl, C₁₋₁₂ alkyl, C₂₋₂₀ alkynyl, C₁₋₁₂ alkoxy, C₂₋₁₃ alkoxycarbonyl, C₇₋₂₆ aryloxycarbonyl and C₇₋₂₆ arylcarbonyloxy.

If m is 2, Z²¹ is preferably cyano, a C₁₋₁₀ alkyl or a C₁₋₁₀ alkoxy, or more preferably a C₄₋₁₀ alkoxy.

If m is 1, Z²¹ is preferably a C₇₋₁₂ alkyl, C₇₋₁₂ alkoxy, C₇₋₁₂ acyl-substituted alkyl, C₇₋₁₂ acyl-substituted alkoxy, C₇₋₁₂ acyloxy-substituted alkyl or C₇₋₁₂ acyloxy-substituted alkoxy.

The acyl is represented by —CO—R, the acyloxy is represented by —O—CO—R, and R represents an aliphatic group (including alkyl, substituted alkyl, alkenyl, substituted alkenyl, alkynyl and substituted alkynyl), or an aromatic group (including aryl and substituted aryl). R is preferably an aliphatic group, or more preferably an alkyl or alkenyl.

In the formula, p is an integer of from 1 to 10, or preferably 1 or 2. CₚH₂ₚ represents an alkylene chain which may have a branched structure. CₚH₂ₚ is preferably a linear alkylene chain (—(CH₂)ₚ—).

In formula (2b), R³⁰ represents a hydrogen atom or a C₁₋₁₂ (preferably C₁₋₆) or more preferably C₁₋₃) alkyl group.

Among the compounds represented by formula (2a) or (2b), the compound represented by formula (2a′) or (2′) is preferable.

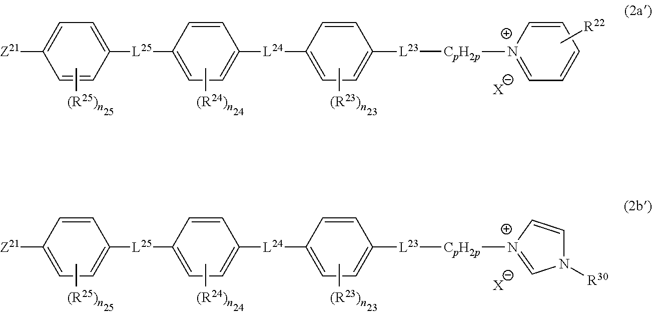

Among the symbols in the formula (2a′) or (2b′), the same symbols have the same definition as those found in formula (2), and preferable examples thereof are same as those in formula (2). Preferably, L²⁴ and L²⁵ represent —O—CO— or —CO—O—; or more preferably, L²⁴ is —O—CO— and L²⁵ is —CO—O—.

R²³, R²⁴ and R²⁵ represent a C₁₋₁₂ (more preferably C₁₋₆, or even more preferably C₁₋₃) alkyl respectively. In the formula, n₂₃ is from 0 to 4, n₂₄ is from 1 to 4, and n₂₅ is from 0 to 4. Preferably, n₂₃ and n₂₅ are 0, and n₂₄ is from 1 to 4 (more preferably from 1 to 3).

Preferably, R³⁰ represents a C₁₋₁₂ (more preferably C₁₋₆, or even more preferably C₁₋₃) alkyl.

Examples of the compound represented by formula (1) include those described in JP-A-2006-113500, columns 0058-0061.

Specific examples of the compound represented by formula (1) include, but are not limited to, those shown below.

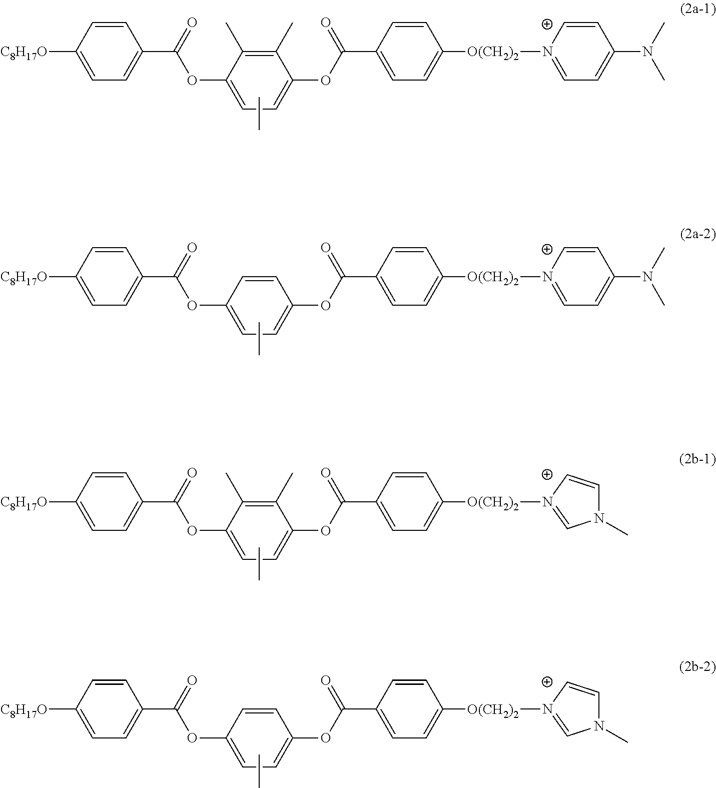

The compound represented by formula (2a) or (2b) may be prepared according to a usual method. For example, usually, the pyridinium derivative may be prepared according to the method wherein a pyridine ring is subjected to an alkylation (Menschutkin reaction).

An amount of the onium salt may be not more than 5% by mass, or preferably about 0.1 to about 2% by mass, with respect to an amount of the liquid crystal compound.

The onium salt represented by formula (2a) or (2b) may localize at the surface of the hydrophilic polyvinyl alcohol alignment layer since the pyridinium or imidazolium group is hydrophilic. Especially, the pyridinium group, or the pyridinium group, having an amino which is an acceptor of a hydrogen atom (in formula (2a) or (2a′), R²² is a non-substituted amino or C₁₋₂₀ substituted amino), may form an intermolecular hydrogen bonding with the polyvinyl alcohol, may localize at the surface of the alignment layer densely, and may promote the orthogonal alignment of the liquid crystal with respect to the rubbing direction along with the pyridinium derivative, which is aligned along the direction orthogonal to the polyvinyl alcohol main chain, by the effect of the hydrogen bonding. The pyridinium derivative having plural aromatic rings may interact with the liquid crystal, especially discotic liquid crystal, by the strong intermolecular π-π interaction, and may induce the orthogonal alignment of the discotic liquid crystal in the area neighboring to the alignment layer. Especially, as represented by formula (2a′), the compound in which the hydrophilic pyridinium group is connected with the hydrophobic aromatic ring may have an effect of inducing the vertical alignment by the hydrophobic property.

Furthermore, in the embodiment using the onium salt represented by formula (2a) or (2b), the anion-exchange between the onium salt and the acidic compound, generating from the photo-acid generating agent compound via the photo-decomposition, may be carried out, the localization at the alignment layer interface may be lowered by the change in the hydrogen-bonding ability or the hydrophilicity of the onium salt, and as a result, the liquid crystal may be aligned so that the slow axis thereof is parallel to the rubbing direction. This is because the onium salt may be dispersed in the alignment layer uniformly via the salt-exchange, the density thereof at the surface of the alignment layer may be lowered, and the liquid crystal may be aligned via the controlling ability of the rubbed alignment layer itself.

And a boronic acid is preferably used as the agent for controlling alignment at the alignment layer interface in combination. Examples of the boronic acid which can be used in the invention include the compounds represented by formula (Ia).

T-X¹-Q (Ia)

In formula (Ia),

In formula (Ia), X¹ represents a single bond or divalent linking group, hydrogen atom, or substituted or non-substituted alkyl, alkenyl, alkynyl, aryl or heteroaryl; T represents a substituent having a polymerizable group; Q represents a boronic acid or boronic acid ester; and the compound may have no T, and in the compound having T, X¹ represents a single bond or divalent linking group.

If the compound represented by formula (Ia) has T, X¹ represents a single bond or divalent linking group. Preferable examples of the divalent linking group include —O—, —CO—, —NH—, —CO—NH—, —COO—, —O—COO—, alkylene, arylene, heteroarylene, and any combinations thereof. And substituted or non-substituted arylenes are more preferable.

The alkyl, alkenyl, alkynyl, aryl or heteroaryl may be connected to each other via a single bond or the divalent linking group exemplified as X¹ above. The definitions and preferable scopes of the alkyl, alkenyl, alkynyl, aryl and heteroaryl are same as those represented by R¹ or R² in formula (IIa). Examples of the substituent include those exemplified as the Substituent Group Y.

In formula (Ia), Q represents a boronic acid or boronic acid ester.

In formula (Ia), T preferably represents acrylate, methacrylate, styryl, vinylketone, butadiene, vinyl ether, oxiranyl, aziridinyl, or oxetane, more preferably represents (meth)acrylate, styryl, oxiranyl or oxetane, or even more preferably (meth)acrylate, or styryl.

Among these, T preferably represents a substituent containing a group represented by formula (II) describe below, oxiranyl or oxetane.

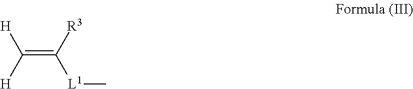

In formula (III), R³ represents a hydrogen atom or methyl, or preferably a hydrogen atom. L¹ represents a single bond or a divalent group selected from the group consisting of —O—, —CO—, —NH—, —CO—NH—, —COO—, —O—COO—, alkylene, arylene, heterocyclic group and any combinations thereof; preferably represents a single bond, —CO—NH— or —COO—; or more preferably a single bond or —CO—NH—.

Preferable examples of the compound represented by formula (Ia) include the compounds represented by formula (IIa).

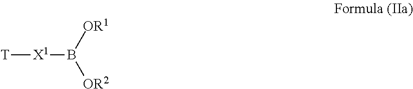

In formula (IIa), R¹ and R² each independently represents a hydrogen atom, or substituted or non-substituted aliphatic hydrocarbon-substituent, aryl or heteroaryl. R¹ and R² may bond to each other via a linking group selected from alkylene, arylene and any combinations thereof.

The definitions of X¹ and T in formula (IIa) are same as those of X¹ and T in formula (Ia) and preferable examples thereof are same as those exemplified for X¹ and T in formula (Ia). The compound represented by formula (IIa) may have no T, as well as the compound represented by formula (Ia).

In formula (IIa), examples of the substituted or non-substituted aliphatic hydrocarbon-substituent represented by R¹ or R² include substituted or non-substituted alkyl, alkenyl and alkynyl.

Examples of the alkyl include linear, branched or cyclic alkyls such as methyl, ethyl, propyl, butyl, pentyl, hexyl, heptyl, octyl, nonyl, decyl, undecyl, dodecyl, tridecyl, hexadecyl, octadecyl, eicosyl, isopropyl, isobutyl, sec-butyl, tert-butyl, isopentyl, neopentyl, 1-methylbutyl, isohexyl, 2-methylhexyl, cyclopentyl, cyclohexyl, 1-adamantyl and 2-norborny. Examples of the alkenyl include linear, branched and cyclic alkenyls such as vinyl, 1-propenyl, 1-butenyl, 1-methyl-1-propenyl, 1-cyclopentenyl and 1-cyclohexenyl.

Examples of the alkynyl include ethynyl, 1-propynyl, 1-butynyl and 1-octynyl. Examples of the aryl include groups formed of from 1 to 4 benzene rings which may be condensed with each other and groups formed of condensed rings of benzene ring and unsaturated 5-membered ring(s); and specific examples thereof include phenyl, naphthyl, anthryl, phenanthryl, indenyl, acenaphthenyl, fluorenyl and pyrenyl.

Examples of the substituted or non-substituted aryl include phenyl and naphthyl. Examples of the substituted or non-substituted heteroaryl include heteroaryls formed by removing a hydrogen atom from heterocyclic rings in which at least one hetero atom selected from the group consisting of nitrogen, oxygen and sulfur atoms is embedded. Specific examples of the heterocyclic ring with at least one hetero atom selected from the group consisting of nitrogen, oxygen and sulfur atoms include pyrrole, furan, thiophene, pyrazole, imidazole, triazole, oxazole, isoxazole, oxadiazole, thiazole, indole, carbazol, benzofuran, dibenzofuran, thianaphthene, dibenzothiophene, indazole benzoimidazole, anthranil, benzoisooxazole, benzoxazole, benzothiazole, purine, pyridine, pyridazine, pyrimidine, pyrazine, triazine, quinoline, acidine, isoquinoline, phthalazin, quinazoline, quinoxaline, naphthyridine, phenanthroline and pteridine.

In the formula, if possible, R¹, R² or X¹ may have at least one substituent. The hydrocarbon group may have at least one substituent. Examples of the substituent include any monovalent non-metalic atom groups excluding hydrogen atom, and include Substituent Group Y described below.

### Substituent Group Y:

haogen atoms (—F, —Br, —Cl and —I), hydroxy, alkoxy, aryloxy, mercapto, alkylthio, arylthio, alkyldithio, aryldithio, amino, N-alkylamino, N,N-dialkyl amino, N-aryl amino, N,N-diaryl amino, N-alkyl-N-aryl amino, acyloxy, carbamoyloxy, N-alkyl carbamoyloxy, N-aryl carbamoyloxy, N,N-dialkyl carbamoyloxy, N,N-diaryl carbamoyloxy, N-alkyl-N-aryl carbamoyloxy, alkylsulfoxy, arylsulfoxy, acylthio, acylamino, N-alkylacylamino, N-arylacylamino, ureido, N′-alkylureido, N′,N′-dialkyl ureido, N′-aryl ureido, N′,N′ diaryl ureido, N′-alkyl-N′-aryl ureido, N-alkyl ureido, N-aryl ureido, N′-alkyl-N-alkyl ureido, N′-alkyl-N-aryl ureido, N′,N′-dialkyl-N-alkyl ureido, N′,N′-dialkyl-N-aryl ureido, N′-aryl-N-alkyl ureido, N′-aryl-N-aryl ureido, N′,N′-diaryl-N-alkyl ureido, N′,N′-diaryl-N-aryl ureido, N′-alkyl-N′-aryl-N-alkyl ureido, N′-alkyl-N′-aryl-N-aryl ureido, alkoxycarbonyl amino, aryloxycarbonyl amino, N-alkyl-N-alkoxycarbonyl amino, N-alkyl-N-aryloxycarbonyl amino, N-aryl-N-alkoxycarbonyl amino, N-aryl-N-aryloxycarbonyl amino, formyl, acyl, carboxy and the conjugate base thereof, alkoxycarbonyl, aryloxycarbonyl, carbamoyl, N-alkylcarbamoyl, N,N-dialkylcarbamoyl, N-arylcarbamoyl, N,N-diarylcarbamoyl, N-alkyl-N-arylcarbamoyl, alkylsulfinyl, arylsulfinyl, alkylsulfonyl, arylsulfonyl, sulfo (—SO₃H) and the conjugate base thereof, alkoxysulfonyl, aryloxysulfonyl, sulfinamoyl, N-alkylsulfinamoyl, N,N-dialkylsulfinamoyl, N-arylsulfinamoyl, N,N-diarylsulfinamoyl, N-alkyl-N-arylsulfinamoyl, sulfamoyl, N-alkyl sulfamoyl, N,N-dialkyl sulfamoyl, N-aryl sulfamoyl, N,N-diaryl sulfamoyl, N-alkyl-N-aryl sulfamoyl, N-acylsulfamoyl and the conjugate base thereof, N-alkylsulfonyl sulfamoyl (—SO₂NHSO₂(alkyl)) and the conjugate base thereof, N-arylsulfonyl sulfamoyl (—SO₂NHSO₂(aryl)) and the conjugate base thereof, N-alkylsulfonyl carbamoyl (—CONHSO₂(alkyl)) and the conjugate base thereof, N-arylsulfonyl carbamoyl (—CONHSO₂(aryl)) and the conjugate base thereof, alkoxysilyl (—Si(Oalkyl)₃), aryloxysilyl (—Si(Oaryl)₃), hydroxysilyl (—Si(OH)₃) and the conjugate base thereof, phosphono (—PO₃H₂) and the conjugate base thereof, dialkyl phosphono (—PO₃(alkyl)₂), diaryl phosphono (—PO₃(aryl)₂), alkylaryl phosphono (—PO₃(alkyl)(aryl)), monoalkyl phosphono (—PO₃H(alkyl)) and the conjugate base thereof, monoaryl phosphono (—PO₃H(aryl)) and the conjugate base thereof, phosphonoxy (—OPO₃H₂) and the conjugate base thereof, dialkyl phosphonoxy (—OPO₃(alkyl)₂), diaryl phosphonoxy (—OPO₃(aryl)₂), alkylaryl phosphonoxy (—OPO₃(alkyl)(aryl)), monoalkyl phosphonoxy (—OPO₃H(alkyl)) and the conjugate base thereof, monoaryl phosphonoxy (—OPO₃H(aryl)) and the conjugate base thereof, cyano, nitro, aryl, alkenyl and alkynyl.

These substituents, if possible, may bond to each other or bond to the carbon atom substituted by them to form a ring.

In formula (IIa), both of R¹ and R² are preferably hydrogen atoms.

Examples of the boronic acid compound represented by formula (Ia) which can be used in the invention include the compounds represented by formula (IIIa).

Z-(Y-L-)ₙ-Cy′-B(OH)₂ (IIIa)

In formula (IIIa), the definitions of Z, Y, L and n are same as those in formula (1) respectively, and preferable examples thereof are same as those in formula (1) respectively. Cy′ represents a cyclic group, preferably aromatic cyclic group, or more preferably phenylene.

Examples of the boronic acid compound represented by formula (Ia) which can be used in the invention include the compounds represented by formula (IVa).

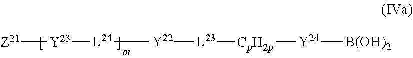

In formula (IVa), the definitions of the symbols in formula (IVa) are same as those in formula (2a) respectively, and preferable examples thereof are same as those in formula (2a) respectively. Y²⁴ represents a cyclic group, preferably aromatic cyclic group, or more preferably phenylene.

Examples of the boronic acid compounds represented by formula (Ia) which can be used in the invention include, but are not limited to, those described below.

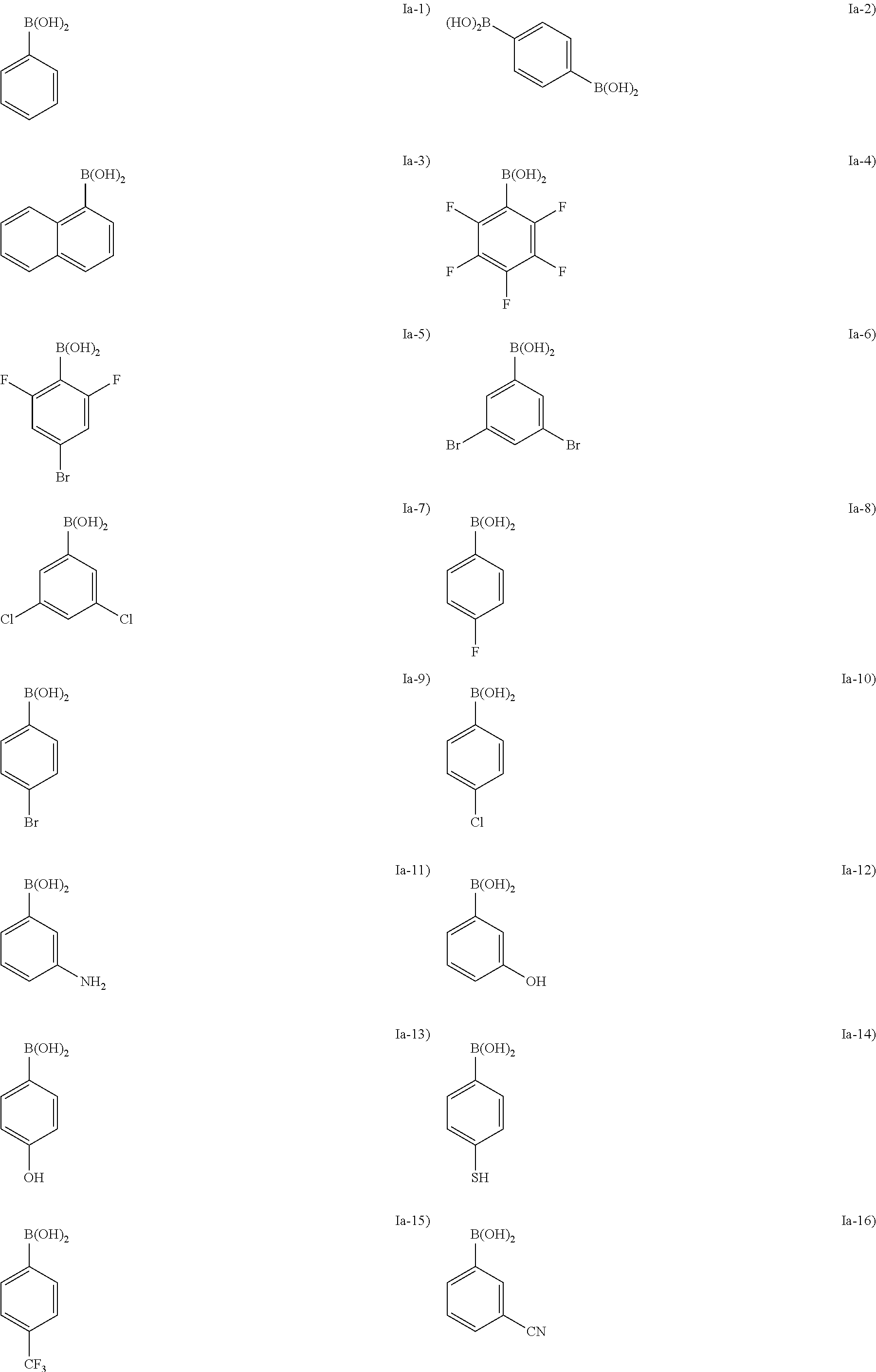

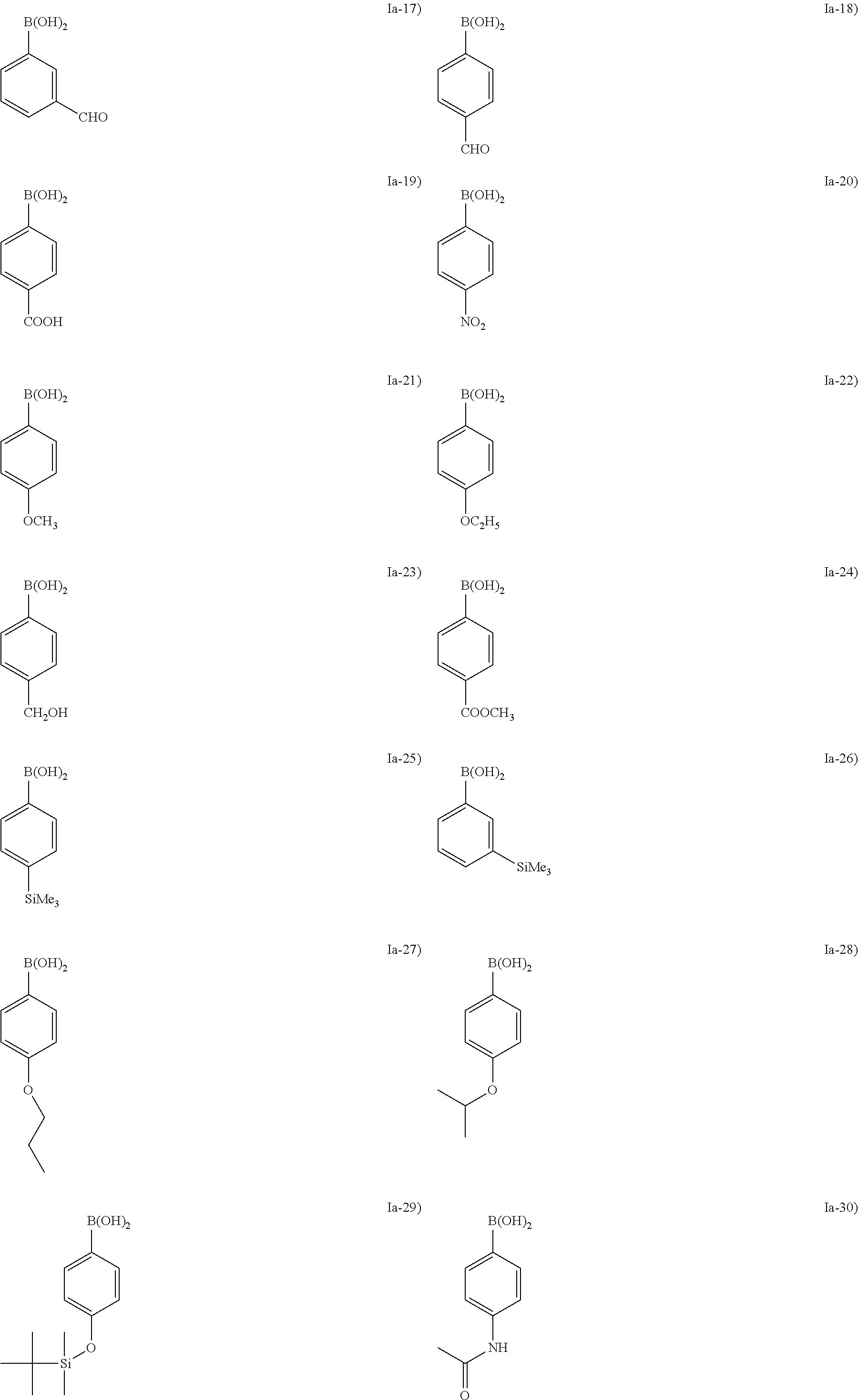

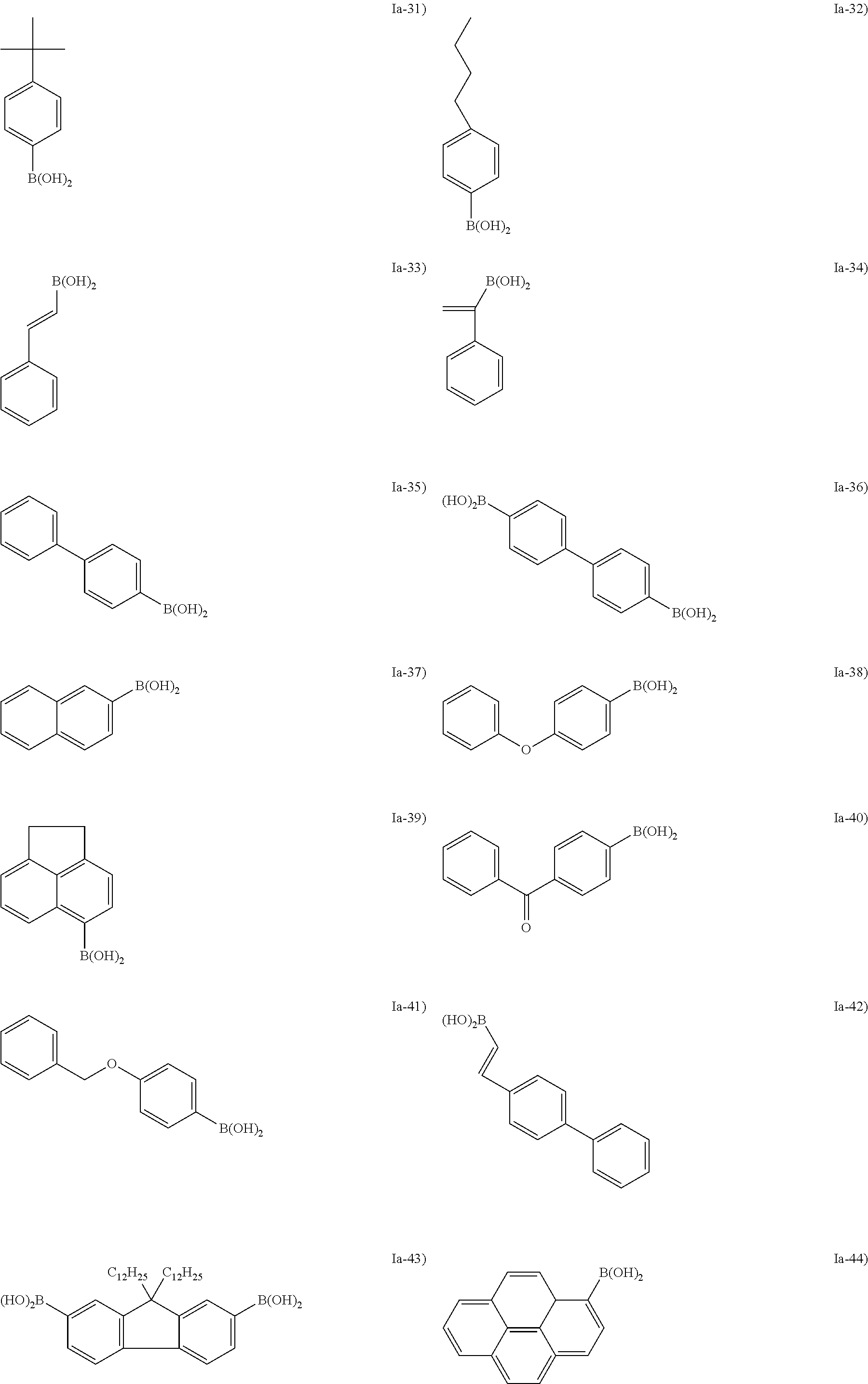

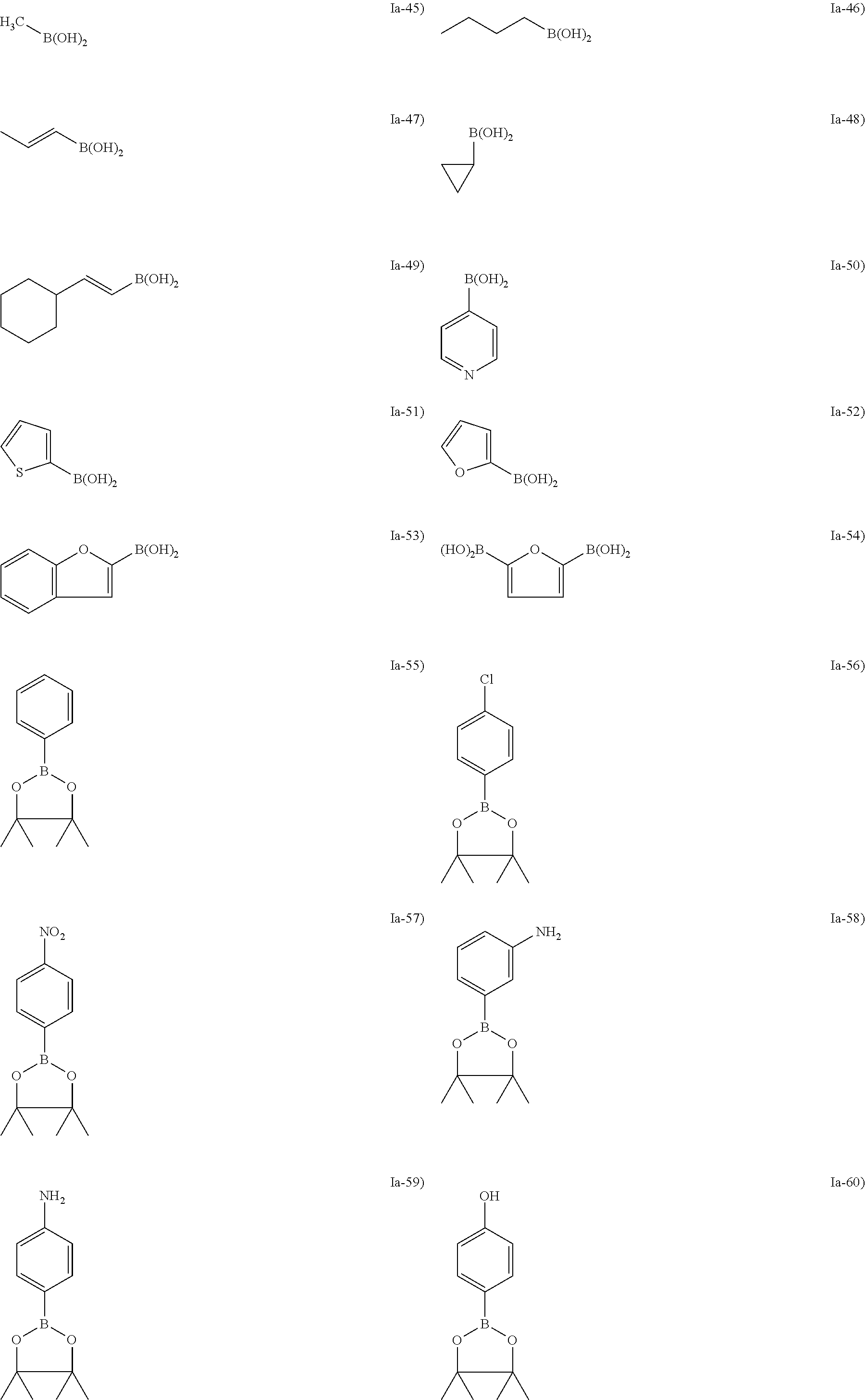

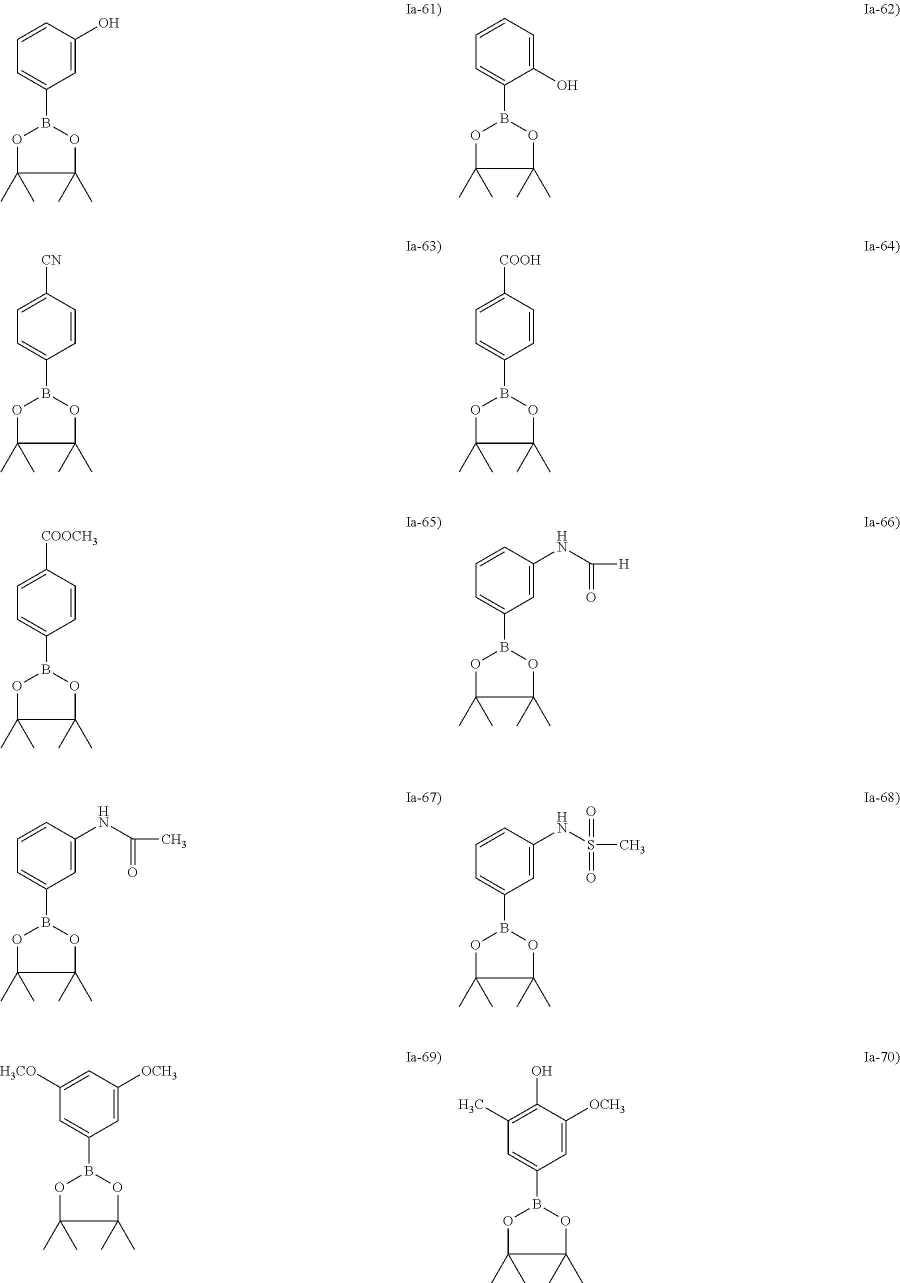

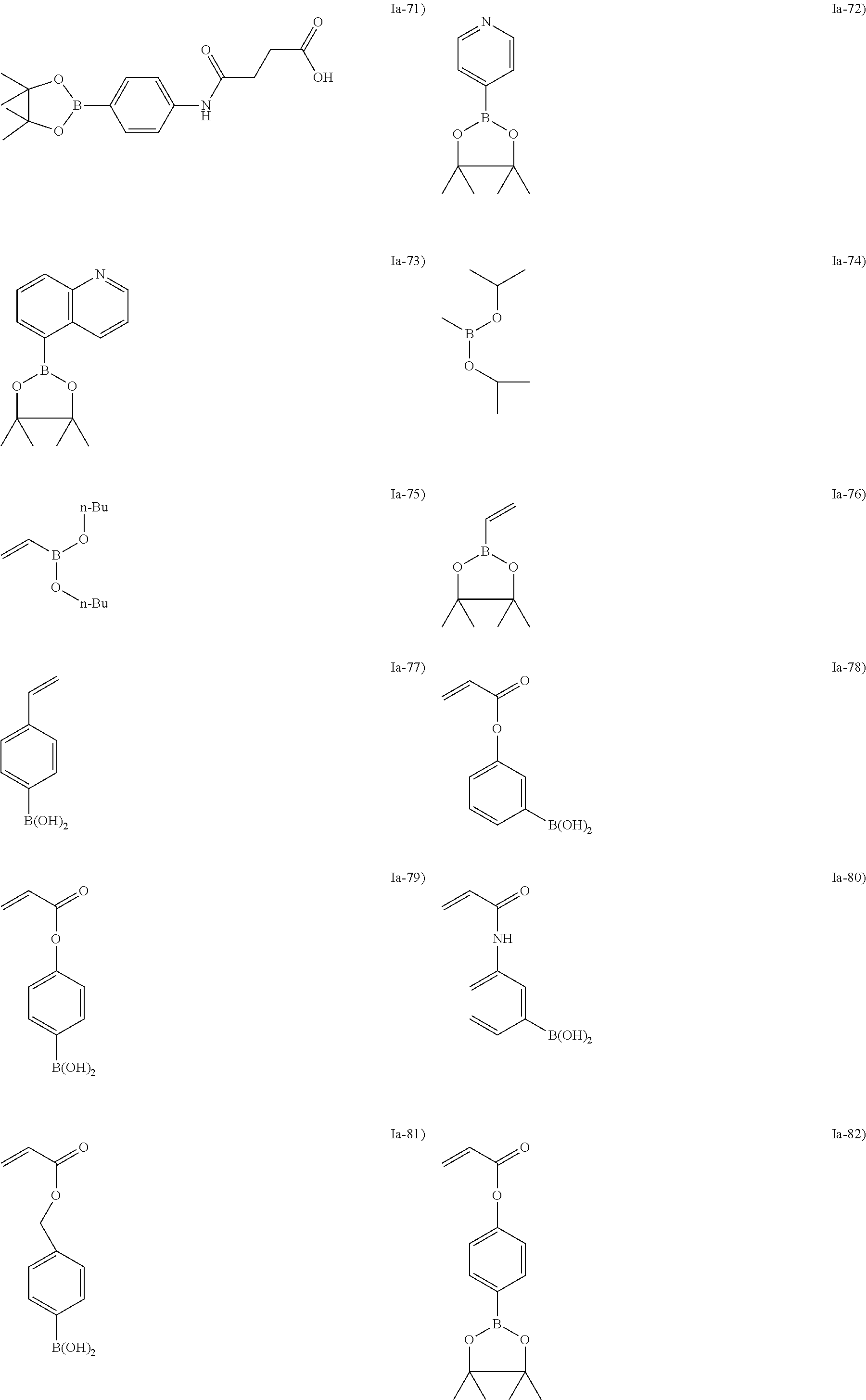

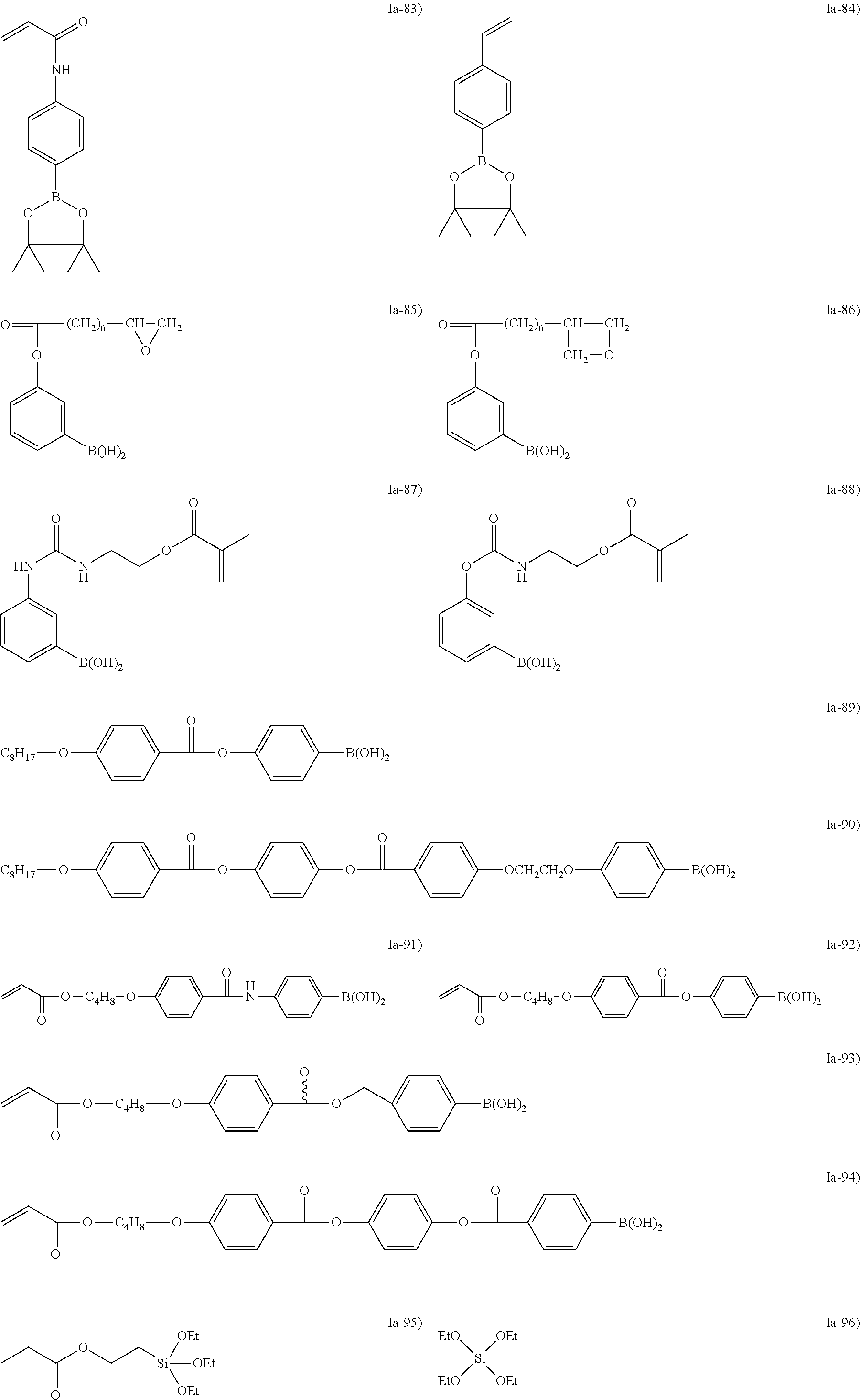

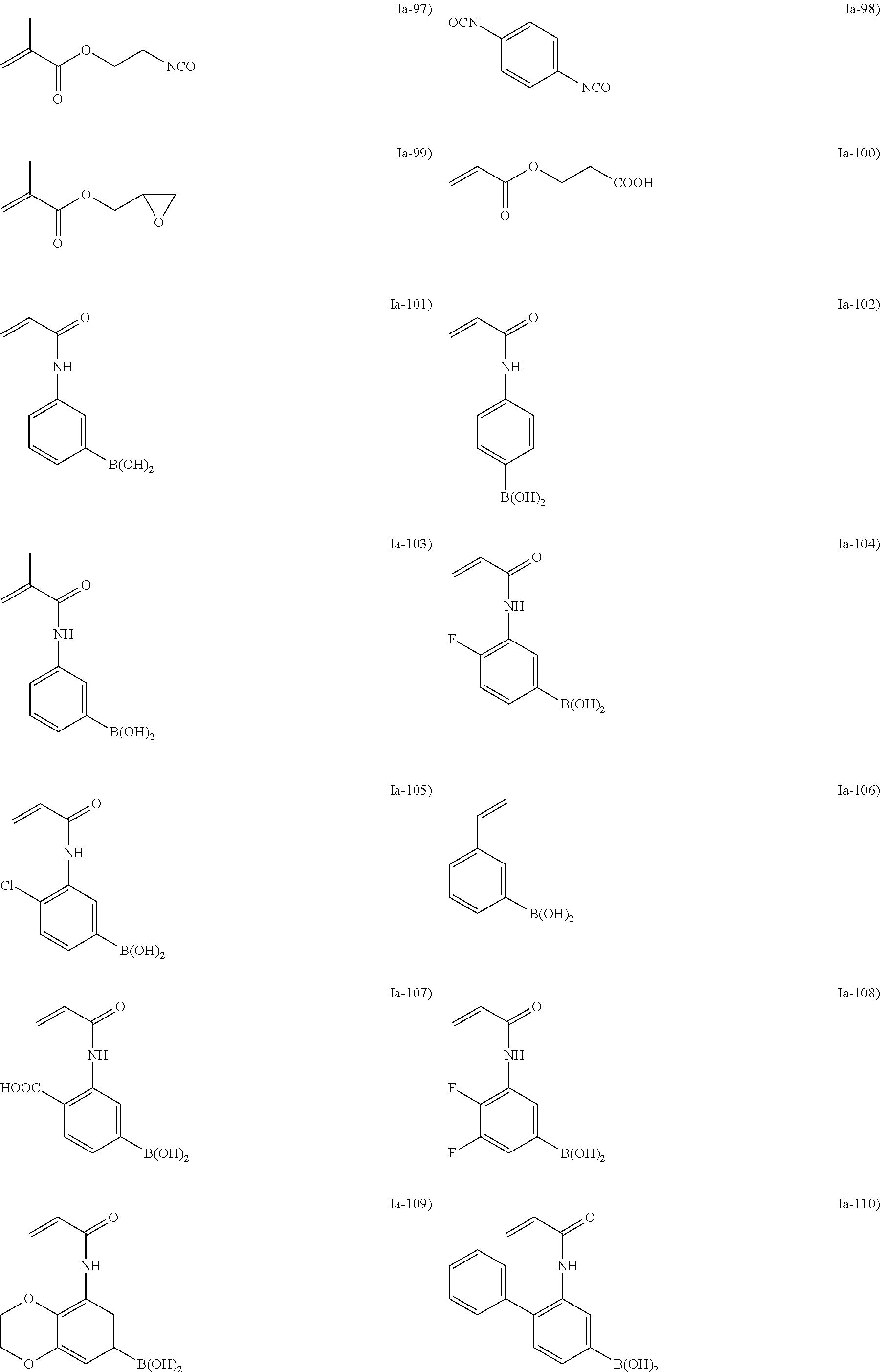

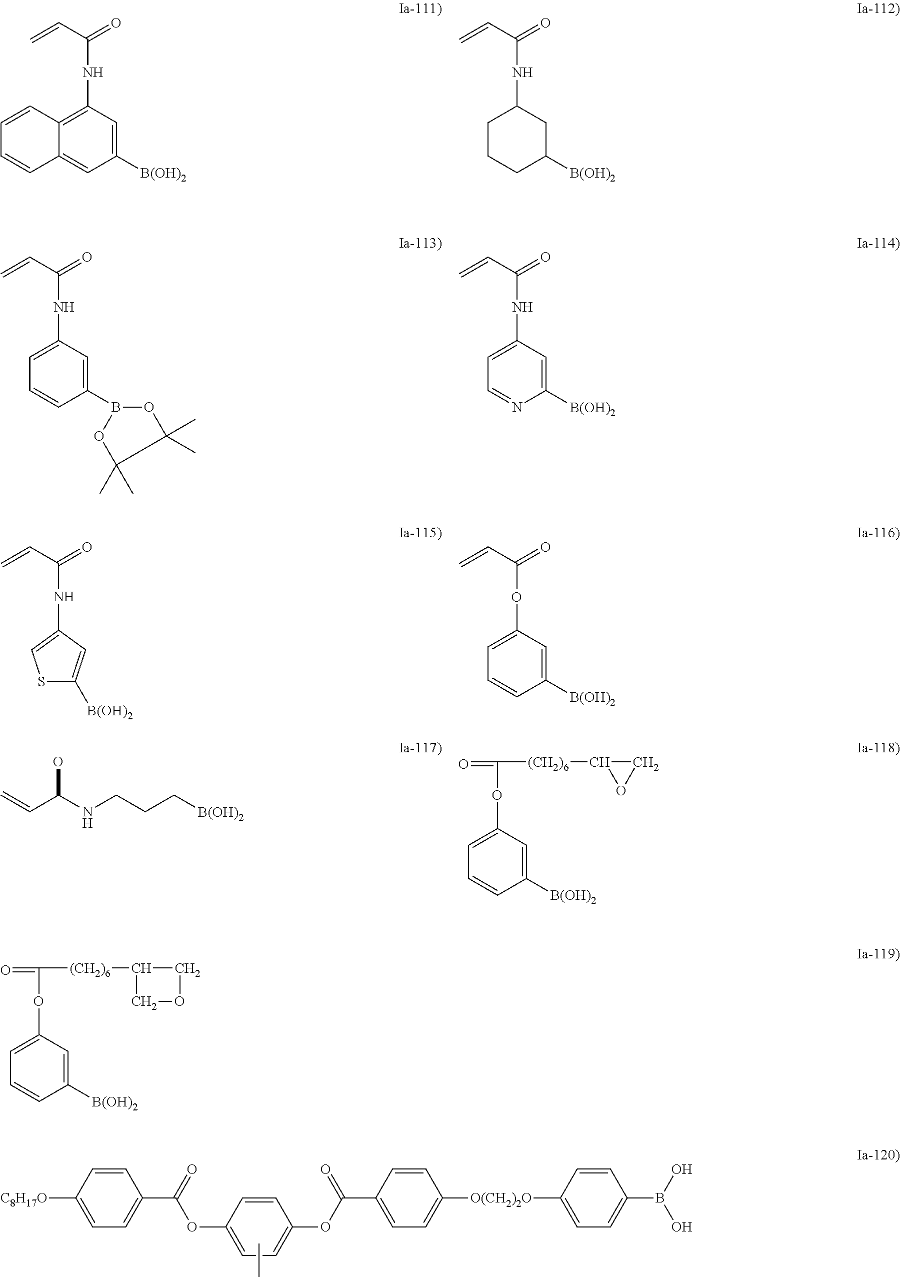

Using the boronic acid compound along with the onium salt in combination as the agent for controlling alignment at the alignment layer interface is one of the preferable embodiments. The boronic acid compound may be localized at the alignment layer interface, and may contribute to stabilizing the vertical alignment of the discotic liquid crystal by the dehydration-reaction with polyvinyl alcohol which is a material of the alignment layer. The dehydration-reaction with polyvinyl alcohol may contribute also to hydrophobizing by extinguishing hydroxys which are diffusion channels of the acidic compound, thereby to inhibit the diffusion of the acidic compound. Therefore, using the boronic acid compound along with the onium salt in combination may improve the discrimination between the non-irradiated and irradiated domains and may achieve accurate pattern formation.

### <Fluoroaliphatic Group-Containing Copolymer (Agent for Controlling Alignment at Air-Interface)>

The fluoroaliphatic group-containing copolymer may be added to the liquid crystal for controlling the alignment of the liquid crystal at the air-interface, and may have a function of increasing the tilt angles of the liquid crystal molecules in the area neighboring to the air interface. And the copolymer may also have a function of improving the coating properties such as unevenness or repelling.

Examples of the fluoroaliphatic group-containing copolymer which can be used in the present invention include those described in JP-A-2004-333852, JP-A-2004-333861, JP-A-2005-134884, JP-A-2005-179636, and JP-A-2005-181977. The polymers having a fluoroaliphatic group and at least a hydrophilic group selected from the group consisting of carboxyl (—COOH), sulfo (—SO₃H), phosphonoxy {—OP(═O)(OH)₂}} and any salts thereof, described in JP-A-2005-179636 and JP-A-2005-181977 are preferable.

An amount of the fluoroaliphatic group-containing copolymer is less than 2% by mass, or preferably from 0.1 to 1% by mass with respect to an amount of the liquid crystal compound.

The fluoroaliphatic group-containing copolymer may localize at the air-interface by the hydrophobic effect of the fluoroaliphatic group, and may provide the low-surface energy area at the air-interface, and the tilt angle of the liquid crystal compound, especially discotic liquid crystal compound, in the area may be increased. Furthermore, by using the copolymer having the hydrophilic group selected from the group consisting of carboxyl (—COOH), sulfo (—SO₃H), phosphonoxy {—OP(═O)(OH)₂}} and any salts thereof, the vertical alignment of the liquid crystal may be achieved by the charge repulsion between the anion of the copolymer and the π electrons of the liquid crystal.

### <Solvent>

The composition to be used for preparing the optically anisotropic layer is preferably prepared as a coating liquid. Organic solvents are preferably used as the solvent used for preparing the coating liquid. Examples of the organic solvents include amides (e.g., N,N-dimethylformamide), sulfoxides (e.g., dimethylsulfoxide), heterocyclic compounds (e.g., pyridine), hydrocarbons (e.g., benzene, hexane), alkyl halide (e.g., chloroform, dichloromethane), esters (e.g., methyl acetate, butyl acetate), ketones (e.g., acetone, methyl ethyl ketone), and ethers (e.g., tetrahydrofuran, 1,2-dimethoxyethane). Alkyl halides and ketones are preferable. Two or more species of organic solvent can be combined.

### <Polymerization Initiator>

The composition (for example coating liquid) containing the liquid crystal having the polymerizable group is aligned in any alignment state, and then, the alignment state is preferably fixed via the polymerization thereof (the 5) step in the above-described process). The fixation is preferably carried out by polymerization reaction between the polymerizable groups introduced into the liquid crystalline compound. Examples of the polymerization reaction include thermal polymerization reaction using a thermal polymerization initiator, and photo-polymerization reaction using a photo-polymerization initiator, wherein photo-polymerization reaction is more preferable. Examples of the photo-polymerization initiator include a-carbonyl compounds (those described in U.S. Pat. Nos. 2,367,661 and 2,367,670), acyloin ethers (those described in U.S. Pat. No. 2,448,828), α-hydrocarbon-substituted aromatic acyloin compounds (those described in U.S. Pat. No. 2,722,512), polynuclear quinone compounds (those described in U.S. Pat. Nos. 3,046,127 and 2,951,758), combinations of triarylimidazole dimer and p-aminophenyl ketone (those described in U.S. Pat. No. 3,549,367), acrydine and phenazine compounds (those described in Japanese Laid-Open Patent Publication No. S60-105667 and U.S. Pat. No. 4,239,850), and oxadiazole compounds (those described in U.S. Pat. No. 4,212,970). Examples of the cationic photo-polymerization initiator include organic sulfonium salts, iodonium salts and phosphonium salts, organic solfonium salts are preferable, and triphenyl sulfonium salts are especially preferable. Preferable examples of the counter ion thereof include hexafluoro antimonate and hexafluoro phosphate.

An amount of the photo-polymerization initiator to be used is preferably from 0.01 to 20% by mass, or more preferable from 0.5 to 5% by mass, with respect to the solid content of the coating liquid.

### <Sensitizer>

For enhancing the sensitivity, any sensitizer may be used along with the polymerization initiator. Examples of the sensitizer include n-butyl amine, triethyl amine, tri-n-butyl phosphine and thioxanthone. The photo-polymerization initiator may be used in combination with other photo-polymerization initiator(s). An amount of the photo-polymerization initiator is preferably from 0.01 to 20% by mass, or more preferably from 0.5 to 5% by mass, with respect to the solid content of the coating liquid. For carrying out the polymerization of the liquid crystal compound, an irradiation with UV light is preferably performed.

### <Other Additives>

The composition may contain any polymerizable non-liquid-crystal monomer(s) along with the polymerizable liquid crystal compound. Preferable examples of the polymerizable monomer include any compounds having vinyl, vinyloxy, acryloyl or methacryloyl. Using any multi-functional monomer, having two or more polymerizable groups, such as ethylene oxide modified trimethylolpropane acrylate may contribute to improving the durability, which is preferable. An amount of the non-liquid-crystal polymerizable monomer to be used is preferably less than 40% by mass, or more preferably from 0 to 20% by mass, with respect to the amount of the liquid crystal compound.

The thickness of the optically anisotropic layer is not limited, and preferably from 0.1 to 10 micro meters, or more preferably from 0.5 to 5 micro meters.

### Transparent Support:

The optical film of the present invention has a transparent support. As the transparent support, any member having almost zero of Re and Rth is preferable. Examples of the transparent support of which retardation is almost zero include glass plates, which can be used in the invention preferably.

Examples of the material constituting the transparent support which can be used in the present invention include polymers excellent in optical transparency, mechanical strength, thermal-stability, water-blocking ability, isotropy or the like. Any materials may be used as far as Re and Rth thereof satisfy the above-described formula (I). Specific examples thereof include polycarbonate series polymers, polyester series polymers such as polyethylene terephthalate and polyethylene naphthalate, acryl series polymers such as polymethylmethacrylate, and styrene series polymers such as polystyrene and acryl nitrile/styrene copolymer (AS resin). Specific examples thereof include also polyolefins such as polyethylene and polypropylene, polyolefin series polymers such as ethylene/propylene copolymers, vinyl chloride series polymers, amide series polymers such as nylon and aromatic polyamide, imide series polymers, sulfone series polymers, polyether sulfone series polymers, polyether ether ketone series polymers, polyphenylene sulfide series polymers, vinylidene chloride series polymers, vinyl alcohol series polymers, vinyl butyral series polymers, arylate series polymers, polyoxymethylene series polymers, epoxy series polymers and any mixtures thereof. The cured layer of any UV cure or thermal cure resins such as acryl, urethane, acryl urethane, epoxy or silicone series cure resins may be also used.

Preferable examples of the material, constituting the transparent support, include thermoplastic norbornene-type reins. Examples of the thermoplastic norbornene-type rein include ZEONEX and ZEONOR (manufactured by ZEON Corporation) and ARTON (manufactured by JSR Corporation.

Preferable examples of the material, constituting the transparent support, include also cellulose series polymers (occasionally referred to as cellulose acylate hereinafter) such as cellulose triacetate used as a transparent protective film of a polarizing plate conventionally

Cellulose acylate will be mainly described in details as an example of the material of the transparent support. However, the technical matters of the cellulose acylate film described under may be applied to other polymer films.

The starting cellulose for the cellulose acylate includes cotton linter and wood pulp (hardwood pulp, softwood pulp), etc.; and any cellulose acylate obtained from any starting cellulose can be used herein. As the case may be, different starting celluloses may be mixed for use herein. The starting cellulose materials are described in detail, for example, in “Plastic Material Lecture (17), Cellulosic Resin” (written by Marusawa & Uda, published by Nikkan Kogyo Shinbun, 1970), and in Hatsumei Kyokai Disclosure Bulletin No. 2001-1745, pp. 7-8. Any cellulose material described in these can be used here with no specific limitation.

The cellulose acylate for use in the invention is, for example, one prepared from cellulose by acylating the hydroxyl group therein, in which the substituent for acylation may be any acyl group having from 2 to 22 carbon atoms. The degree of substitution of the hydroxyl group in cellulose for the cellulose acylate for use in the invention is not specifically defined. The bonding degree with acetic acid and/or a fatty acid having from 3 to 22 carbon atoms for substituting the hydroxyl group in cellulose is measured, and the degree of substitution in the cellulose acylate may be determined through computation. For the measurement, the method of ASTM D-817-91 may be employed.

In the cellulose acylate, the degree of substitution of the hydroxyl group in cellulose is not specifically defined, but preferably, the degree of acyl substitution of the hydroxyl group in cellulose is from 2.50 to 3.00, more preferably from 2.75 to 3.00, even more preferably from 2.85 to 3.00.

The acyl group having from 2 to 22 carbon atoms, which is in acetic acid and/or the fatty acid having from 3 to 22 carbon atoms and which is to substitute for the hydroxyl group in cellulose may be an aliphatic group or an aryl group, and may be a single group or a mixture of two or more different groups. For example, there may be mentioned cellulose alkylcarbonyl esters, alkenylcarbonyl esters, aromatic carbonyl esters, aromatic alkylcarbonyl esters, etc. These may be further substituted. Preferred examples of the acyl group in these include an acetyl group, a propionyl group, a butanoyl group, a heptanoyl group, a hexanoyl group, an octanoyl group, a decanoyl group, a dodecanoyl group, a tridecanoyl group, a tetradecanoyl group, a hexadecanoyl group, an octadecanoyl group, an iso-butanoyl group, a tert-butanoyl group, a cyclohexanecarbonyl group, an oleoyl group, a benzoyl group, a naphthylcarbonyl group, a cinnamoyl group, etc. Of those, preferred are an acetyl group, a propionyl group, a butanoyl group, a dodecanoyl group, an octadecanoyl group, a tert-butanoyl group, an oleoyl group, a benzoyl group, a naphthylcarbonyl group a cinnamoyl group, etc.; and more preferred are an acetyl group, a propionyl group, and a butanoyl group.

In case where the acyl substituent to substitute for the hydroxyl group of cellulose mentioned above comprises at least two of an acetyl group, a propionyl group and a butanoyl group, the degree of total substitution with the substituents is preferably from 2.50 to 3.00 as capable of lowering the optical anisotropy of the cellulose acylate film. More preferably, the degree of acyl substitution is from 2.60 to 3.00, even more preferably from 2.65 to 3.00. Or in case where the acyl substituent to substitute for the hydroxyl group of cellulose mentioned above is only an acetyl group, the degree of total substitution with the substituents is preferably from 2.80 to 2.99 as not only capable of lowering the optical anisotropy of the cellulose acylate film but also capable of improving the compatibility with other additive(s) and the solubility in the organic solvent. More preferably, the degree of acetyl substitution is from 2.85 to 2.95.

Regarding the degree of polymerization of the cellulose acylate to be used here as the starting material, preferably, the viscosity-average degree of polymerization is from 180 to 700. More preferably, the viscosity-average degree of polymerization of cellulose acetate is from 180 to 550, even more preferably from 180 to 400, still more preferably from 180 to 350. When the degree of polymerization is not higher than a predetermined level, then the viscosity of the dope solution of cellulose acylate may be prevented from increasing too much and the film formation by casting may be effectively prevented from becoming difficult. When the degree of polymerization is not lower than a predetermined level, then the strength of the formed film may be effectively prevented from lowering. The degree of polymerization may be measured, for example, according to Uda et al's limiting viscosity method (Kazuo Uda, Hideo Saito, Sen'i Gakkaishi by the Society of Fiber Science and Technology, Japan, Vol. 18, No. 1, pp. 105-120, 1962). The method is described in detail in JP-A 9-95538.

The molecular weight distribution of the cellulose acylate preferably used here as the starting material can be evaluated through gel permeation chromatography, and the polydispersity index Mw/Mn (Mw: mass-average molecular weight, Mn: number-average molecular weight) thereof is preferably smaller, or that is, the molecular weight dispersion thereof is preferably narrower. Concretely, the value of Mw/Mn is preferably from 1.0 to 3.0, more preferably from 1.0 to 2.0, even more preferably from 1.0 to 1.6.

When the low-molecular component is removed, the mean molecular weight (degree of polymerization) may increase but the viscosity could be lower than that of ordinary cellulose acylate, and therefore the case is favorable here. The cellulose acylate in which the content of the low-molecular component is low may be prepared by removing the low-molecular component from cellulose acylate produced according to an ordinary method. The low-molecular component may be removed by washing the cellulose acylate with a suitable organic solvent. In case where the cellulose acylate in which the content of the low-molecular component is low is produced, preferably, the amount of the sulfuric acid catalyst in acetylation is controlled to be from 0.5 to 25 parts by mass relative to 100 parts by mass of cellulose. When the amount of the sulfuric acid catalyst is controlled to fall within the above range, a cellulose acylate favorable in point of the molecular weight distribution thereof (that is, having a uniform molecular weight distribution) can be produced. Preferably, the water content of the cellulose acylate for use in the invention is at most 2% by mass, more preferably at most 1% by mass, even more preferably at most 0.7% by mass. In general, cellulose acylate contains water, and it is known that the water content thereof is from 2.5 to 5% by mass. In order to control the water content of cellulose acylate to fall within the above range, the cellulose acylate must be dried, and the method for drying is not specifically defined so far as the dried cellulose acylate could have the intended water content. The starting cotton and the production method for the cellulose acylate satisfying the above-mentioned various characteristics are described in detail in Hatsumei Kyokai Disclosure Bulletin No. 2001-1745 (published on Mar. 15, 2001 by Hatsumei Kyokai) pp. 7-12.

As the starting material for the cellulose acylate film, preferably used is a single cellulose acylate or a mixture of two or more different types of cellulose acylates of which the substituent, the degree of substitution, the degree of polymerization and the molecular weight distribution each fall within the above-mentioned range.

The cellulose acylate film can be produced according to a solution casting method. To the cellulose acylate solution (dope), various additives (e.g., compound capable of lowering the optical anisotropy, wavelength dispersion characteristics-controlling agent, fine particles, plasticizer, UV inhibitor, antioxidant, separating agent, optical characteristics-controlling agent, etc.) may be added in accordance with the use thereof in the production process. The additive may be added in any stage of the dope production process. The additive may be added at the end of the dope production process.

By adjusting the amount of the additive(s), it is possible to prepare a cellulose acylate film satisfying the condition of 0 nm≦Re(550)≦10 nm. And by using such the cellulose acylate film as a support, it is possible to adjust Re of the first and the second retardation areas to the range of 110 nm≦Re(550)≦165 nm. The Re value preferably satisfies 120 nm≦Re(550)≦145 nm, or more preferably satisfies 130 nm≦Re(550)≦145 nm.

In the relation with the optically anisotropic layer described later, the support preferably satisfies the condition of −150 nm≦Rth(630)≦100 nm for satisfying the condition that the total Rth of the transparent support and the optically anisotropic layer (λ/4 plate) satisfies the condition of |Rth|≦20 nm.

According to a preferable embodiment, the cellulose acylate film contains at least one compound capable of lowering the optical anisotropy.

The compound capable of lowering the optical anisotropy of the cellulose acylate film will be described in details. The compound capable of lowering the optical anisotropy is preferably selected from the compounds which are compatible with the cellulose acylate sufficiently and have neither any rod-like structure nor any planer structure. More specifically, if the compound has plural planar functional groups such as an aromatic group, it is preferable that the functional groups reside in the planes different from each other rather than in the same plane.

For preparing the cellulose acylate film having low retardation, the compound, as the compound capable of preventing the orientation of cellulose acylate in the film to thereby lower the optical anisotropy of the film, preferred for use herein is a compound having an octanol-water partition coefficient (log P value) of from 0 to 7. When a compound having a log P value of at most 7 is used, then the compound is more miscible with cellulose acylate and the film can be effectively prevented from being cloudy and chalky. When a compound having a log P value of at least 0 is used, then the compound is highly hydrophilic and therefore can more effectively prevent the waterproofness of the cellulose acylate film from lowering. More preferably, the log P value is from 1 to 6, even more preferably from 1.5 to 5.

The octanol-water partition coefficient (log P value) can be measured according to a flask dipping method described in JIS (Japanese Industrial Standards) Z7260-107 (2000). In place of actually measuring it, the octanol-water partition coefficient (log P value) may be estimated according to a calculative chemical method or an experiential method. For the calculative method, preferred are a Crippen's fragmentation method (J. Chem. Inf. Comput. Sci., 27, 21 (1987)), a Viswanadhan's fragmentation method (J. Chem. Inf. Comput. Sci., 29, 163 (1989)), a Broto's fragmentation method (Eur. J. Med. Chem.-Chim. Theor., 19, 71 (1984)); and more preferred is a Crippen's fragmentation method (J. Chem. Inf. Comput. Sci., 27, 21 (1987)). When a compound has different log P values, depending on the measuring method or the computing method employed, then the compound may be determined as to whether or not it falls within the scope of the invention preferably according to the Crippen's fragmentation method. The Log P value described in the specification is calculated according to the Crippen's fragmentation method (J. Chem. Inf. Comput. Sci., 27,21 (1987).).

The compound capable of lowering the optical anisotropy may or may not have an aromatic compound. Preferably, the compound capable of lowering the optical anisotropy has a molecular weight of from 150 to 3000, more preferably from 170 to 2000, even more preferably from 200 to 1000. Having a molecular weight that falls within the range, the compound may have a specific monomer structure or may have an oligomer structure or a polymer structure that comprises a plurality of such monomer units bonded.

The compound capable of lowering the optical anisotropy is preferably liquid at 25 degrees Celsius or a solid having a melting point of from 25 to 250 degrees Celsius, more preferably liquid at 25 degrees Celsius or a solid having a melting point of from 25 to 200 degrees Celsius. Also preferably, the compound capable of lowering the optical anisotropy does not vaporize in the process of dope casting and drying for cellulose acylate film formation.

An amount to be added of the compound capable of lowering the optical anisotropy is preferably from 0.01 to 30% by mass, more preferably from 1 to 25% by mass, or even more preferably from 5 to 20% by mass, with respect to the amount of the cellulose acylate.

The compound capable of lowering the optical anisotropy may be used either singly or as a mixture of two or more different types of such compounds combined in any desired ratio.

The compound capable of lowering the optical anisotropy may be added at any time during the preparation of the dope, and may be added at the end of the step for preparing the dope.

Regarding the content of the optical anisotropy-lowering compound in the cellulose acylate film, preferably, the mean content of the compound in the part of 10% of the overall thickness from the surface of at least one side of the film is from 80 to 99% of the mean content of the compound in the center part of the film. An amount of the optical anisotropy-lowering compound existing in the film may be determined by measuring the amount of the compound in the surface area and in the center part of the film, according to a method of infrared spectrometry as in JP-A 8-57879.

Specific examples of compound capable of lowering the optical anisotropy of cellulose acylate film are described in JP-A 2006-199855, columns 0035-0058, and are employable in the invention, to which, however, the invention is not limited.

The optical film of the present invention may be disposed at the viewed side, and may be influenced easily by the outside light, especially UV rays. Therefore, any ultraviolet (UV) absorber is preferably added to the polymer film or the like to be used as a transparent support.

Among the UV absorbers, the compound which has the absorbability for the UV rays within the wavelength range of from 200 to 400 nm and is capable of lowering both of the values of |Re(400)-Re(700)| and |Rth(400)-Rth(700)| is preferable. An amount of the compound to be used is preferably from 0.01 to 30% by mass.

According to the liquid crystal display device such as TV, notebook computers and mobile phones, the optical members to be used in the liquid crystal display device are required to be excellent in transparency for raising the brightness with smaller electricity consumption. From this viewpoint, the cellulose acylate containing the compound, which has the absorbability for the UV rays within the wavelength range of from 200 to 400 nm and is capable of lowering both of the values of |Re(400)-Re(700)| and |Rth(400)-Rth(700)|, is required to be excellent in spectral transmittance. The spectral transmittance of the cellulose acylate film is preferably not less than 45% and not more than 95% at a wavelength of 380 nm and is not more than 10% at a wavelength of 350 nm.

In terms of volatilization, the molecular weight of the UV absorber is preferably from 250 to 1000, more preferably from 260 to 800, even more preferably from 270 to 800, or especially preferably from 300 to 800. Having a molecular weight that falls within the range, the compound may have a specific monomer structure or may have an oligomer structure or a polymer structure that comprises a plurality of such monomer units bonded.

The UV absorber is preferably not volatilized during the step of casting the dope or the step of drying the dope included in the process of preparing the cellulose acylate film

Examples of the UV absorber of the cellulose acylate film include those described in JP-A-2006-199855, columns 0059-0135.

Preferably, fine particles are added as a mat agent to the cellulose acylate film. Fine particles for use in the invention includes silicon dioxide (silica), titanium dioxide, aluminum oxide, zirconium oxide, calcium carbonate, calcium carbonate, talc, clay, calcined kaolin, calcined calcium silicate, calcium silicate hydrate, aluminum silicate, magnesium silicate and calcium phosphate. Of the fine particles, preferred are those containing silicon as the haze of the film with them may be low, and more preferred is silicon dioxide. Preferably, fine particles of silicon dioxide for use herein have a primary mean particle size of not larger than 20 nm and an apparent specific gravity of at least 70 g/liter. Those having a mean particle size of the primary particles of from 5 to 16 nm are more preferred as capable of reducing the haze of the film with them. The apparent specific gravity is preferably from 90 to 200 g/liter or more, more preferably from 100 to 200 g/liter or more. Having a larger apparent specific gravity, the particles may form a dispersion of high concentration, and they are favorable as capable of reducing the haze of the film with them and capable bettering their aggregates.

The fine particles generally form secondary particles having a mean particle size of from 0.1 to 3.0 μm, and the fine particles may exist in the film as aggregates of their primary particles, therefore forming fine projections and recesses with a size of from 0.1 to 3.0 μm in the film surface. The secondary mean particle size is preferably from 0.2 μm to 1.5 μm, more preferably from 0.4 μm to 1.2 μm, even more preferably from 0.6 μm to 1.1 μm. The primary or secondary particle size as referred to herein means the particle size as determined by observing the particles in the film with a scanning electronic microscope and measuring the diameter of the circle that circumscribes the particle. 200 different particles in different sites are analyzed and measured in that manner, and their mean value is the mean particle size.

For fine particles of silicon dioxide, for example, herein usable are commercial products of AEROSIL R972, R972V, R974, R812, 200, 200V, 300, R202, OX50, TT600 (all by Nippon Aerosil). Fine particles of zirconium oxide are commercially available, for example, as AEROSIL R976 and R811 (both by Nippon Aerosil), and they are usable herein.

Of those, especially preferred are AEROSIL 200V and AEROSIL R972V, as they are fine particles of silicon dioxide having a primary mean particle size at most 20 nm and an apparent specific gravity of at least 70 g/liter, and they are significantly effective for reducing the friction coefficient of the optical film with them while keeping the haze of the film low.

In the invention, the method of incorporating the mat agent is not specifically defined. For mixing a dispersion of the mat agent and a solution of additives, and for mixing them with a cellulose acylate solution, preferably used is an in-line mixer. In case where silicon dioxide fine particles are mixed with a solvent to form dispersion, the concentration of silicon dioxide is preferably from 5 to 30% by mass, more preferably from 10 to 25% by mass, even more preferably from 15 to 20% by mass. The dispersion having a higher concentration is preferred as capable of reducing the haze of the film with it and capable bettering its aggregates. Concretely, when the same amount of a dispersion having a higher concentration is added to a film, then the film may have a lower haze. An amount of the mat agent in the final cellulose acylate dope is preferably from 0.01 to 1.0 g per 1 m³, more preferably from 0.03 to 0.3 g per 1 m³, or even more preferably from 0.08 to 0.16 g per 1 m³.

The lower alcohol to be used is preferably methyl alcohol, ethyl alcohol, propyl alcohol, isopropyl alcohol or butyl alcohol. The solvent other than the lower alcohol is not limited, and the solvent which can be used in film-forming of the cellulose acylate can be also used.

Any additive(s) (e.g., plasticizers, UV inhibitors, anti-degradation agents, remover agents, infrared absorbers) other than the compound of lowering the optical anisotropy or the UV absorber may be added to the cellulose acylate film depending on the application thereof, and the additive may be selected from solid or oil materials. Namely, the additive is not limited in terms of the melting point or boiling point. For example, any mixture of UV absorbers having melting points of not higher than 20 degrees Celsius and not lower than 20 degrees Celsius respectively may be used, and any mixture of plasticizers described in JP-A-2001-151901 may be used. Examples of the infrared absorber are described in JP-A-2001-194522. The additive(s) may be added at any time during the step of preparing the dope, and is preferably added at the end of the step of preparing the dope. Furthermore, an amount of the additive is not limited as far as the additive can function as itself. in the embodiment wherein the cellulose acylate film has a multi-layered structure, the species or the amounts of the additive may be different among the layers. The techniques thereof have been known as described in JP-A-2001-151902. The details of the techniques are described in Hatsumei Kyokai Disclosure Bulletin No. 2001-1745 (published on Mar. 15, 2001 by Hatsumei Kyokai) pp. 16-22.

The plasticizer may be added or not be added to the cellulose acylate film as shown in Examples. Some compounds, which are capable of lowering the optical anisotropy, may also act as a plasticizer; and therefore, no plasticizer may be added to the film containing any of such compounds.

The cellulose acylate film is preferably prepared according to any solution film-forming method using a cellulose acylate solution. The dissolution method to be used in preparation of the cellulose acylate solution is not limited, the dissolution may be carried out at a room temperature, or the low-temperature-dissolution method, the high-temperature-dissolution method or the combination thereof may be carried out. Regarding the step of preparation of the cellulose acylate solution, the step of condensation of the solution along with the step of dissolution and the step of filtration, the details are described in Hatsumei Kyokai Disclosure Bulletin No. 2001-1745 (published on Mar. 15, 2001 by Hatsumei Kyokai) pp. 22-25, which are preferably used in the invention.

The dope-transparency of the cellulose acylate solution is preferably equal to or more than 85%. It is more preferably equal to or more than 88%, or even more preferably equal to or more than 90%. According to the present invention, the additive(s) is preferably dissolved in the cellulose acylate solution. The concrete method for calculating the dope-transparency is as follows. A 1 cm-square glass cell is filled with a cellulose acylate dope, and the absorbance at 550 nm is measured by using a spectrometer (for example, UV-3150, by Shimazu). Regarding the solvent only, the absorbance at 550 nm is measured as a blank, and the dope-transparency is calculated as a ratio of the absorbance of the cellulose acylate solution to the absorbance of the blank.

The cellulose acylate film may be produced by a conventional method of solution casting film formation, using a conventional apparatus for solution casting film formation. A dope (cellulose acylate solution) prepared in a dissolution machine (pot) is once stored in a storage pot, and after defoaming of bubbles contained in the dope, the dope is subjected to final preparation. Then, the dope is discharged from a dope exhaust and fed into a pressure die via, for example, a pressure constant-rate gear pump capable of feeding the dope at a constant flow rate at a high accuracy depending upon a rotational rate; the dope is uniformly cast from a nozzle (slit) of the pressure die onto a metallic support continuously running in an endless manner in the casting section; and at the peeling point where the metallic support has substantially rounded in one cycle, the half-dried dope film (also called a web) is peeled away from the metallic support. The obtained web is clipped at both ends and dried by conveying with a tenter while keeping a width. Subsequently, the obtained film is mechanically conveyed with a group of rolls in a dryer to terminate the drying and then wound in a roll form with a winder in a prescribed length. A combination of the tenter and the dryer of a group of rolls varies depending upon the purpose. In the solution casting film formation for the film formation of a functional protective film that is an optical member for liquid crystal display device which is a main application of the cellulose acylate film of the invention, in addition to a solution casting film forming apparatus, a coating apparatus is often added for the purpose of subjecting a coating layer such as a subbing layer, an antistatic layer, an anti-halation layer and a protective layer to coating and formation (coating processing) on the surface of the film. These are described in detail in Journal of Technical Disclosure, No. 2001-1745, pages 25 to 30, issued on Mar. 15, 2001 by Japan Institute of Invention and Innovation and are classified into casting (including co-casting), metallic support, drying, releasing (peeling) and so on. Those can be preferably adopted in the invention.

The thickness of the cellulose acylate film is preferably from 10 to 120 micro meters, more preferably from 20 to 100 micro meters, or even more preferably from 30 to 90 micro meters.

Properties of Polymer Film to be used as Transparent Support:

The preferable properties of the polymer film to be used as a transparent support in the present invention will be described in details below.

### <Re and Rth>

In this description, Re(λ) and Rth(λ) are retardation (nm) in plane and retardation (nm) along the thickness direction, respectively, at a wavelength of λ. Re(λ) is measured by applying light having a wavelength of λ nm to a film in the normal direction of the film, using KOBRA 21ADH or WR (by Oji Scientific Instruments). The selection of the measurement wavelength may be conducted according to the manual-exchange of the wavelength-selective-filter or according to the exchange of the measurement value by the program.

When a film to be analyzed is expressed by a monoaxial or biaxial index ellipsoid, Rth(λ) of the film is calculated as follows.

Rth(λ) is calculated by KOBRA 21ADH or WR on the basis of the six Re(λ) values which are measured for incoming light of a wavelength λ nm in six directions which are decided by a 10° step rotation from 0° to 50° with respect to the normal direction of a sample film using an in-plane slow axis, which is decided by KOBRA 21ADH, as an inclination axis (a rotation axis; defined in an arbitrary in-plane direction if the film has no slow axis in plane), a value of hypothetical mean refractive index, and a value entered as a thickness value of the film.

In the above, when the film to be analyzed has a direction in which the retardation value is zero at a certain inclination angle, around the in-plane slow axis from the normal direction as the rotation axis, then the retardation value at the inclination angle larger than the inclination angle to give a zero retardation is changed to negative data, and then the Rth(λ) of the film is calculated by KOBRA 21ADH or WR.

Around the slow axis as the inclination angle (rotation angle) of the film (when the film does not have a slow axis, then its rotation axis may be in any in-plane direction of the film), the retardation values are measured in any desired inclined two directions, and based on the data, and the estimated value of the mean refractive index and the inputted film thickness value, Rth may be calculated according to formulae (11) and (12):

$$Re ( θ ) = [ nx - \frac{ny \times nz}{\sqrt{{\{ ny sin ( {sin}^{- 1} ( \frac{sin ( - θ )}{nx} ) ) \}}^{2} + {\{ nz cos ( {sin}^{- 1} ( \frac{sin ( - θ )}{nx} ) ) \}}^{2}}} ] \times \frac{d}{cos \{ {sin}^{- 1} ( \frac{sin ( - θ )}{nx} ) \}}$$

Re(θ) represents a retardation value in the direction inclined by an angle 8 from the normal direction; nx represents a refractive index in the in-plane slow axis direction; ny represents a refractive index in the in-plane direction perpendicular to nx; and nz represents a refractive index in the direction perpendicular to nx and ny. And “d” is a thickness of the film.

Rth={(nx+ny)/2-nz}×d (12)

In the formula, nx represents a refractive index in the in-plane slow axis direction; ny represents a refractive index in the in-plane direction perpendicular to nx; and nz represents a refractive index in the direction perpendicular to nx and ny. And “d” is a thickness of the film.

When the film to be analyzed is not expressed by a monoaxial or biaxial index ellipsoid, or that is, when the film does not have an optical axis, then Rth(λ) of the film may be calculated as follows:

Re(λ) of the film is measured around the slow axis (judged by KOBRA 21ADH or WR) as the in-plane inclination axis (rotation axis), relative to the normal direction of the film from −50 degrees up to +50 degrees at intervals of 10 degrees, in 11 points in all with a light having a wavelength of λ nm applied in the inclined direction; and based on the thus-measured retardation values, the estimated value of the mean refractive index and the inputted film thickness value, Rth(λ) of the film may be calculated by KOBRA 21ADH or WR.

In the above-described measurement, the hypothetical value of mean refractive index is available from values listed in catalogues of various optical films in Polymer Handbook (John Wiley & Sons, Inc.). Those having the mean refractive indices unknown can be measured using an Abbe refract meter. Mean refractive indices of some main optical films are listed below:

cellulose acylate (1.48), cycloolefin polymer (1.52), polycarbonate (1.59), polymethylmethacrylate (1.49) and polystyrene (1.59). KOBRA 21ADH or WR calculates nx, ny and nz, upon enter of the hypothetical values of these mean refractive indices and the film thickness. On the basis of thus-calculated nx, ny and nz, Nz=(nx−nz)/(nx−ny) is further calculated.

One example of the polymer film to be used as the transparent support is a low-retardation film having Re of from 0 to 10 nm and the absolute value of Rth of not more than 20 nm.

### <Coefficient of Humidity Expansion>

The coefficient of humidity expansion of the polymer film may be decided depending on the combination with the coefficient of thermal expansion, is preferably from 3.0×10⁻⁶ to 500×10⁻⁶/% RH, is more preferably from 4.0×10⁻⁶ to 100×10⁻⁶/% RH, is even more preferably from 5.0×10⁻⁶ to 50×10⁻⁶/% RH, or most preferably from 5.0×10⁻⁶ to 40×10⁻⁶/% RH.

The coefficient of thermal expansion may be measured according to “IS011359-2” as follows. A film sample is heated to 80 degrees Celsius from a room temperature, and then is cooled to a temperature of from 60 degrees Celsius to 50 degrees Celsius. The coefficient is calculated on the basis of the slope of the length of the film sample during the cooling.

For measuring the coefficient of humidity expansion, a film sample having a length (this is a measuring direction) of 25 cm and a width of 5 cm is cut from a long film along the long direction so that the direction giving the maximum elastic modulus is the long direction. The pin holes in a 20 cm interval are punched in the film sample, and the film sample is left in the atmosphere at 25 degrees Celsius and 10% RH for 24 hours, and then the interval between the holes is measured (measured value L₀) by a pin-gauge. Next, the film sample is left in the atmosphere at 25 degrees Celsius and 80% RH for 24 hours, and then the interval between the holes is measured (measured value L₁) by a pin-gauge. The coefficient of humidity expansion (/% RH) of the film sample is calculated on the basis of these measured values according to the following formula.

Coefficient of Humidity Expansion={(L₁−L₀)/L₀}/(R₁−R₀)

### <Elastic Modulus>

The elastic modulus of the polymer film is not limited, is preferably from 1 to 50 GPa, more preferably from 5 to 50 GPa, or even more preferably from 7 to 20 GPa. The elastic modulus may be adjusted to the preferable range by selecting the species of the polymer, the species or amount of the additive or the stretching treatment.

The elastic modulus is measured as follows. A film sample having a length of 150 mm and a width of 10 mm is prepared, and is left in the atmosphere at 25 degrees Celsius and 60% RH for 24 hours, and then the measurement according to the standard “ISO527-3:1995” is conducted under the condition that the initial sample length is 100 mm and the tension rate is 10 mm/min. On the basis of the initial slope of the stress-strain curve, the tensile elastic modulus is calculated, which is the elastic modulus in the specification. Usually, the elastic modulus may be varied depending on which direction is determined as the long or width direction of the film, and, in the specification, the elastic modulus is defined as the value which is measured for the sample prepared along the direction giving the maximum value. If the elastic modulus along the direction giving the maximum sound wave velocity is defined as E1 and the elastic modulus along the direction orthogonal to the direction is defined as E2, the ratio thereof (E1/E2) is preferably from 1.1 to 5.0, or more preferably from 1.5 to 3.0 in terms of keeping the flexibility of the film and reducing the dimension variation of the film.

According to the invention, the direction giving the maximum sound wave velocity is obtained as follows. The film to be analyzed is conditioned at 25 degrees Celsius and at a relative humidity of 60% for 24 hours, then by using an orientation analyzer (SST-2500, by Nomura Shoji), the direction giving the maximum sound wave velocity is obtained as the direction giving the maximum velocity of transmitting the longitudinal wave of the ultrasonic pulse.

### <Total Transmittance or Haze>

According to the present invention, a sample is conditioned at 25 degrees Celsius and at a relative humidity of 60% for 24 hours, and then, by using a haze meter (NDH 2000, by Nippon Denshoku), the values are measured as haze and the total transmittance.

The polymer film having the higher total transmittance is more preferable in terms of the efficiency of the light emitted from the light source and reducing the electricity consumption of the panel. And the total transmittance is preferably equal to or more than 85%, more preferably equal to or more than 90% or even more preferably equal to or more than 92%. Haze of the film is preferably equal to or less than 5%, more preferably equal to or less than 3%, even more preferably equal to or less than 3%, or especially preferably equal to or less than 0.5%.

### <Tear Strength>

According to the invention, the tear strength test (Ermendorf Tear Method) is conducted as follows. Film samples having a dimension of 64 mm×50 mm are cut from a long film along the directions parallel and orthogonal to the slow direction of the film respectively, and are left in the atmosphere at 25 degrees Celsius and 60% RH for 2 hours, and then, by using a light-load tear strength tester, the measurement is conducted. The smaller value is defined as the tear strength.

The tear strength of the polymer film is preferably from 3 to 50 g, more preferably from 5 to 40 g, or even more preferably from 10 to 30 g in terms of the fragility of the film.

### <Thickness>

The thickness of the polymer film is preferably from 10 to 1000 micro meters, more preferably from 40 to 500 micro meters, or even more preferably from 40 to 200 micro meters in terms of reducing the producing cost.

### 2. Polarizing Plate

The present invention relates to also the polarizing plate having the optical film of the invention. One embodiment of the polarizing plate of the invention comprises the optical film of the invention and a polarizing film, wherein the in-plane slow axes of the first and second retardation domains are along the direction of 45° respectively relative to the absorption axis of the polarizing film. The polarizing plate of the invention may be disposed at the viewed side of the displaying device for displaying 3D images so that the optical film faces to the viewed side.

Embodiments of the polarizing plate of the invention include not only the film-shaped embodiments which can be incorporated directly but also long band-shaped and roll-shaped embodiments (for example, the roll length is equal to or longer than 2500 m or 3900 m) which are obtained in the continuous production. The width of the polarizing plate is preferably equal to or more than 1470 mm when the polarizing plate is used in a large-screen displaying device.

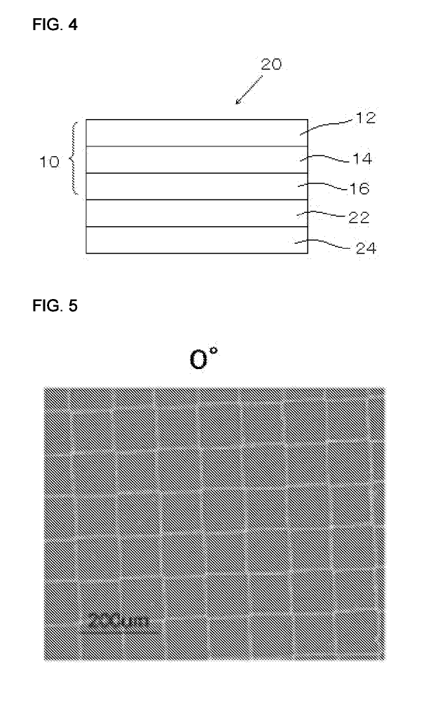

The layer construction of the polarizing plate is not limited. The polarizing plate may have a usual layer-construction. One feature of the polarizing plate resides in that it has the optical film of the invention. FIG. 4 is a cross-section view showing a frame format of an example of the polarizing plate of the present invention. The polarizing plate 20 shown in FIG. 4 has a polarizing film 22, the optical film of the present invention on one surface thereof, and a protective film 24 on another surface thereof. Examples of the polymer film to be used as the protective film 24 are same as those of the polymer film to be used as the transparent support of the optical film 10.

### Preparation of Polarizing Plate:

One example of the process of preparing the polarizing plate of the invention comprises:

forming an alignment layer of a composition, comprising at least one photo-acid-generating agent, on a long polymer film such as a cellulose acylate film to be used as a transparent support while the long polymer film is transported;

subjecting the alignment layer to a rubbing treatment along the 45° oblique direction relative to the transporting direction continuously;

irradiating the alignment layer with light through a photo-mask, thereby to decompose the at least one photo-acid-generating agent in the irradiated area, and to generate an acidic compound in the irradiated area, wherein the photo-mask is disposed so that the border line between the light-block region/the light-transmissive region is parallel to the transporting direction;

applying a composition, comprising a liquid crystal having a polymerizable group as a main ingredient, to the alignment layer, thereby to form a coated layer;

aligning the liquid crystal at a temperature of T₁ degrees Celsius, so that a slow axis of the irradiated domain is aligned along a first direction and a slow axis of the non-irradiated domain is aligned along a second direction which is different from the first direction;

polymerizing the liquid crystal at a temperature of T₂ (T₁>T₂) degrees Celsius under a full irradiation of light, thereby to fix the liquid crystal in an alignment state, and to form an optically anisotropic patterned layer with a first retardation domain and a second retardation domain having slow axes which are aligned along the directions different from each other; and

sticking the long polymer film having the optically anisotropic patterned layer thereon and a long polarizing film having a transmission axis along the cross direction according to a roll-to-roll manner.

The cost spent in the above-described process for preparing the polarizing plate may be smaller, compared with the conventional process, in terms of possibility of continuous manufacture. If the rubbing direction is conducted along the 45° oblique direction relative to the film-transporting direction, it is not necessary to cut out the obtained long polarizing plate along the oblique direction, which may result in reducing the cost spent in the process of preparing the polarizing plate.

### Polarizing Film:

The polarizing film may be selected from the commonly-used polarizing films. For example, the polarizing films formed of polyvinyl alcohol films dyed with iodine or dichroic dyes may be used.

### Pressure-Sensitive Adhesion Layer:

The polarizing plate of the present invention may have a pressure-sensitive adhesion layer disposed between the optical film and the polarizing film. The pressure-sensitive adhesion layer to be used for sticking the optical film and the polarizing film may be formed of a material having the ration of G″ to G′ (tan δ=G″/G′) of from 0.001 to 1.5, where G″ and G′ are measured by a dynamic viscoelasticity measurement device. Examples of such a material include the pressure-sensitive adhesion agents and the easily-creeping materials. Examples of the pressure-sensitive adhesion material include polyvinyl-alcohol series pressure-sensitive adhesion agents.

### Antireflection Layer:

Any functional layer such as an antireflection layer is preferably formed on the surface of the polarizing plate which is disposed at the side opposite to the liquid crystal cell. Especially, according to the invention, an antireflection layer having a lamination of a light-scattering layer and a low-refractive layer formed in this order on a transparent protective film or an antireflection layer having a lamination of middle-refractive layer, high-refractive layer and low-refractive layer formed in this order on a transparent protective film is preferable. The antireflection layer may efficiently prevent the flicker from occurring due to the reflection of the outside light especially when 3D images are displayed. The antireflection layer may further contain any functional layer(s) such as a hard-coat layer, forward-scattering layer, primer layer, antistatic layer, undercoat layer and protective layer. The details of each of the layers constituting the antireflection layer are described in JP-A-2007-254699, columns 0182-0220, and the preferable properties and preferable materials thereof are same as those described in the document.

### 3. Image Display Device and Stereoscopic Image Display System

The present invention relates to the image display device and the stereoscopic image display device employing the optical film of the present invention. One example of the image display device comprises:

a first polarizing film and a second polarizing film,

a liquid crystal cell disposed between the first and second polarizing films, comprising a pair of substrates and a liquid crystal layer disposed between the pair of substrates, and

an optical film of any one of claims 1-16 disposed on the outer side of the first polarizing film;

wherein the angle between each of slow axes in plane of the first retardation domain or the second retardation domain of the optical film and an absorption axis of the first polarizing film is ±45°.

One example of the stereoscopic image display device comprises:

the image display device, and

a third polarizing plate disposed at the outside of the optical film

wherein the stereoscopic images are viewed through the third polarizing plate.

The image display device of the invention may employ any modes such as a TN (Twisted Nematic), IPS (In-Plane Switching), FLC (Ferroelectric Liquid Crystal), AFLC (Anti-ferroelectric Liquid Crystal), OCB (Optically Compensatory Bend), STN (Supper Twisted Nematic), VA (Vertically Aligned) and HAN(Hybrid Aligned Nematic) modes.

### Third Polarizing Plate:

According to the stereoscopic image display system of the present invention, the stereoscopic images (3D images) are viewed through a glasses-shaped polarizing plate (third polarizing plate)

### <Polarization Glasses>

One preferable embodiment of the present invention is the display system comprising polarization glasses of which the slow axes in the glasses for the right and left eyes are orthogonal to each other, wherein the polarization images for the right eye coming out from one of the first or second retardation domains are transmissive through the glass for the right eye and blocked by the glass for the left eye, and the polarization images for the left eye coming out from another of the first or second retardation domains are transmissive through the glass for the left eye and blocked by the glass for the right eye.

The polarization glasses may comprise a retardation layer and a linear polarizer. Other member having a same function as the polarizer may be used in place of the polarizer.

The construction including the polarization glasses of the display device of the invention will be described in details. The optical film of the invention has the first and second retardation domains (of which the polarization-transformation functions are different from each other) formed on alternately-disposed plural first lines and plural second lines (e.g., plural even number lines and plural odd number lines along the horizontal direction if the lines are along the horizontal direction, or plural even number lines and plural odd number lines along the vertical direction if the lines are along the vertical direction) of the display panel respectively. If the circularly-polarized light is used for displaying, both of the first and second domains preferably have λ/4, and more preferably have slow axes orthogonal to each other.

If the circularly-polarized light is used for displaying, both of the first and second domains may have λ/4, the images for the right eye may be displayed on the odd number lines of the display panel, and the slow axes of the retardation domains formed on the odd number lines may be along the 45° direction. According to the embodiment describe above, the λ/4 plate may be disposed on both of the glasses for the right and left eyes of the polarization glasses, and the slow axis of the λ/4 plate disposed on the glass for the right eye may be along the 45° direction. And according to the embodiment described above, the images for the left eye may be displayed on the even number lines of the display panel, the slow axes of the retardation domains formed on the even number lines may be along the 135° direction, and the slow axis of the λ/4 plate disposed on the glass for the left eye may be along the 135° direction.

In terms of restoring the polarization state of the outgoing image-lights, circularly-polarized lights, from the patterned retardation film by the polarization glasses, it is more preferable that the slow axis of the glass for the right eye is more exactly along the 45° direction relative to the horizontal direction, and it is more preferable that the slow axis of the glass for the left eye is more exactly along the 135° (or −45° direction relative to the horizontal direction

According to the embodiment employing the liquid crystal display panel, the absorption axis of the polarizing plate disposed at the front side of the panel is usually along the horizontal direction, and the absorption axis of the linear polarizer of the polarization glasses is preferably orthogonal to the absorption axis of the front polarizing plate and is preferably along the vertical direction.

The angle between the absorption axis of the front polarizing plate of the liquid crystal display panel and each of the slow axes of even-number and odd-number retardation domains of the patterned retardation film is preferably 45° in terms of efficiency of the polarization transformation.

Preferable examples of the construction of the polarization glasses, the patterned retardation film and the liquid crystal display device include those described in JP-A-2004-170693.

Examples of the polarization glasses which can be used in the invention include those described in JP-A-2004-170693 and the commercially-available products such as the accessory of “ZM-M220 W” manufactured by Zalman.

### EXAMPLES

Paragraphs below will further specifically describe features of the present invention, referring to Examples and Comparative Examples. Any materials, amount of use, ratio, details of processing, procedures of processing and so forth shown in Examples may appropriately be modified without departing from the spirit of the present invention. Therefore, it is to be understood that the scope of the present invention should not be interpreted in a limited manner based on the specific examples shown below.

### Example 1

### Preparation of Transparent Support with Rubbed Alignment Layer

A composition for an alignment layer having the following formulation was prepared, and filtrated with a filter made of polypropylene having a pore diameter of 0.2 micro meters, to give a coating liquid for an alignment layer. The coating liquid was applied to the surface of a transparent glass plate by using a No. 8 wire bar, and dried at 100 degrees Celsius for a minute, to form a layer. A checkered mask was disposed on the layer, and then, irradiated with the UV light for 4 seconds by using an air-cooling metal halide lamp (manufactured by EYE GRAPHICS Co., Ltd.) of which the luminance of the UV-C region was 2.5 mW/cm² under the air-atmosphere at a room temperature, to generate the acidic compound by the decomposition of the photo-acid-generating agent and to form an alignment layer for the first retardation domain. The irradiated domain (for the first irradiation domain) of the alignment layer and the non-irradiated domain (for the second retardation domain) of the alignment layer were analyzed respectively by using a TOF-SIMS (time-of-flight secondary ion mass spectrometry method, “TOF-SIMS V” manufactured by ION-TOF), and the abundance ratio of the photo-acid-generating agent in the alignment layer corresponding to the first retardation domain to the photo-acid-generating agent in the alignment layer corresponding to the second retardation domain was 8/92. After that, the alignment layer was subjected to a rubbing treatment along one direction by a stroke at 500 rpm, to provide a glass plate with a rubbed alignment layer. Re(550) of the glass plate was 0 nm, and the thickness of the alignment layer was 0.5 micro meters.

### <Formulation of Composition for Alignment Layer>

| | | |
|---|---|---|
| Polymer material for alignment layer | 3.9 | parts by mass |
| (polyvinyl alcohol, PVA 103, Kuraray Co., Ltd.) | | |
| Photo-acid-generating agent (S-1) | 0.1 | parts by mass |
| Methanol | 36 | parts by mass |
| Water | 60 | parts by mass |

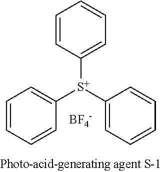

### <Preparation of Optically Anisotropic Patterned Layer>

A composition having the following formulation was prepared, and filtrated with a filter made of polypropylene having a pore diameter of 0.2 micro meters, to give a coating liquid for an optically anisotropic layer. The coating liquid was applied to the rubbed surface of the alignment layer, dried at a film-surface temperature of 110 degrees Celsius for 2 minutes, to align uniformly and form a liquid crystal phase, cooled down to 100 degrees Celsius, and then irradiated with the UV light for 20 seconds by using an air-cooling metal halide lamp (manufactured by EYE GRAPHICS Co., Ltd.) with 20 mW/cm² under the air-atmosphere, to fix the alignment state and to form an optically anisotropic layer. In the optically anisotropic layer, the discotic liquid crystal was vertically aligned in the irradiated domain (the first retardation domain) so that the slow axis thereof was parallel to the rubbing direction; and the discotic liquid crystal was vertically aligned in the non-irradiated domain (the second retardation domain) so that the slow axis thereof was orthogonal to the rubbing direction. The thickness of the optically-anisotropic layer was 0.8 micro meters.

### <Formulation of Composition for Optically Anisotropic Layer>

| | | |
|---|---|---|
| Discotic liquid crystal E-1 | 100 | parts by mass |
| Agent for controlling alignment at the alignment layer interface (II-1) | 3.0 | parts by mass |
| Agent for controlling alignment at the air-interface (P-1) | 0.4 | parts by mass |
| Photo-polymerization initiator (Irgacure 907, by Ciba Specialty Chemicals) | 3.0 | parts by mass |
| Sensitizer (Kayacure DETX, by Nippon Kayaku) | 1.0 | part by mass |
| Methyl ethyl ketone | 400 | parts by mass |

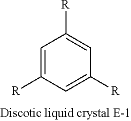

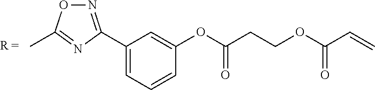

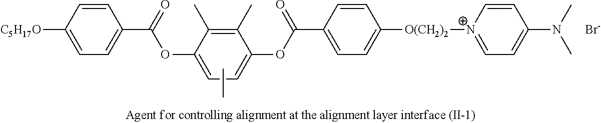

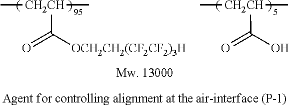

The first and second retardation domains of the obtained optical film were analyzed respectively by using a TOF-SIMS (time-of-flight secondary ion mass spectrometry method, “TOF-SIMS V” manufactured by ION-TOF); and the abundance ratio of the photo-acid-generating agent, S-1, in the alignment layer corresponding to the first retardation domain to the photo-acid-generating agent in the alignment layer corresponding to the second retardation domain was 8/92. This indicated that almost all of the photo-acid-generating agent, S-1, in the first domain was decomposed. Regarding the optically anisotropic layer, the cation of II-1 and the anion BF₄⁻ of the acid HBF₄ generated from the photo-acid-generating agent, S-1, were found at the air-interface of the first retardation domain; and these ions were hardly found at the air-interface of the second retardation domain and the cation of II-1 and Br⁻ were localized in the area neighboring to the alignment layer interface. The abundance ratio of the cation of II-1 in the first retardation domain to the cation in the second retardation domain was 93/7 at the air interface; and the abundance ratio of BF₄⁻ in the first retardation domain to the anion in the second retardation domain was 90/10 at the air interface. This indicated that the agent for controlling the alignment at the alignment-layer interface (II-1) was localized at the alignment layer interface in the second retardation domain, that the localization of the agent was lowered in the first retardation domain and some of the agent were diffused to the air-interface, and that the diffusion of the cation of II-1 was promoted by the anion-exchange between the generating acid HBF₄ and the agent II-1 in the first retardation domain.

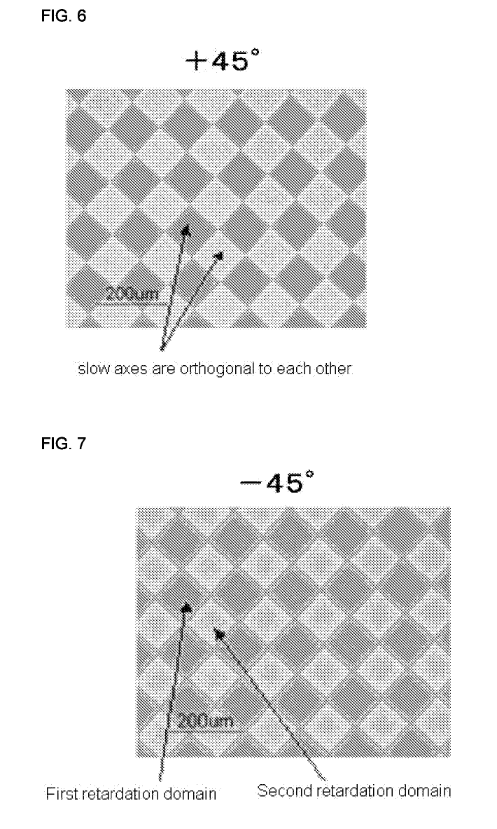

The obtained optical film was disposed between orthogonally-positioned two polarizing plates so that the slow axis of the first or second retardation domain of the optically anisotropic layer was parallel to the polarization axis of any one of the polarizing plates; and a sensitive color plate having retardation of 530 nm was disposed on the optically anisotropic layer so that the angle between the slow axis of the color plate and the polarization axis of the polarizing plate was 45° (as shown in FIG. 5). And the state obtained by the +45° rotation of the optically anisotropic layer (FIG. 6) and the state obtained by the −45° rotation of the optically anisotropic layer (FIG. 7) were observed under a polarizing microscope (“ECLIPE E600 W POL” manufactured by NIKON). From the observations shown in FIGS. 5-7, it is understandable as follows. When being rotated by +45°, the slow axis of the first retardation domain was parallel to the slow axis of the color plate, retardation of the domain was more than 530 nm, and the color of the domain was changed bluish (the dark domain in the monochrome figure); on the other hand, the slow axis of the second retardation domain was orthogonal to the slow axis of the color plate, retardation of the domain was less than 530 nm, and the color of the domain was changed yellowish (the faint domain in the monochrome figure). When being rotated by −45°, the converse phenomenon was found.

### <Evaluation of Optical Film>

Regarding the obtained optical film, the tilt angle of the discotic liquid crystal at the alignment layer interface, the tilt angle of the discotic liquid crystal at the air-interface, Re and Rth were measured respectively according to the above-described methods by using KOBRA-21ADH (by Oji Scientific Instruments). The results are shown in Table 1. In the table, “Verticality” means the tilt angle falling within the range of from 70° to 90°. The direction of the slow axis of the optically anisotropic layer was determined according to the above-described method by using KOBRA-21 ADH (by Oji Scientific Instruments). In Table 1, the relation between the slow axis of the optically anisotropic layer and the rubbing direction was shown.

From the results shown in Table 1, it is understandable that it is possible to form an optically anisotropic patterned layer with the first and second retardation domains formed of the vertical alignment of the discotic liquid crystal of which the slow axes are orthogonal to each other by aligning the discotic liquid crystal in the presence of a pyridinium salt compound and a fluoroaliphatic-group-containing copolymer on the surface of the polyvinyl alcohol-series alignment layer containing a photo-acid-generating compound, subjected to a rubbing treatment along one direction after subjected to an light-irradiation via a mask.

### Example 2

The optical film with an optically anisotropic patterned layer was prepared in the same manner as Example 1, except that the formulation of the coating liquid for the alignment layer was changed to the following formulation. The thickness of the alignment layer was 0.5 micro meters and the thickness of the optically anisotropic layer was 0.8 micro meters.

### <Formulation of Composition for Alignment Layer>

| | | |
|---|---|---|
| Polymer material for alignment layer | 3.9 | parts by mass |
| (polyvinyl alcohol, PVA 103, Kuraray Co., Ltd.) | | |
| Photo-acid-generating agent (I-33) | 0.1 | parts by mass |
| Methanol | 36 | parts by mass |
| Water | 60 | parts by mass |

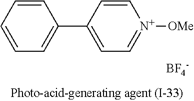

The first and second retardation domains of the obtained optical film were analyzed respectively by using a TOF-SIMS (time-of-flight secondary ion mass spectrometry method, “TOF-SIMS V” manufactured by ION-TOF); and the abundance ratio of the photo-acid-generating agent, I-33, in the alignment layer corresponding to the first retardation domain to the photo-acid-generating agent in the alignment layer corresponding to the second retardation domain was 10/90. This indicated that almost all of the photo-acid-generating agent, I-33, in the first domain was decomposed. Regarding the optically anisotropic layer, the cation of II-1 and the anion BF₄⁻ of the acid HBF₄ generated from the photo-acid-generating agent, I-33, were found at the air-interface of the first retardation domain; and these ions were hardly found at the air-interface of the second retardation domain and the cation of II-1 and Br⁻ were localized in the area neighboring to the alignment layer interface. The abundance ratio of the cation of II-1 in the first retardation domain to the cation in the second retardation domain was 93/7 at the air interface; and the abundance ratio of BF₄⁻ in the first retardation domain to the anion in the second retardation domain was 90/10 at the air interface. This indicated that the agent for controlling the alignment at the alignment-layer interface (II-1) was localized at the alignment layer interface in the second retardation domain, that the localization of the agent was lowered in the first retardation domain and some of the agent were diffused, and that the diffusion of the cation of II-1 was promoted by the anion-exchange between the generating acid HBF₄ and the agent II-1 in the first retardation domain.

### <Evaluation of Optical Film>

Regarding the obtained optical film, the direction of the slow axis of the optically anisotropic layer was determined in the same manner as Example 1. In Table 1, the relation between the slow axis of the optically anisotropic layer and the rubbing direction was shown. From the results shown in Table 1, it is understandable that it is possible to form an optically anisotropic patterned layer with the first and second retardation domains formed of the vertical alignment of the discotic liquid crystal of which the slow axes are orthogonal to each other by aligning the discotic liquid crystal in the presence of a pyridinium salt compound and a fluoroaliphatic-group-containing copolymer on the surface of the polyvinyl alcohol-series alignment layer containing a photo-acid-generating compound, subjected to a rubbing treatment along one direction after subjected to an light-irradiation via a mask.

### Example 3

<Preparation of Transparent Support with Photo-Alignment Layer>

### <<Preparation of Photo-Alignment Layer>>

A composition for a photo-alignment layer having the following formulation was prepared, and filtrated with a filter made of polypropylene having a pore diameter of 0.2 micro meters, to give a coating liquid for a photo-alignment layer. The coating liquid is applied to the surface of a transparent glass plate according to a spin coat manner, and dried at 100 degrees Celsius for a minute, to form a layer. A 100-micrometers square checkered mask was disposed on the layer, and then, irradiated with the UV light for 4 seconds by using an air-cooling metal halide lamp (manufactured by EYE GRAPHICS Co., Ltd.) of which the luminance of the UV-C region was 2.5 mW/cm² under the air-atmosphere at a room temperature, to generate the acidic compound by the decomposition of the photo-acid-generating agent and to form an alignment layer for the first retardation domain. Next, the obtained layer was irradiated with the UV light by using an air-cooling metal halide lamp (manufactured by EYE GRAPHICS Co., Ltd.) with 160 W/cm. The irradiation was carried out through a wire-grid polarizer (“ProFlux PPL02” manufactured by Moxtek) and an UV-C region cut filter. The luminance of the UV light in the UV-A region (the wavelength range of from 380 nm to 320 nm) was 100 mW/cm² and the irradiance level of the UV light in the UV-A region was 1000 mJ/cm².

### <Formulation of Composition for Alignment Layer>

| | | |
|---|---|---|
| Material for a photo-alignment layer | 1.0 | part by mass |
| Photo-acid-generating agent (S-1) | 0.1 | part by mass |
| Methanol | 36 | parts by mass |
| Water | 60 | parts by mass |

E-1 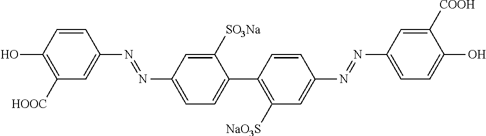
Photo-acid-generating agent (S-1)

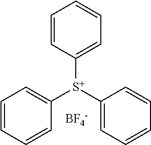

### <Preparation of Optically Anisotropic Patterned Layer>

The composition which was used in Example 1 for preparing the optically anisotropic layer was prepared, and filtrated with a filter made of polypropylene having a pore diameter of 0.2 micro meters, to give a coating liquid for an optically anisotropic layer. The coating liquid was applied to the rubbed surface of the alignment layer, dried at a film-surface temperature of 110 degrees Celsius for 2 minutes to align uniformly and form a liquid crystal state, cooled down to 100 degrees Celsius, and then irradiated with the UV light for 20 seconds by using an air-cooling metal halide lamp (manufactured by EYE GRAPHICS Co., Ltd.) with 20 mW/cm² under the air-atmosphere, to fix the alignment state and to form an optically anisotropic layer. In the optically anisotropic layer, the discotic liquid crystal was vertically aligned in the mask-irradiated domain (the first retardation domain) so that the slow axis thereof was parallel to the UV-A irradiation direction; and the discotic liquid crystal was vertically aligned in the non-mask-irradiated domain (the second retardation domain) so that the slow axis thereof was orthogonal to the UV-A irradiation direction. The thickness of the optically-anisotropic layer was 0.8 micro meters.

The first and second retardation domains of the obtained optical film were analyzed respectively by using a TOF-SIMS (time-of-flight secondary ion mass spectrometry method, “TOF-SIMS V” manufactured by ION-TOF); and the abundance ratio of the photo-acid-generating agent, S-1, in the alignment layer corresponding to the first retardation domain to the photo-acid-generating agent in the alignment layer corresponding to the second retardation domain was 8/92. This indicated that almost all of the photo-acid-generating agent, S-1, in the first domain was decomposed. Regarding the optically anisotropic layer, the cation of II-1 and the anion BF₄⁻ of the acid HBF₄ generated from the photo-acid-generating agent, S-1, were found at the air-interface of the first retardation domain; these ions were hardly found at the air-interface of the second retardation domain and the cation of II-1 and Br⁻ were localized in the area neighboring to the alignment layer interface. The abundance ratio of the cation of II-1 in the first retardation domain to the cation in the second retardation domain was 93/7 at the air interface; and the abundance ratio of BF₄⁻ in the first retardation domain to the anion in the second retardation domain was 90/10 at the air interface. This indicated that the agent for controlling the alignment at the alignment-layer interface (II-1) was localized at the alignment layer interface in the second retardation domain, that the localization of the agent was lowered in the first retardation domain and some of the agent were diffused to the air-interface, and that the diffusion of the cation of II-1 was promoted by the anion-exchange between the generating acid HBF₄ and the agent II-1 in the first retardation domain.

### <Evaluation of Optical Film>

Regarding the obtained optical film, the tilt angle of the discotic liquid crystal at the alignment layer interface, the tilt angle of the discotic liquid crystal at the air-interface, Re and Rth were measured respectively according to the above-described methods by using KOBRA-21ADH (by Oji Scientific Instruments). The results are shown in Table 1. In the table, “Verticality” means the tilt angle falling within the range of from 70° to 90°. The direction of the slow axis of the optically anisotropic layer was determined according to the above-described method by using KOBRA-21 ADH (by Oji Scientific Instruments). In Table 1, the relation between the slow axis of the optically anisotropic layer and the rubbing direction was shown.

From the results shown in Table 1, it is understandable that it is possible to form an optically anisotropic patterned layer with the first and second retardation domains formed of the vertical alignment of the discotic liquid crystal of which the slow axes are orthogonal to each other by aligning the discotic liquid crystal in the presence of a pyridinium salt compound and a fluoroaliphatic-group-containing copolymer on the surface of the photo-alignment layer containing a photo-acid-generating compound, subjected to an irradiation treatment along one direction after subjected to an light-irradiation via a mask.

### Example 4

An optical film with an optically anisotropic patterned layer was prepared in the same manner as Example 1, except that the formulation of the coating liquid for the optically anisotropic layer was changed to the following formulation. the thickness of the optically anisotropic layer was 0.8 micro meters.

### <Formulation of Composition for Optically Anisotropic Layer>

| | | |
|---|---|---|
| Discotic liquid crystal E-2 | 100 | parts by mass |
| Agent for controlling alignment at the alignment layer interface (II-1) | 3.0 | parts by mass |
| Agent for controlling alignment at the air-interface (P-2) | 0.4 | parts by mass |
| Photo-polymerization initiator (Irgacure 907, by Ciba Specialty Chemicals) | 3.0 | parts by mass |
| Sensitizer (Kayacure DETX, by Nippon Kayaku) | 1.0 | part by mass |
| Methyl ethyl ketone | 400 | parts by mass |

Discotic liquid crystal E-2 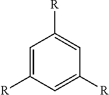 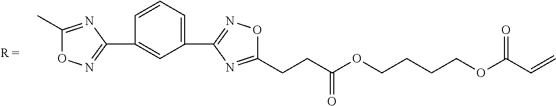 [SMILES: C=CC(=O)OCCCCOC(=O)CCc1nc(-c2cccc(-c3noc(C)n3)c2)no1]
Agent for controlling alignment at the air-interface (P-2)

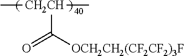

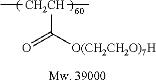

The first and second retardation domains of the obtained optical film were analyzed respectively by using a TOF-SIMS (time-of-flight secondary ion mass spectrometry method, “TOF-SIMS V” manufactured by ION-TOF); and the abundance ratio of the photo-acid-generating agent, S-1, in the alignment layer corresponding to the first retardation domain to the photo-acid-generating agent in the alignment layer corresponding to the second retardation domain was 8/92. This indicated that almost all of the photo-acid-generating agent, S-1, in the first domain was decomposed. Regarding the optically anisotropic layer, the cation of II-1 and the anion BF₄⁻ of the acid HBF₄ generated from the photo-acid-generating agent, S-1, were found at the air-interface of the first retardation domain; and these ions were hardly found at the air-interface of the second retardation domain and the cation of II-1 and Br⁻ were localized in the area neighboring to the alignment layer interface. The abundance ratio of the cation of II-1 in the first retardation domain to the cation in the second retardation domain was 93/7 at the air interface; and the abundance ratio of BF₄⁻ in the first retardation domain to the anion in the second retardation domain was 90/10 at the air interface. This indicated that the agent for controlling the alignment at the alignment-layer interface (II-1) was localized at the alignment layer interface in the second retardation domain, that the localization of the agent was lowered in the first retardation domain and some of the agent were diffused to the air-interface, and that the diffusion of the cation of II-1 was promoted by the anion-exchange between the generating acid H BF₄ and the agent II-1 in the first retardation domain.

### <Evaluation of Optical Film>

Regarding the obtained optical film, the direction of the slow axis of the optically anisotropic layer was determined in the same manner as Example 1. In Table 1, the relation between the slow axis of the optically anisotropic layer and the rubbing direction was shown. From the results shown in Table 1, it is understandable that it is possible to form an optically anisotropic patterned layer with the first and second retardation domains formed of the vertical alignment of the discotic liquid crystal of which the slow axes are orthogonal to each other by aligning the discotic liquid crystal in the presence of a pyridinium salt compound and a fluoroaliphatic-group-containing copolymer on the surface of the polyvinyl alcohol-series alignment layer containing a photo-acid-generating compound, subjected to a rubbing treatment along one direction after subjected to an light-irradiation via a mask.

### Example 5

<Preparation of Transparent Support with Rubbed Alignment Layer>

### (Preparation of Transparent Support)

The following ingredients were put into a tank, stirred under heat, and dissolved to give a cellulose acetate solution A.

### <Formulation of Cellulose Acylate Solution A>

| | | |
|---|---|---|
| Cellulose Acetate (the degree of acetylation: | 100.0 | parts by mass |
| 2.86) | | |
| Triphenyl phosphate (plasticizer) | 7.8 | parts by mass |
| Biphenyl diphenyl phosphate (plasticizer) | 3.9 | parts by mass |
| Methylene chloride (First Solvent) | 300 | parts by mass |
| Methanol (Second Solvent) | 45 | parts by mass |
| 1-Butanol | 11 | parts by mass |

The ingredients shown below were put into another mixing tank, stirred under heating so as to dissolve the individual components, to thereby prepare an additive solution B.

### <Formulation of Additive Solution B>

| | | |
|---|---|---|
| Compound B1 shown below (Agent for lowering Re) | 40 | parts by mass |
| Compound B2 shown below | 4 | parts by mass |
| (Agent for controlling wavelength dispersion) | | |
| Methylene chloride (First Solvent) | 80 | parts by mass |
| Methanol (Second Solvent) | 20 | parts by mass |

Compound B1 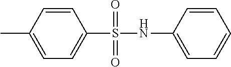 [SMILES: Cc1ccc(S(=O)(=O)Nc2ccccc2)cc1]
Compound B2

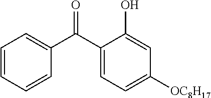

<Preparation of Transparent support, Cellulose Acetate Film>

To 477 parts by mass of the cellulose acetate solution “A”, 40 parts by mass of the additive solution B was added, thoroughly stirred, to thereby prepare a dope. The dope was cast from a cast port onto a drum cooled to 0° C. The obtained film was peeled off while being kept at a solvent content of 70% by mass, held at both width-wise edges thereof with a pin tenter (a pin tenter shown in FIG. 3 of JPA No. H4-1009), and dried while keeping a tenter width so as to keep a factor of stretching of 3% in the transverse direction (direction perpendicular to the mechanical direction), under a state with a solvent content of 3 to 5% by mass. Thereafter, the film was further dried while allowing it to travel between rolls of an annealing apparatus, to thereby produce a cellulose acetate film of 60 micro meters thick. Re(550) and Rth(550) of the film to be used as a transparent support were 2.0 nm and 12.3 nm respectively.

### (Alkali-Saponification Treatment)

The cellulose acylate film obtained in the above was led to pass through a dielectric heating roll at a temperature of 60 degrees Celsius so that the film surface temperature was elevated up to 40 degrees Celsius, and then, using a bar coater, an alkali solution having the composition mentioned below was applied to it in an amount of 14 ml/m²; thereafter this was kept staying below a steam-type far-infrared heater (by Noritake Company) heated at 110 degrees Celsius for 10 seconds, and then also using a bar coater, pure water was applied thereto in an amount of 3 ml/m². In this stage, the film temperature was 40 degrees Celsius. Next, this was washed with water using a fountain coater and treated with an air knife for water removal, repeatedly three times each, and then dried in a drying zone at 70 degrees Celsius for 10 seconds. In this way, a cellulose acylate film to be used as a transparent support was prepared.

Formulation of Alkali Solution for Saponification (parts by mass)

| | | |
|---|---|---|
| Potassium hydroxide | 4.7 | mas. pts. |
| Water | 15.8 | mas. pts. |
| Isopropanol | 63.7 | mas. pts. |
| Surfactant SF-1: C₁₄H₂₉O(CH₂CH₂O)₂₀H | 1.0 | mas. pt. |
| Propylene glycol | 14.8 | mas. pts. |

(Preparation of Transparent Support with Rubbed Alignment Layer)

A coating liquid having the following formulation for an alignment layer was applied to the saponified surface of the obtained support film by using a No. 8 wire bar, and dried with a hot air of 60 degrees Celsius for 60 minutes and with a hot air of 100 degrees Celsius for 120 minutes, to form a layer. A stripe mask of which the width of the transmission stripe was 100 micro meters and the width of the light-blocking stripe was 300 micro meters was prepared. The mask was disposed on the layer, and then, irradiated with the UV light for 4 seconds by using an air-cooling metal halide lamp (manufactured by EYE GRAPHICS Co., Ltd.) of which the luminance of the UV-C region was 2.5 mW/cm² under the air-atmosphere at a room temperature, to generate the acidic compound by the decomposition of the photo-acid-generating agent and to form an alignment layer for the first retardation domain. After that, the alignment layer was subjected to a rubbing treatment along one direction by a stroke at 500 rpm, to provide a transparent support with a rubbed alignment layer. The thickness of the alignment layer was 0.5 micro meters.

### <Formulation of Composition for Alignment Layer>

| | | |
|---|---|---|
| Polymer material for alignment layer | 3.9 | parts by mass |
| (polyvinyl alcohol, PVA 103, Kuraray Co., Ltd.) | | |
| Photo-acid-generating agent (S-2) | 0.1 | parts by mass |
| Methanol | 36 | parts by mass |
| Water | 60 | parts by mass |

Photo-acid-generating agent (S-2)

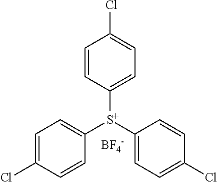

### (Preparation of Optically Anisotropic Patterned Layer)

A composition which was used in Example 1 for preparing the optically anisotropic layer was applied to the rubbed surface of the alignment layer, dried at a film-surface temperature of 110 degrees Celsius for 2 minutes, to align uniformly and form a liquid crystal state, cooled down to 100 degrees Celsius, and then irradiated with the UV light for 20 seconds by using an air-cooling metal halide lamp (manufactured by EYE GRAPHICS Co., Ltd.) with 20 mW/cm² under the air-atmosphere, to fix the alignment state and to form an optically anisotropic layer. In the optically anisotropic layer, the discotic liquid crystal was vertically aligned in the irradiated domain (the first retardation domain) so that the slow axis thereof was parallel to the rubbing direction; and the discotic liquid crystal was vertically aligned in the non-irradiated domain (the second retardation domain) so that the slow axis thereof was orthogonal to the rubbing direction. The thickness of the optically-anisotropic layer was 0.8 micro meters.

The first and second retardation domains of the obtained optical film were analyzed respectively by using a TOF-SIMS (time-of-flight secondary ion mass spectrometry method, “TOF-SIMS V” manufactured by ION-TOF); and the abundance ratio of the photo-acid-generating agent, S-2, in the alignment layer corresponding to the first retardation domain to the photo-acid-generating agent in the alignment layer corresponding to the second retardation domain was 8/92. This indicated that almost all of the photo-acid-generating agent, S-2, in the first domain was decomposed. Regarding the optically anisotropic layer, the cation of II-1 and the anion BF₄⁻ of the acid HBF₄ generated from the photo-acid-generating agent, S-1, were found at the air-interface of the first retardation domain; and these ions were hardly found at the air-interface of the second retardation domain and the cation of II-1 and Br⁻ were localized in the area neighboring to the alignment layer interface. The abundance ratio of the cation of II-1 in the first retardation domain to the cation in the second retardation domain was 93/7 at the air interface; and the abundance ratio of BF₄⁻ in the first retardation domain to the anion in the second retardation domain was 90/10 at the air interface. This indicated that the agent for controlling the alignment at the alignment-layer interface (II-1) was localized at the alignment layer interface in the second retardation domain, that the localization of the agent was lowered in the first retardation domain and some of the agent were diffused to the air-interface, and that the diffusion of the cation of II-1 was promoted by the anion-exchange between the generating acid HBF₄ and the agent II-1 in the first retardation domain.

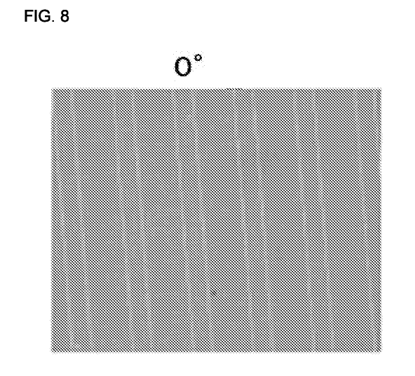

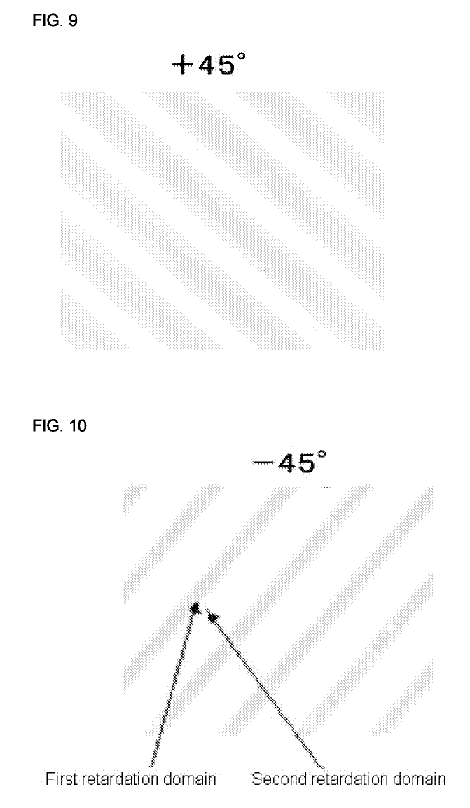

The obtained optical film was disposed between orthogonally-positioned two polarizing plates so that the slow axis of the first or second retardation domain of the optically anisotropic layer was parallel to the polarization axis of any one of the polarizing plates; and a sensitive color plate having retardation of 530 nm was disposed on the optically anisotropic layer so that the angle between the slow axis of the color plate and the polarization axis of the polarizing plate was 45° (as shown in FIG. 8). And the state obtained by the +45° rotation of the optically anisotropic layer (FIG. 9) and the state obtained by the −45° rotation of the optically anisotropic layer (FIG. 10) were observed under a polarizing microscope (“ECLIPE E600 W POL ” manufactured by NIKON). From the observations shown in FIGS. 8-10, it is understandable as follows. When being rotated by +45°, the slow axis of the first retardation domain was parallel to the slow axis of the color plate, retardation of the domain was more than 530 nm, and the color of the domain was changed bluish (the dark domain in the monochrome figure); on the other hand, the slow axis of the second retardation domain was orthogonal to the slow axis of the color plate, retardation of the domain was less than 530 nm, and the color of the domain was changed yellowish (the faint domain in the monochrome figure). When being rotated by −45°, the converse phenomenon was found.

### <Evaluation of Optical Film>

Regarding the obtained optical film, the tilt angle of the discotic liquid crystal at the alignment layer interface, the tilt angle of the discotic liquid crystal at the air-interface, Re and Rth were measured respectively according to the above-described methods by using KOBRA-21ADH (by Oji Scientific Instruments). The results are shown in Table 1. In the table, “Verticality” means the tilt angle falling within the range of from 70° to 90°. The direction of the slow axis of the optically anisotropic layer was determined according to the above-described method by using KOBRA-21 ADH (by Oji Scientific Instruments). In Table 1, the relation between the slow axis of the optically anisotropic layer and the rubbing direction was shown.

From the results shown in Table 1, it is understandable that it is possible to form an optically anisotropic patterned layer with the first and second retardation domains formed of the vertical alignment of the discotic liquid crystal of which the slow axes are orthogonal to each other by aligning the discotic liquid crystal in the presence of a pyridinium salt compound and a fluoroaliphatic-group-containing copolymer on the surface of the polyvinyl alcohol-series alignment layer containing a photo-acid-generating compound, subjected to a rubbing treatment along one direction after subjected to an light-irradiation via a mask.

### Example 6

### <Preparation of Optical Film>

An optical film with an optically anisotropic patterned layer was prepared in the same manner of Example 5, except that a transverse-stripe mask having the pitch of 282 micro meters was used.

### <Preparation of Antireflection Film>

### (Preparation of Coating Liquid for Hard Coat Layer)

To 900 parts by mass of MEK, 100 parts by mass of cyclohexanone, 750 parts by mass of a polyfunctional acrylate partially modified with caprolactone (DPCA-20, manufactured by Nippon Kayaku Co., Ltd.), 200 parts by mass of silica sol (MIBK-ST manufactured by Nippon Kayaku Co., Ltd.), and 50 parts by mass of a photopolymerization initiator (IRGACURE 184, manufactured by Ciba Specialty Chemicals) were added and stirred. The mixture was filtered through a poly-propylene-made filter having a pore size of 0.4 micro meters, thereby preparing a coating liquid for hard coat layer.

### (Preparation of Coating Liquid A for Medium Refractive-Index Layer)

To 5.1 parts by mass of a hard coating agent containing ZrO₂ fine particles {DeSolite Z7404 produced by JSR Corp. <<refractive index: 1.72, solids concentration: 60 mass %, particulate zirconium oxide content: 70 mass % (with respect to the solids content), average size of particulate zirconium oxide: around 20 nm, solvent composition: MIBK/MEK=9/1>>}, 1.5 parts by mass of a mixture of dipentaerythritol pentaacrylate and dipentaerythritol hexaacrylate mixture (DPHA), 0.05 parts by mass of a photopolymerization initiator (Irgacure 907, produced by Ciba Specialty Chemicals), 66.6 parts by mass of methyl ethyl ketone, 7.7 parts by mass of methyl isobutyl ketone and 19.1 parts by mass of cyclohexanone were added, and these ingredients were thoroughly stirred. Then the mixture obtained was passed through a polypropylene filter having a pore size of 0.4 micro meters. Thus, a coating liquid A for a medium refractive-index layer was prepared.

### (Preparation of Coating Liquid B for Medium Refractive-Index Layer)

4.5 parts by mass of a mixture of dipentaerythritol pentaacrylate and dipentaerythritol hexaacrylate mixture (DPHA), 0.14 parts by mass of a photopolymerization initiator (Irgacure 907, produced by Ciba Specialty Chemicals), 66.5 parts by mass of methyl ethyl ketone, 9.5 parts by mass of methyl isobutyl ketone and 19.0 parts by mass of cyclohexanone were mixed, and these ingredients were thoroughly stirred. Then the mixture obtained was passed through a polypropylene filter having a pore size of 0.4 micro meters. Thus, a coating liquid B for a medium refractive-index layer was prepared.

The coating liquids A and B were mixed to give a coating liquid for a medium refractive layer so that the refractive index was 1.36 and the thickness of the layer was 90 micro meters.

### (Preparation of Coating Liquid for High Refractive-Index Layer)

To 14.4 parts by mass of a hard coating agent containing ZrO₂ fine particles {DeSolite Z7404 produced by JSR Corp. <<refractive index: 1.72, solids concentration: 60 mass %, particulate zirconium oxide content: 70 mass % (with respect to the solids content), average size of particulate zirconium oxide: around 20 nm, solvent composition: MIBK/MEK=9/1>>}, 0.75 parts by mass of a mixture of dipentaerythritol pentaacrylate and dipentaerythritol hexaacrylate mixture (DPHA), 62.0 parts by mass of methyl ethyl ketone, 7.7 parts by mass of methyl isobutyl ketone and 1.1 parts by mass of cyclohexanone were added, and these ingredients were thoroughly stirred. Then the mixture obtained was passed through a polypropylene filter having a pore size of 0.4 micro meters. Thus, a coating liquid C for a high refractive-index layer was prepared.

### (Preparation of Coating Liquid for Low Refractive-Index Layer)

### (Synthesis of Perfluoroolefin Copolymer (1))

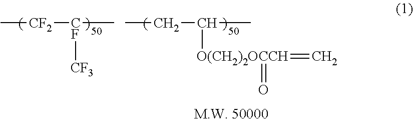

In the formula, the value of 50/50 is a molar ratio.

40 ml of ethyl acetate, 14.7 g of hydroxyethylvinylether, and 0.55 g of dilauroyl peroxide were placed in an autoclave with a stainless stirrer having a capacity of 100 ml, and the system was evacuated so that the gas phase was replaced with nitrogen gas. Further, 25 g of hexafluoropropylene (HFP) was introduced into the autoclave, followed by heating to 65 degrees Celsius. The autoclave had a pressure of 0.53 MPa (5.4 kg/cm.sup.2) when a temperature thereof reached 65 degrees Celsius. A reaction was allowed to continue for 8 hours while keeping the temperature, and when the pressure reached 0.31 MPa (3.2 kg/cm.sup.2), the heating was stopped and the mixture was allowed to stand for cooling. When the internal temperature decreased to room temperature, unreacted monomers were removed, and the autoclave was opened to remove a reaction liquid. The obtained reaction liquid was introduced to a large excess of hexane, and the solvent was removed by decantation to recover a precipitated polymer. The polymer was dissolved in a small amount of ethyl acetate, followed by reprecipitation twice to entirely remove residual monomers from hexane. After drying, 28 g of polymer was obtained. Then, the 20 g of polymer was dissolved in 100 ml of N,N-dimethylacetamide, 11.4 g of acrylic acid chloride was dropped thereto while cooling with ice, and the resultant mixture was stirred at room temperature for 10 hours. Ethyl acetate was added to the reaction liquid, followed by water washing. An organic layer was extracted and condensed. The obtained polymer was reprecipitated in hexane to obtain 19 g of perfluoroolefin copolymer (1). The obtained polymer had a refractive index of 1.422 and a weight-averaged molecular weight of 50000.

### (Preparation of Hollow Silica Microparticle Dispersing Liquid A)

To 500 parts by mass of a hollow particulate silica sol (isopropyl alcohol silica sol, CS60-IPA, produced by CATALYSTS & CHEMICALS IND. CO., LTD.; average particle diameter: 60 nm; shell thickness: 10 nm; silica concentration: 20%; refractive index of particulate silica: 1.31) were added 30 parts by mass of acryloyloxy propyl trimethoxysilane and 1.5 parts by mass of diisopropoxy aluminum ethyl acetoacetate. The mixture was then stirred. To the mixture were then added 9 parts by mass of deionized water. The reaction mixture was allowed to undergo reaction at 60 degrees Celsius for 8 hours, and then allowed to cool to room temperature. Thereafter, for the purpose of rendering the silica content almost uniform, the dispersion liquid was subjected to solvent displacement by reduced-pressure distillation under pressure of 30 Torr as cyclohexanone was added thereto. Finally, a dispersion liquid A having a solids concentration of 18.2% was obtained though concentration adjustment. The amount of IPA remaining in the dispersion liquid obtained was found to be 0.5% or below by gas chromatographic analysis.

### (Preparation of Coating Liquid for Low-Refractive Layer)

The following ingredients were mixed, and dissolved in methyl ethyl ketone to give a coating liquid Ln6 for a low refractive layer having the solid content of 5% by mass. The % by mass of each ingredient is a ration of the solid ingredient with respect to the total solid content of the coating liquid.

| | | |
|---|---|---|
| P-1: Perfluoroolefin Copolymer (1) | 15% | by mass |
| DPHA: Mixture of dipentaerythritol pentaacrylate and | 7% | by mass |
| dipentaerythritol hexaacrylate mixture (manufacture by | | |
| Nippon Kayaku) | | |
| MF1: Fluorine-saturated compound shown below | 5% | by mass |
| which is described in WO2003/022906, Examples | | |
| (weight-averaged molecular weight 1600) | | |
| 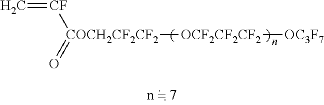 | | |
| M-1: KAYARAD DPHA manufactured by Nippon Kayaku | 20% | by mass |
| Dispersing liquid A: The hollow silica microparticle | 50% | by mass |
| dispersing liquid A) (hollow silica microparticles sol | | |
| surface-modified with acryloyloxy propyl trimethoxysilan, | | |
| the solid content concentration 18.2%) | | |
| Irg 127: Photo-polymerization initiator IRGACURE 127, | 3% | by mass |
| manufactured by Ciba Specialty Chemicals) | | |

The coating liquid fro a hard coat layer having the above-described formulation was applied to the surface of the optical film by using a gravure-coater. After drying at 100 degrees Celsius, the coating liquid was cured under illuminance of 400 mW/cm² through irradiation with UV emitted from a 160 W/cm air-cooled metal halide lamp (made by Eye Graphics Co., Ltd.) in an exposure amount of 240 mJ/cm² while purging the air by nitrogen until the oxygen concentration in the air was reduced to 1.0 vol % or below. In this way, a hard coat layer A having an average thickness of 12 nm was formed.

Furthermore, each of the coating liquid for a medium refractive layer, the coating liquid for a high refractive layer and the coating liquid for a low refractive was applied by using a gravure-coater.

Regarding the medium refractive layer, the drying was carried out for 30 seconds at 90 degrees Celsius. While purging the air by nitrogen until the oxygen concentration in the air was reduced to 1.0 vol % or below, the coating liquid was cured under illuminance of 300 mW/cm² through irradiation with UV emitted from a 180 W/cm air-cooled metal halide lamp (made by Eye Graphics Co., Ltd.) in an exposure amount of 240 mJ/cm².

Regarding the high refractive layer, the drying was carried out for 30 seconds at 90 degrees Celsius. While purging the air by nitrogen until the oxygen concentration in the air was reduced to 1.0 vol % or below, the coating liquid was cured under illuminance of 300 mW/cm² through irradiation with UV emitted from a 240 W/cm air-cooled metal halide lamp (made by Eye Graphics Co., Ltd.) in an exposure amount of 240 mJ/cm².

Regarding the low refractive layer, the drying was carried out for 30 seconds at 90 degrees Celsius. While purging the air by nitrogen until the oxygen concentration in the air was reduced to 1.0 vol % or below, the coating liquid was cured under illuminance of 240 mW/cm² through irradiation with UV emitted from a 600 W/cm air-cooled metal halide lamp (made by Eye Graphics Co., Ltd.) in an exposure amount of 600 mJ/cm².

### <Preparation of Polarizing Plate>

A pressure-sensitive adhesive coating liquid having the following formulation and a coating liquid B for an upper layer having the following formulation were applied to the surface of the obtained film by an amount of 20 ml/m² respectively, and dried at 100 degrees Celsius for 5 minutes, to give a film sample with a pressure-sensitive adhesive layer.

### (Pressure-Sensitive Adhesive Coating Liquid)

| | | |
|---|---|---|
| Water-soluble polymer (m) shown below | 0.5 | g |
| Acetone | 40 | ml |
| Ethyl acetate | 55 | ml |
| Isopropanol | 5 | ml |

### (Coating Liquid B for Upper Layer)

| | | |
|---|---|---|
| Polyvinyl alcohol (GOHSENOL NH-26 | 0.3 | g |
| manufactured by NIPPON GOHSEI) | | |
| Saponin (Surfactant manufactured by Merck) | 0.03 | g |
| Pure water | 57 | ml |
| Methanol | 40 | ml |
| Methyl propylene glycol | 3 | ml |

Water-soluble polymer (m)

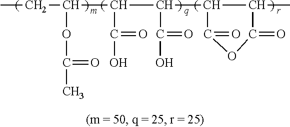

Next, a polarizing film having a thickness of 30 micro meters was prepared by stretching a polyvinyl alcohol film in an aqueous solution of iodine at a quintuple ratio continuously, and then drying it. The obtained film with the pressure-sensitive adhesive layer was bonded to one surface of the polarizing film so that the pressure-sensitive adhesive layer contacted with the polarizing film; and a commercially-available cellulose acetate film (FUJI TAC TD80UF manufactured by FUJIFILM; RE(550)=3 nm; |Rth(630)=50 nm), on the surface of which a pressure-sensitive adhesive layer was formed after being subjected to an alkali-saponification treatment, was bonded to another surface of the polarizing film. In this way, a polarizing plate was prepared.

### (Evaluation of Polarizing Plate Mounted in Liquid Crystal Display Device)

The patterned-retardation plate and the front polarizing plate were removed from a 3D monitor (manufactured by ZALMAN), and the obtained polarizing plate was mounted in the monitor in place of them.

The stereoscopic images were displayed on the 3D monitor and were observed through circularly-polarized light-glasses, and as a result, the clean images without any crosstalk were viewable.

### Example 7

### <Preparation of Optical Film>

An optical film was prepared in the same manner as Example 6, except that a cellulose acylate solution without additives B1 (Agent for lowering Re) and B2 (Agent for controlling wavelength dispersion) was used in preparation of a cellulose acetate film to be used as a transparent support. The thickness of the cellulose acetate film was 200 micro meters, and Re and Rth of the film were 15 nm and 102 nm respectively.

### (Evaluation of Liquid Crystal Display Device Having Polarizing Plate)

A polarizing plate was prepared in the same manner as Example 6. The patterned-retardation plate and the front polarizing plate were removed from a 3D monitor (manufactured by ZALMAN), and the obtained polarizing plate was incorporated into the monitor in place of them.

The stereoscopic images were displayed on the 3D monitor and were observed through circularly-polarized light-glasses, and as a result, the images were viewable as 3D images but a little crosstalk was also recognizable.

### Example 8

An optical film with an optically anisotropic patterned layer was prepared in the same manner as Example 1, except that a coating liquid having the following formulation was used in preparation of the optically anisotropic layer. The thickness of the optically anisotropic layer was 0.8 micro meters.

### <Formulation of Composition for Optically Anisotropic Layer>

| | | |
|---|---|---|
| Discotic liquid crystal E-3 | 100 | parts by mass |
| Agent for controlling alignment at the alignment | 3.0 | parts by mass |
| layer interface (II-1) | | |
| Agent for controlling alignment at the air-interface (P-1) | 0.4 | parts by mass |
| Photo-polymerization initiator | 3.0 | parts by mass |
| (Irgacure 907, by Ciba Specialty Chemicals) | | |
| Sensitizer (Kayacure DETX, by Nippon Kayaku) | 1.0 | part by mass |
| Ethylene oxide modified trimethylol propane triacrylate | 9.9 | parts by mass |
| (V#360, manufactured by OSAKA ORGANIC | | |
| CHEMICAL INDUSTRY LTD.) | | |
| Methyl ethyl ketone | 300 | parts by mass |

Discotic liquid crystal E-3

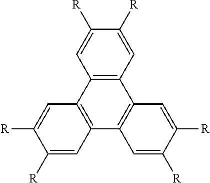

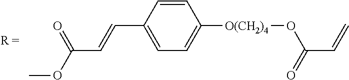

The first and second retardation domains of the obtained optical film were analyzed respectively by using a TOF-SIMS (time-of-flight secondary ion mass spectrometry method, “TOF-SIMS V” manufactured by ION-TOF); and the abundance ratio of the photo-acid-generating agent, S-1, in the alignment layer corresponding to the first retardation domain to the photo-acid-generating agent in the alignment layer corresponding to the second retardation domain was 8/92. This indicated that almost all of the photo-acid-generating agent, S-1, in the first domain was decomposed. Regarding the optically anisotropic layer, the cation of II-1 and the anion BF₄⁻ of the acid HBF₄ generated from the photo-acid-generating agent, S-1, were found at the air-interface of the first retardation domain; and these ions were hardly found at the air-interface of the second retardation domain and the cation of II-1 and Br⁻ were localized in the area neighboring to the alignment layer interface. The abundance ratio of the cation of II-1 in the first retardation domain to the cation in the second retardation domain was 93/7 at the air interface; and the abundance ratio of BF₄⁻ in the first retardation domain to the anion in the second retardation domain was 90/10 at the air interface. This indicated that the agent for controlling the alignment at the alignment-layer interface (II-1) was localized at the alignment layer interface in the second retardation domain, that the localization of the agent was lowered in the first retardation domain and some of the agent were diffused to the air-interface, and that the diffusion of the cation of II-1 was promoted by the anion-exchange between the generating acid HBE₄ and the agent II-1 in the first retardation domain.

### <Evaluation of Optical Film>

Regarding the obtained optical film, the direction of the slow axis of the optically anisotropic layer was determined in the same manner as Example 1. In Table 1, the relation between the slow axis of the optically anisotropic layer and the rubbing direction was shown. From the results shown in Table 1, it is understandable that it is possible to form an optically anisotropic patterned layer with the first and second retardation domains formed of the vertical alignment of the discotic liquid crystal of which the slow axes are orthogonal to each other by aligning the discotic liquid crystal in the presence of a pyridinium salt compound and a fluoroaliphatic-group-containing copolymer on the surface of the polyvinyl alcohol-series alignment layer containing a photo-acid-generating compound, subjected to a rubbing treatment along one direction after subjected to an light-irradiation via a mask.

### Example 9

An optical film with an optically anisotropic patterned layer was prepared in the same manner as Example 1, except that a coating liquid having the following formulation was used in preparation of the optically anisotropic layer. The thickness of the optically anisotropic layer was 0.8 micro meters.

### <Formulation of Composition for Optically Anisotropic Layer>

| | | |
|---|---|---|
| Discotic liquid crystal E-1 | 100 | parts by mass |
| Agent for controlling alignment at the alignment layer interface (II-2) | 3.0 | parts by mass |
| Agent for controlling alignment at the air-interface (P-1) | 0.4 | parts by mass |
| Photo-polymerization initiator (Irgacure 907, by Ciba Specialty Chemicals) | 3.0 | parts by mass |
| Sensitizer (Kayacure DETX, by Nippon Kayaku) | 1.0 | part by mass |
| Methyl ethyl ketone | 400 | parts by mass |

Agent for controlling alignment at the alignment layer interface (II-2)

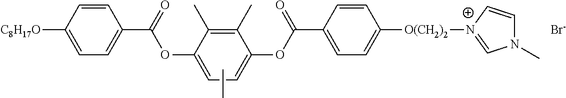

The first and second retardation domains of the obtained optical film were analyzed respectively by using a TOF-SIMS (time-of-flight secondary ion mass spectrometry method, “TOF-SIMS V” manufactured by ION-TOF); and the abundance ratio of the photo-acid-generating agent, S-1, in the alignment layer corresponding to the first retardation domain to the photo-acid-generating agent in the alignment layer corresponding to the second retardation domain was 8/92. This indicated that almost all of the photo-acid-generating agent, S-1, in the first domain was decomposed. Regarding the optically anisotropic layer, the cation of II-2 and the anion BF₄⁻ of the acid HBF₄ generated from the photo-acid-generating agent, S-1, were found at the air-interface of the first retardation domain; and these ions were hardly found at the air-interface of the second retardation domain and the cation of II-2 and Br⁻ were localized in the area neighboring to the alignment layer interface. The abundance ratio of the cation of II-2 in the first retardation domain to the cation in the second retardation domain was 93/7 at the air interface; and the abundance ratio of BF₄⁻ in the first retardation domain to the anion in the second retardation domain was 90/10 at the air interface. This indicated that the agent for controlling the alignment at the alignment-layer interface (II-2) was localized at the alignment layer interface in the second retardation domain, that the localization of the agent was lowered in the first retardation domain and some of the agent were diffused to the air-interface, and that the diffusion of the cation of II-2 was promoted by the anion-exchange between the generating acid HBF₄ and the agent II-2 in the first retardation domain.

### <Evaluation of Optical Film>

Regarding the obtained optical film, the direction of the slow axis of the optically anisotropic layer was determined in the same manner as Example 1. In Table 1, the relation between the slow axis of the optically anisotropic layer and the rubbing direction was shown. From the results shown in Table 1, it is understandable that it is possible to form an optically anisotropic patterned layer with the first and second retardation domains formed of the vertical alignment of the discotic liquid crystal of which the slow axes are orthogonal to each other by aligning the discotic liquid crystal in the presence of a imidazolium salt compound and a fluoroaliphatic-group-containing copolymer on the surface of the polyvinyl alcohol-series alignment layer containing a photo-acid-generating compound, subjected to a rubbing treatment along one direction after subjected to an light-irradiation via a mask.

### Example 10

<Preparation of Transparent Support with Rubbed Alignment Layer>

A transparent support with a rubbed alignment layer was prepared in the same manner as Example 1, except that the composition for an alignment layer having the following formulation was used in preparation of the alignment layer. The thickness of the alignment layer was 0.5 micro meters.

### <Formulation of Composition for Alignment Layer>

| | | |
|---|---|---|
| Polymer material for alignment layer | 3.9 | parts by mass |
| (polyvinyl alcohol, PVA 103, Kuraray Co., Ltd.) | | |
| Photo-acid-generating agent (S-3) | 0.1 | parts by mass |
| Methanol | 36 | parts by mass |
| Water | 60 | parts by mass |

Photo-acid-generating agent (S-3)

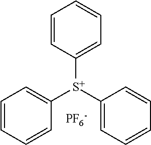

### <Preparation of Optically Anisotropic Patterned Layer>

A composition having the following formulation was prepared, and filtrated with a filter made of polypropylene having a pore diameter of 0.2 micro meters, to give a coating liquid for an optically anisotropic layer. The coating liquid was applied to the rubbed surface of the alignment layer, dried at a film-surface temperature of 135 degrees Celsius for 1 minute to form a isotropic phase, cooled down to 80 degrees Celsius to align uniformly, and then irradiated with the UV light for 20 seconds by using an air-cooling metal halide lamp (manufactured by EYE GRAPHICS Co., Ltd.) with 20 mW/cm² under the air-atmosphere, to fix the alignment state and to form an optically anisotropic layer. The thickness of the optically anisotropic layer was 0.8 micro meters.

### <Formulation of Composition for Optically Anisotropic Layer>

| | | |
|---|---|---|
| Discotic liquid crystal E-2 | 100 | parts by mass |
| Agent for controlling alignment at the alignment | 1.0 | part by mass |
| layer interface (II-1) | | |
| Agent for controlling alignment at the air- | 0.4 | parts by mass |
| interface (P-1) | | |
| Photo-polymerization initiator | 3.0 | parts by mass |
| (Irgacure 907, by Ciba Specialty Chemicals) | | |
| Sensitizer (Kayacure DETX, by Nippon Kayaku) | 1.0 | part by mass |
| Methyl ethyl ketone | 400 | parts by mass |

The first and second retardation domains of the obtained optical film were analyzed respectively by using a TOF-SIMS (time-of-flight secondary ion mass spectrometry method, “TOF-SIMS V” manufactured by ION-TOF); and the abundance ratio of the photo-acid-generating agent, S-3, in the alignment layer corresponding to the first retardation domain to the photo-acid-generating agent in the alignment layer corresponding to the second retardation domain was 5/95. This indicated that almost all of the photo-acid-generating agent, S-3, in the first domain was decomposed. Regarding the optically anisotropic layer, the cation of II-1 and the anion PF₆⁻ of the acid HPF₆ generated from the photo-acid-generating agent, S-3, were found at the air-interface of the first retardation domain; and these ions were hardly found at the air-interface of the second retardation domain and the cation of II-1 and Br were localized in the area neighboring to the alignment layer interface. The abundance ratio of the cation of II-1 in the first retardation domain to the cation in the second retardation domain was 95/5 at the air interface; and the abundance ratio of PF₆⁻ in the first retardation domain to the anion in the second retardation domain was 95/5 at the air interface. This indicated that the agent for controlling the alignment at the alignment-layer interface (II-1) was localized at the alignment layer interface in the second retardation domain, that the localization of the agent was lowered in the first retardation domain and some of the agent were diffused to the air-interface, and that the diffusion of the cation of II-1 was promoted by the anion-exchange between the generating acid HPF₆ and the agent II-1 in the first retardation domain.

### <Evaluation of Optical Film>

Regarding the obtained optical film, the direction of the slow axis of the optically anisotropic layer was determined in the same manner as Example 1. In Table 1, the relation between the slow axis of the optically anisotropic layer and the rubbing direction was shown. From the results shown in Table 1, it is understandable that it is possible to form an optically anisotropic patterned layer with the first and second retardation domains formed of the vertical alignment of the discotic liquid crystal of which the slow axes are orthogonal to each other by aligning the discotic liquid crystal in the presence of a pyridinium salt compound and a fluoroaliphatic-group-containing copolymer on the surface of the polyvinyl alcohol-series alignment layer containing a photo-acid-generating compound, subjected to a rubbing treatment along one direction after subjected to an light-irradiation via a mask.

According to Example 10, although the discotic liquid crystal was aligned vertically in the second retardation domain, the discotic liquid crystal was hybrid-aligned in the first retardation domain. This is because the composition was heated once to the temperature (135 degrees Celsius) at which it formed the isotropic phase. Therefore, it can be understandable that the localization of the pyridinium compound at the alignment layer interface might be lowered in both of the irradiated and non-irradiated domains, the discotic liquid crystal in the non-irradiated domain was aligned vertically but along the rubbing direction, and the discotic liquid crystal in the irradiated domain was aligned in a hybrid alignment state because of the additionally lowered localization.

### Comparative Example 1

### <Preparation of Optical Film>

An optical film was prepared in the same manner as Example 1, except that a composition without the photo-acid-generating agent (S-1) was used in preparation of the alignment layer. The thickness of the alignment layer was 0.5 micro meters; and the thickness of the optically anisotropic layer was 0.8 micro meters.

### <Evaluation of Optical Film>

Regarding the obtained optical film, the tilt angle of the discotic liquid crystal at the alignment layer interface, the tilt angle of the discotic liquid crystal at the air-interface, Re and Rth were measured respectively according to the above-described methods by using KOBRA-21ADH (by Oji Scientific Instruments). The results are shown in Table 1. In the table, “Verticality” means the tilt angle falling within the range of from 70° to 90°. The direction of the slow axis of the optically anisotropic layer was determined according to the above-described method by using KOBRA-21 ADH (by Oji Scientific Instruments). In Table 1, the relation between the slow axis of the optically anisotropic layer and the rubbing direction was shown.

From the results shown in Table 1, it is understandable that the discotic liquid crystal was aligned in a hybrid alignment state but only the optically-anisotropic un-patterned layer having a slow axis orthogonal to the rubbing direction was obtained.

### Comparative Example 2

### <Preparation of Optical Film>

An optical film was prepared in the same manner as Example 10, except that a composition without the photo-acid-generating agent (S-3) was used in preparation of the alignment layer. The thickness of the alignment layer was 0.5 micro meters; and the thickness of the optically anisotropic layer was 0.8 micro meters.

### <Evaluation of Optical Film>

Regarding the obtained optical film, the tilt angle of the discotic liquid crystal at the alignment layer interface, the tilt angle of the discotic liquid crystal at the air-interface, Re and Rth were measured respectively according to the above-described methods by using KOBRA-21ADH (by Oji Scientific Instruments). The results are shown in Table 1. In the table, “Verticality” means the tilt angle falling within the range of from 70° to 90°. The direction of the slow axis of the optically anisotropic layer was determined according to the above-described method by using KOBRA-21 ADH (by Oji Scientific Instruments). In Table 1, the relation between the slow axis of the optically anisotropic layer and the rubbing direction was shown.

From the results shown in Table 1, it is understandable that the discotic liquid crystal was aligned in a hybrid alignment state but only the optically-anisotropic un-patterned layer having a slow axis parallel to the rubbing direction was obtained.

### Comparative Example 3

### (Evaluation of Polarizing Plate Mounted in Liquid Crystal Display Device)

A 3D monitor was prepared in the same manner as Example 6, except that the optical film prepared in Comparative Example 1 was used.

The stereoscopic images were displayed on the 3D monitor and were observed through circularly-polarized light-glasses, and as a result, the images were not viewable as 3D images due to the large crosstalk.

### Comparative Example 4

### (Evaluation of Polarizing Plate Mounted in Liquid Crystal Display Device)

A 3D monitor was prepared in the same manner as Example 6, except that the optical film prepared in Comparative Example 2 was used.

The stereoscopic images were displayed on the 3D monitor and were observed through circularly-polarized light-glasses, and as a result, the images were not viewable as 3D images due to the large crosstalk.

TABLE 1

| | | | | Alignment | | Air-Interface | | | | | | | |
|---|---|---|---|---|---|---|---|---|---|---|---|---|---|
| | | | | layer Side | | Side | | | | | | | |
| | | | | Alignment Agent | | Alignment Agent | | | | Tilt Angle | | Optical | |
| | | | Photo-Acid- | | Amount | | Amount | | | Alignment | Air- | Properties | |
| | Liquid | Alignment | Generating | | (% by | | (% by | Light- | Direction of | Layer | Interface | Re | Rth |
| | Crystal | Layer | Agent | Material | mass) | Material | mass) | Irradiation | Slow Axis | Side | Side | (nm) | (nm) |
| Example 1 | E-1 | PVA103 | S-1 | II-1 | 3.0 | P-1 | 0.4 | No | Orthogonal | Verticality | Verticality | 130 | −35 |
| | | | | | | | | Yes | Parallel | Verticality | Verticality | 130 | −35 |
| Example 2 | E-1 | PVA103 | I-33 | II-1 | 3.0 | P-1 | 0.4 | No | Orthogonal | Verticality | Verticality | 130 | −35 |
| | | | | | | | | Yes | Parallel | Verticality | Verticality | 130 | −35 |
| Example 3 | E-1 | E-1 | S-1 | II-1 | 3.0 | P-1 | 0.4 | No | Orthogonal | Verticality | Verticality | 130 | −35 |
| | | | | | | | | Yes | Parallel | Verticality | Verticality | 130 | −35 |
| Example 4 | E-2 | PVA103 | S-1 | II-1 | 3.0 | P-2 | 0.4 | No | Orthogonal | Verticality | Verticality | 140 | −38 |
| | | | | | | | | Yes | Parallel | Verticality | Verticality | 140 | −38 |
| Example 5 | E-1 | PVA103 | S-2 | II-1 | 3.0 | P-1 | 0.4 | No | Orthogonal | Verticality | Verticality | 127 | −19 |
| | | | | | | | | Yes | Parallel | Verticality | Verticality | 127 | −19 |
| Example 8 | E-3 | PVA103 | S-1 | II-1 | 3.0 | P-1 | 0.4 | No | Orthogonal | Verticality | Verticality | 140 | −38 |
| | | | | | | | | Yes | Parallel | Verticality | Verticality | 140 | −38 |
| Example 9 | E-1 | PVA103 | S-1 | II-2 | 3.0 | P-1 | 0.4 | No | Orthogonal | Verticality | Verticality | 130 | −35 |
| | | | | | | | | Yes | Parallel | Verticality | Verticality | 130 | −35 |
| Exam- | E-1 | PVA103 | S-3 | II-1 | 3.0 | P-1 | 0.4 | No | Parallel | Verticality | Verticality | 130 | −35 |
| ple 10 | | | | | | | | Yes | Orthogonal | 1° | 85° | 74 | 53 |
| Com- | E-1 | PVA103 | — | II-1 | 3.0 | P-1 | 0.4 | No | Orthogonal | Verticality | Verticality | 130 | −35 |
| parative | | | | | | | | Yes | Orthogonal | Verticality | Verticality | 130 | −35 |
| Example 1 | | | | | | | | | | | | | |
| Com- | E-1 | PVA103 | — | II-1 | 3.0 | P-1 | 0.4 | No | Parallel | Verticality | Verticality | 130 | −35 |
| parative | | | | | | | | Yes | Parallel | Verticality | Verticality | 130 | −35 |
| Example 2 | | | | | | | | | | | | | |

### Example 11

An optical film with an optically anisotropic patterned layer was prepared in the same manner as Example 1, except that a coating liquid having the following formulation was used in preparation of the optically anisotropic layer. The thickness of the optically anisotropic layer was 0.8 micro meters.

### <Formulation of Composition for Optically Anisotropic Layer>

| | | |
|---|---|---|
| Discotic liquid crystal E-4 | 100 | parts by mass |
| Agent for controlling alignment at the alignment | 3.0 | parts by mass |
| layer interface (II-1) | | |
| Agent for controlling alignment at the air-interface (P-1) | 0.3 | parts by mass |
| Photo-polymerization initiator | 3.0 | parts by mass |
| (Irgacure 907, by Ciba Specialty Chemicals) | | |
| Sensitizer (Kayacure DETX, by Nippon Kayaku) | 1.0 | part by mass |
| Ethylene oxide modified trimethylol propane triacrylate | 9.9 | parts by mass |
| (V#360, manufactured by OSAKA ORGANIC | | |
| CHEMICAL INDUSTRY LTD.) | | |
| Methyl ethyl ketone | 300 | parts by mass |

Discotic liquid crystal E-4

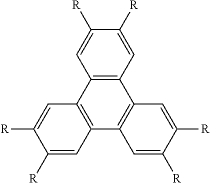

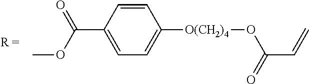

### <Evaluation of Optical Film>

Regarding the obtained optical film, the direction of the slow axis of the optically anisotropic layer was determined in the same manner as Example 1. Discotic liquid crystal E-4, a triphenylene-series discotic liquid crystal having no bonding of “—C═C—” in the group connecting the side chains to the discotic-core, didn't become the orthogonal alignment state easily, and the obtained optical film was inferior to the optical films of the examples in terms of the pattern-forming.

### Example 12

An optical film with an optically anisotropic patterned layer was prepared in the same manner as Example 1, except that a coating liquid having the following formulation was used in preparation of the optically anisotropic layer. The thickness of the optically anisotropic layer was 0.8 micro meters.

### <Formulation of Composition for Optically Anisotropic Layer>

| | | |
|---|---|---|
| Discotic liquid crystal E-1 | 100 | parts by mass |
| Agent for controlling alignment at the alignment | 3.0 | parts by mass |
| layer interface (II-3) | | |
| Agent for controlling alignment at the air-interface (P-1) | 0.4 | parts by mass |
| Photo-polymerization initiator | 3.0 | parts by mass |
| (Irgacure 907, by Ciba Specialty Chemicals) | | |
| Sensitizer (Kayacure DETX, by Nippon Kayaku) | 1.0 | part by mass |
| Methyl ethyl ketone | 400 | parts by mass |

Agent for controlling alignment at the alignment layer interface (II-3)

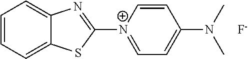

### <Evaluation of Optical Film>

Regarding the obtained optical film, the direction of the slow axis of the optically anisotropic layer was determined in the same manner as Example 1. According to the example, since the pyridinium salt falling without the formula (2) was used, the orthogonal alignment state didn't form easily, and the obtained optical film was inferior to the optical films of the examples in terms of the pattern-forming.

### Example 13

<Preparation of Transparent Support A with Rubbed Alignment Layer>

A composition for an alignment layer having the following formulation was prepared, and filtrated with a filter made of polypropylene having a pore diameter of 0.2 micro meters, to give a coating liquid for an alignment layer. The coating liquid was applied to the surface of a transparent glass plate by using a No. 14 wire bar, and dried at 100 degrees Celsius for a minute, to form a layer. A stripe mask of which the width of the transmission stripe was 285 micro meters and the width of the light-blocking stripe was 285 micro meters was prepared. The mask was disposed on the layer, and then, irradiated with the UV light for 2 seconds by using an air-cooling metal halide lamp (manufactured by EYE GRAPHICS Co., Ltd.) of which the luminance at 365 nm was 50 mW/cm² under the air-atmosphere, to generate the acidic compound by the decomposition of the photo-acid-generating agent and to form an alignment layer for the first retardation domain. The irradiated domain (for the first irradiation domain) of the alignment layer and the non-irradiated domain (for the second retardation domain) of the alignment layer were analyzed respectively by using a TOF-SIMS (time-of-flight secondary ion mass spectrometry method, “TOF-SIMS V” manufactured by ION-TOF), and the abundance ratio of the photo-acid-generating agent S-4 in the alignment layer corresponding to the first retardation domain to the photo-acid-generating agent S-4 in the alignment layer corresponding to the second retardation domain was 15/85. After that, the alignment layer was subjected to a rubbing treatment along one direction by a stroke at 500 rpm, to provide a transparent glass support with a rubbed alignment layer. Re(550) of the glass substrate was 0 nm, and the thickness of the alignment layer was 0.5 micro meters.

### <Formulation of Composition A for Alignment Layer>

| | | |
|---|---|---|
| Polymer material for alignment layer | 2.4 | parts by mass |
| (polyvinyl alcohol, PVA 103, Kuraray Co., Ltd.) | | |
| Photo-acid-generating agent (S-4) | 0.11 | parts by mass |
| Methanol | 16.7 | parts by mass |
| Isopropanol | 7.4 | parts by mass |
| Water | 73.4 | parts by mass |

Photo-acid-generating agent (S-4)

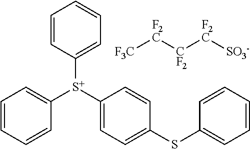

### <Preparation of Optically Anisotropic Patterned Layer A>

A composition A having the following formulation was prepared, and filtrated with a filter made of polypropylene having a pore diameter of 0.2 micro meters, to give a coating liquid for an optically anisotropic layer. The coating liquid was applied to the rubbed surface of the alignment layer, dried at a film-surface temperature of 115 degrees Celsius for 1 minute, and further dried for a minute after being cooled down to 100 degrees Celsius. After being cooled down to 60 degrees Celsius, the coated layer was then irradiated with the UV light for 20 seconds by using an air-cooling metal halide lamp (manufactured by EYE GRAPHICS Co., Ltd.) of which the luminance at 365 nm was 50 mW/cm² under the air-atmosphere, to fix the alignment state and to form an optically anisotropic layer A. In the optically anisotropic layer, the discotic liquid crystal was vertically aligned in the irradiated domain (the first retardation domain) so that the slow axis thereof was parallel to the rubbing direction; and the discotic liquid crystal was vertically aligned in the non-irradiated domain (the second retardation domain) so that the slow axis thereof was orthogonal to the rubbing direction. The thickness of the optically-anisotropic layer was 1.0 micro meter.

### <Formulation of Composition A for Optically Anisotropic Layer>

| | | |
|---|---|---|
| Discotic liquid crystal E-2 | 87 | parts by mass |
| Agent for controlling alignment at the alignment layer interface (II-3) | 0.43 | parts by mass |
| Agent for controlling alignment at the alignment layer interface (II-4) | 0.08 | parts by mass |
| Agent for controlling alignment at the air-interface (P-3) | 0.17 | parts by mass |
| Agent for controlling alignment at the air-interface (P-4) | 0.17 | parts by mass |
| Photo-polymerization initiator | 3.0 | parts by mass |
| (Irgacure 907, by Ciba Specialty Chemicals) | | |
| Sensitizer (Kayacure DETX, by Nippon Kayaku) | 1.0 | part by mass |
| Ethylene oxide modified trimethylol propane triacrylate (V#360, manufactured by OSAKA ORGANIC | 8.7 | parts by mass |
| CHEMICAL INDUSTRY LTD.) | | |
| Methyl ethyl ketone | 400 | parts by mass |

Discotic liquid crystal E-2 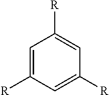 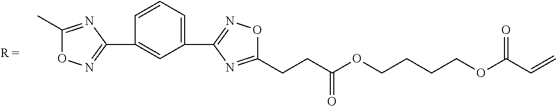 [SMILES: C=CC(=O)OCCCCOC(=O)CCc1nc(-c2cccc(-c3noc(C)n3)c2)no1]
Agent for controlling alignment at the alignment layer interface (II-3 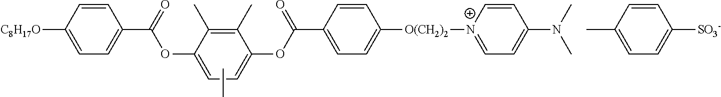
Agent for controlling alignment at the alignment layer interface (II-4) 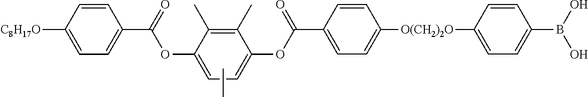
Agent for controlling alignment at the air-interface (P-3) 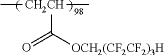 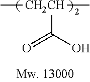
Agent for controlling alignment at the air-interface (P-4)

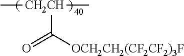

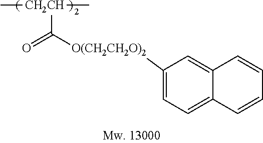

Regarding the optically anisotropic layer A, the cation of II-3 and the anion of the acid C₄F₉SO₃H generated from the photo-acid-generating agent, S-4, were found at the air-interface of the first retardation domain; and these ions were hardly found at the air-interface of the second retardation domain and the cation of II-3 and C₄F₉SO₃⁻ were localized in the area neighboring to the alignment layer interface. The abundance ratio of the cation of II-3 in the first retardation domain to the cation in the second retardation domain was 85/15 at the air interface; and the abundance ratio of C₄F₉S03 in the first retardation domain to the anion in the second retardation domain was 80/20 at the air interface. It was confirmed that the ingredient II-4 was localized at the areas neighboring to the alignment layer interface in both of the first and second domains. This indicated that the agent for controlling the alignment at the alignment-layer interface (II-3) was localized at the alignment layer interface in the second retardation domain, that the localization of the agent was lowered in the first retardation domain and some of the agent were diffused to the air-interface, and that the diffusion of the cation of II-3 was promoted by the anion-exchange between the generating acidC₄F₉SO₃H and the agent II-3 in the first retardation domain.

The obtained optically anisotropic patterned layer A was disposed between orthogonally-positioned two polarizing plates so that the slow axis of the first or second retardation domain of the optically anisotropic layer was parallel to the polarization axis of any one of the polarizing plates; and a sensitive color plate having retardation of 530 nm was disposed on the optically anisotropic layer so that the angle between the slow axis of the color plate and the polarization axis of the polarizing plate was 45°. And the state obtained by the +45° rotation of the optically anisotropic layer and the state obtained by the −45° rotation of the optically anisotropic layer were observed under a polarizing microscope (“ECLIPE E600 W POL” manufactured by NIKON). When being rotated by +45°, the slow axis of the first retardation domain was parallel to the slow axis of the color plate, retardation of the domain was more than 530 nm, and the color of the domain was changed bluish; on the other hand, the slow axis of the second retardation domain was orthogonal to the slow axis of the color plate, retardation of the domain was less than 530 nm, and the color of the domain was changed yellowish. When being rotated by −45°, the converse phenomenon was found.

### <Evaluation of Optical Film A>

Regarding the obtained optically anisotropic layer A, the tilt angle of the discotic liquid crystal at the alignment layer interface, the tilt angle of the discotic liquid crystal at the air-interface, Re and Rth were measured respectively according to the above-described methods by using KOBRA-21ADH (by Oji Scientific Instruments). The results are shown in the following table 1. In the table, “Verticality” means the tilt angle falling within the range of from 70° to 90°. The direction of the slow axis of the optically anisotropic layer was determined according to the above-described method by using KOBRA-21ADH (by Oji Scientific Instruments). In the following table, the relation between the slow axis of the optically anisotropic layer and the rubbing direction was shown.

From the results shown in the following table, it is understandable that it is possible to form an optically anisotropic patterned layer A with the first and second retardation domains formed of the vertical alignment of the discotic liquid crystal of which the slow axes are orthogonal to each other by aligning the discotic liquid crystal in the presence of a pyridinium salt compound, boronic acid compound and a fluoroaliphatic-group-containing copolymer on the surface of the polyvinyl alcohol-series alignment layer containing a photo-acid-generating compound, subjected to a rubbing treatment along one direction after subjected to an light-irradiation via a mask.

### Example 14

An optically anisotropic patterned layer B was formed in the same manner as Example 13, except that a coating liquid B having the following formulation was used in preparation of the alignment layer in place of the coating liquid A. The thickness of the alignment layer was 0.5 micro meters, and the thickness of the optically anisotropic layer was 1.0 micro meter.

### <Formulation of Composition B for Alignment Layer>

| | | |
|---|---|---|
| Polymer material for alignment layer | 2.4 | parts by mass |
| (polyvinyl alcohol, PVA 103, Kuraray Co., Ltd.) | | |
| Photo-acid-generating agent (S-5) | 0.11 | parts by mass |
| Methanol | 16.7 | parts by mass |
| Isopropanol | 7.4 | parts by mass |
| Water | 73.4 | parts by mass |

Photo-acid-generating agent (S-5)

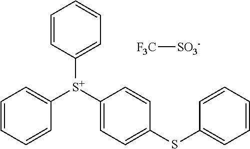

The first and second retardation domains of the obtained optically anisotropic patterned layer B were analyzed respectively by using a TOF-SIMS (time-of-flight secondary ion mass spectrometry method, “TOF-SIMS V” manufactured by ION-TOF); and the abundance ratio of the photo-acid-generating agent, S-5, in the alignment layer corresponding to the first retardation domain to the photo-acid-generating agent in the alignment layer corresponding to the second retardation domain was 10/90. This indicated that almost all of the photo-acid-generating agent, S-5, in the first domain was decomposed. Regarding the optically anisotropic layer, the cation of 11-3 and the anion of the acid CF₃SO₃H generated from the photo-acid-generating agent, S-5, were found at the air-interface of the first retardation domain; and these ions were hardly found at the air-interface of the second retardation domain and the cation of II-1 and CF₃SO₃⁻ were localized in the area neighboring to the alignment layer interface. The abundance ratio of the cation of II-3 in the first retardation domain to the cation in the second retardation domain was 90/10 at the air interface; and the abundance ratio of CF₃SO₃⁻ in the first retardation domain to the anion in the second retardation domain was 90/10 at the air interface. This indicated that the agent for controlling the alignment at the alignment-layer interface (II-3) was localized at the alignment layer interface in the second retardation domain, that the localization of the agent was lowered in the first retardation domain and some of the agent were diffused to the air-interface, and that the diffusion of the cation of II-3 was promoted by the anion-exchange between the generating acid CF₃SO₃H and the agent II-3 in the first retardation domain.

### <Evaluation of Optical Film B>

Regarding the obtained optically anisotropic layer B, the direction of the slow axis was determined in the same manner as Example A. In the following table, the relation between the slow axis of the optically anisotropic layer B and the rubbing direction was shown. From the results shown in the following table, it is understandable that it is possible to form an optically anisotropic patterned layer B with the first and second retardation domains formed of the vertical alignment of the discotic liquid crystal of which the slow axes are orthogonal to each other by aligning the discotic liquid crystal in the presence of a imidazolium salt compound, a boronic acid compound and a fluoroaliphatic-group-containing copolymer on the surface of the polyvinyl alcohol-series alignment layer containing a photo-acid-generating compound, subjected to a rubbing treatment along one direction after subjected to an light-irradiation via a mask.

TABLE 2

| | | | | Alignment | | | | | | | | | |
|---|---|---|---|---|---|---|---|---|---|---|---|---|---|
| | | | | layer Side | | Air-Interface | | | | | | | |
| | | | | Alignment | | Side | | | | | | | |
| | | | | Agent | | Alignment Agent | | | | Tilt Angle | | Optical | |
| | | | Photo-Acid- | | Amount | | Amount | | | Alignment | Air- | Properties | |
| | Liquid | Alignment | Generating | Mate- | (% by | | (% by | Light- | Direction of | Layer | Interface | Re | Rth |
| | Crystal | Layer | Agent | rial | mass) | Material | mass) | Irradiation | Slow Axis | Side | Side | (nm) | (nm) |
| Example 13 | E-2 | PVA103 | S-4 | II-3 | 0.43 | P-3 | 0.17 | No | Orthogonal | Verticality | Verticality | 130 | −65 |
| | | | | II-4 | 0.08 | P-4 | 0.17 | Yes | Parallel | Verticality | Verticality | 130 | −65 |
| Example 14 | E-2 | PVA103 | S-5 | II-3 | 0.43 | P-3 | 0.17 | No | Orthogonal | Verticality | Verticality | 130 | −65 |
| | | | | II-4 | 0.08 | P-4 | 0.17 | Yes | Parallel | Verticality | Verticality | 130 | −65 |

### Example 15

### <Preparation of Coating Liquid for Anti-Glare Layer>

31 g of a mixture of pentaerythritol triacrylate and pentaerythritol tetraacrylate (“PET-30” available from Nippon Kayaku Co., Ltd.) was diluted with 38 g of methyl isobutylene. 1.5 g of a photo polymerization initiator (Irgacure 184, from Ciba Specialties Chemicals Corp.) was added and mixed under stirring. Successively, 0.04 g of a surface modifying fluoro-agent (FP-149) and 6.2 g of a silane coupling agent (KBM-5103, manufactured by Shinetsu Chemical Industry Co.) were added. The refractive index of a coating film obtained by coating the solution and by UV-ray curing was 1.520. Finally, after adding 39.0 g of a 30% cyclohexanone liquid dispersion of crosslinked poly(acryl-styrene) particles of an average grain size of 3.5 micro meters (copolymer compositional ratio=50/50, refractive index:1.540) dispersed by a polytron dispersing machine at 10,000 rpm for 20 min to the solution.

The liquid mixture was filtered by a filter made of polypropylene of 30 micro meters pore size to prepare a coating liquid for use in an anti-glare layer.

### <Preparation of Anti-Glare Layer>

The coating liquid for use in the anti-glare layer was applied to a surface of a triacetyl cellulose film, TD80UL (80 micro meters thickness, manufactured by FUJIFILM) by using a gravure coater, and, after drying at 30 degrees Celsius for 15 seconds and 90 degrees Celsius for 20 seconds, UV-rays at an irradiation dose of 90 mJ/cm² were irradiated under nitrogen purge by using an air-cooled metal halide lamp (manufactured by I Graphics Co.) at 160 W/cm to cure the coating layer and an anti-glare layer of 6 micro meters thickness having an anti-glare property was formed.

### <Preparation of Coating Liquid for Low Refractive-Index Layer>

The following ingredients were dissolved in MEK according to the following formulation, to give a coating liquid for a low refractive index layer having the solid content of 5% by mass.

### Formulation of Coating Liquid for Low Refractive-Index Layer

| | | |
|---|---|---|
| Perfluoroolefin copolymer shown below | 15 | parts by mass |
| DPHA (a mixture of dipentaerythritol pentaacrylate and dipentaerythritol | 7 | parts by mass |
| hexaacrylate mixture available from Nippon Kayaku) | | |
| Defensor MCF-323 | 5 | parts by mass |
| (Fluorochemical surfactant, available from Dai-Nippon Ink) | | |
| Fluorine-containing polymerizable compound shown below | 20 | parts by mass |
| Hollow silica microparticle dispersing Liquid A | 50 | parts by mass |
| (Solid content concentration 18.2 % by mass) | | |
| IRGACURE 127 (Photo-polymerization initiator, manufactured by Ciba Specialty | 3 | parts by mass |
| Chemicals) | | |

Perfluoroolefin copolymer 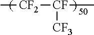 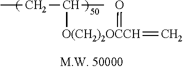
In the formula, 50/50 means the molar ratio.
Fluorine-containing polymerizable compound

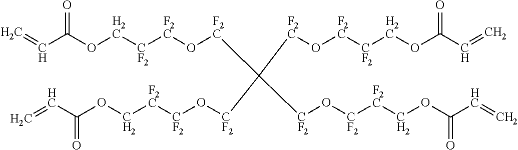 [SMILES: C=CC(=O)OCC(F)(F)C(F)(F)OC(F)(F)C(C(F)(F)OC(F)(F)C(F)(F)COC(=O)C=C)(C(F)(F)OC(F)(F)C(F)(F)COC(=O)C=C)C(F)(F)OC(F)(F)C(F)(F)COC(=O)C=C]

### <Preparation of Low Refractive-Index Layer>

The coating liquid for use in the anti-glare layer was applied to a surface of the anti-glare layer by using a gravure coater, and, after drying at 90 degrees Celsius for 30 seconds, UV-rays at an irradiation dose of 600 mJ/cm² and an illuminance of 600 mW/cm² were irradiated under an atmosphere with a concentration of oxygen of 0.1 vol. % by using an air-cooled metal halide lamp (manufactured by I Graphics Co.) at 240 W/cm to cure the coating layer, and a low-refractive-index layer of 90 nm thickness having a refractive index of 1.36 was formed.

<Preparation of Optically Anisotropic Patterned Layer B with Optical Film C>

An optically anisotropic patterned layer B was formed on a glass support in the same manner as Example 14, and the surface of the glass support was bonded to a TD80UL-surface of the obtained optical film C via an adhesive. In this way, an optically anisotropic patterned layer B with the optical C was prepared.

### <Fabrication of Stereoscopic Display Device C>

The optically anisotropic patterned layer B with the optical film C was bonded to the surface of the view-side-polarizing plate of “FlexScan S2231W” available from EIZO NANAO CORPORATION via an adhesive. And the bonding thereof was carried out so that the angle between the slow axis of the optically anisotropic patterned layer B and the absorption axis of the polarizing film was ±45 degrees. The stereoscopic images were displayed on the 3D monitor and were observed through circularly-polarized light-glasses, and as a result, the clean images without any crosstalk were viewable.

### Example 16

<Preparation of Optically Anisotropic Patterned Layer B with CV-LU>

An optically anisotropic patterned layer B was formed on a glass support in the same manner as Example 14.

Using “CV-LU” (by FUJIFILM) in place of the optical film C, the surface of the glass support of the optically anisotropic layer B was bonded to the surface of the transparent support in CV-LU via an adhesive. In this way, an optically anisotropic patterned layer B with CV-LU was prepared.

### <Fabrication of Stereoscopic Display Device D>

The optically anisotropic patterned layer B with CV-LU was bonded to the surface of the view-side-polarizing plate of “FlexScan S2231W” available from EIZO NANAO CORPORATION via an adhesive. And the bonding thereof was carried out so that the angle between the slow axis of the optically anisotropic patterned layer B and the absorption axis of the polarizing film was ±45 degrees. The stereoscopic images were displayed on the 3D monitor and were observed through circularly-polarized light-glasses, and as a result, the clean images without any crosstalk were viewable.

### DESCRIPTION OF REFERENCE NUMERALS

10 Optical film
12 Optically anisotropic patterned layer
14 Alignment layer
16 Transparent support
20 Polarizing plate
22 Polarizing film
24 Protective film

What is claimed is:

1. An optical film comprising:
a transparent support, and thereon,
an alignment layer comprising at least one photo-acid-generating agent, and
an optically anisotropic layer formed of a composition comprising a liquid crystal having a polymerizable group as a main ingredient;
wherein the optically anisotropic layer is an optically anisotropic patterned layer comprising a first retardation domain and a second retardation domain disposed alternately in a plane.

2. The optical film of claim 1, wherein the alignment layer is an alignment layer subjected to an alignment treatment in one direction.

3. The optical film of claim 1, wherein the at least one photo-acid-generating agent is decomposed at least partially, and the degrees of decomposition thereof are different between the domains of the alignment layer corresponding to the first and second retardation domains respectively.

4. The optical film of claim 3, wherein an acidic compound or an ion thereof generated from the at least one photo-acid-generating agent exists in at least a part of the optically anisotropic layer, and the ratios of the acidic compound or the ion contained in the first retardation domain and the second retardation domain respectively are different from each other.

5. The optical film of claim 1, wherein slow axes in plane of the first retardation domain and the second retardation domain are orthogonal to each other.

6. The optical film of claim 1, which has Re(550) falling within the range from 110 nm to 165 nm, wherein Re (550) (unit: nm) is retardation in plane at a wavelength of 550 nm.

7. The optical film of claim 1, wherein Re (550) of the transparent support is from 0 nm to 10 nm.

8. The optical film of claim 1, which has Rth(550) satisfying |Rth(550)|≦20, wherein Rth (550) (unit: nm) is retardation along the thickness at a wavelength of 550 nm.

9. The optical film of claim 1, wherein the alignment layer comprises modified or non-modified polyvinyl alcohol as a main ingredient.

10. The optical film of claim 1, wherein the liquid crystal having a polymerizable group is a discotic liquid crystal.

11. The optical film of claim 1, wherein the optically anisotropic layer further comprises at least one onium salt.

12. The optical film of claim 11, wherein the at least one onium salt in the optically anisotropic layer is at least partially anion-exchanged with an acid compound generated from the photo-acid-generating agent.

13. The optical film of claim 12, wherein the anion-exchange ratios of the onium salt in the first retardation domain and the second retardation domain are different from each other.

14. The optical film of claim 1, wherein the optically anisotropic layer further comprises at least one compound represented by formula (Ia):
T-X¹-Q (Ia)
wherein X¹ represents a single bond or divalent linking group, hydrogen atom, or substituted or non-substituted alkyl, alkenyl, alkynyl, aryl or heteroaryl; T represents a substituent having a polymerizable group; Q represents a boronic acid or boronic acid ester; and the compound may have no T, and in the compound having T, X¹ represents a single bond or divalent linking group.

15. The optical film of claim 1, wherein the optically anisotropic layer further comprises at least one fluoroaliphatic group-containing copolymer.

16. A polarizing plate comprising an optical film of claim 1, and a polarizing film, wherein the angle between each of slow axes in plane of the first retardation domain or the second retardation domain and an absorption axis of the polarizing film is 45°.

17. An image display device comprising:
a first polarizing film and a second polarizing film,
a liquid crystal cell disposed between the first and second polarizing films, comprising a pair of substrates and a liquid crystal layer disposed between the pair of substrates, and
an optical film of claim 1 disposed on the outer side of the first polarizing film;
wherein the angle between each of slow axes in plane of the first retardation domain or the second retardation domain of the optical film and an absorption axis of the first polarizing film is ±45°, and
which further comprises a third polarizing plate disposed on the outer side of the optical film so as to be capable of allowing a viewer to see stereoscopic imagery through the third polarizing plate.

18. A process for producing an optical film of claim 1, comprising, in the following order:
1) forming an alignment layer of a composition, comprising at least one photo-acid-generating agent, on a transparent support;
2) irradiating the alignment layer with light through a photo-mask, thereby to decompose the at least one photo-acid-generating agent in the irradiated area, and to generate an acidic compound in the irradiated area;
3) applying a composition, comprising a liquid crystal having a polymerizable group as a main ingredient, to the alignment layer, thereby to form a coated layer;
4) aligning the liquid crystal at a temperature of T₁ degrees Celsius, so that a slow axis of the irradiated domain is aligned along a first direction and a slow axis of the non-irradiated domain is aligned along a second direction which is different from the first direction; and
5) polymerizing the liquid crystal at a temperature of T₂ (T₁>T₂) degrees Celsius, thereby to fix the liquid crystal in an alignment state, and to form an optically anisotropic patterned layer with a first retardation domain and a second retardation domain having slow axes which are aligned along the directions different from each other.

19. The process of claim 18, further comprising rubbing the alignment layer along one direction between the 1) and the 2) steps, or between the 2) and 3) steps.

20. The process of claim 18, wherein carrying out the 2) step brings about the difference in aligning force between the irradiated area and the non-irradiated area of the alignment layer.

21. The process of claim 20, wherein
the composition to be used in the 3) step comprises an agent capable of controlling alignment at an alignment layer-interface; and
an acidic compound or an ion thereof, generated in the irradiated area of the alignment layer during the 2) step, decreases the degree of localization of the agent to the alignment-layer interface, thereby to bring about the difference in aligning force between the irradiated area and the non-irradiated area of the alignment layer.
